(19) United States
(12) Patent Application Publication
(10) Pub. No.: US 2018/0308473 A1
(43) Pub. Date: Oct. 25, 2018

(54) INTELLIGENT VIRTUAL ASSISTANT SYSTEMS AND RELATED METHODS

(71) Applicant: TRUE IMAGE INTERACTIVE, INC., Pittsburgh, PA (US)

(72) Inventor: Wayne SCHOLAR, Mars, PA (US)

(21) Appl. No.: 15/757,105

(22) PCT Filed: Sep. 2, 2016
(86) PCT No.: PCT/US16/50223

§ 371 Date: Mar. 2, 2018

Related U.S. Application Data
(60) Provisional application No. 62/213,276, filed on Sep. 2, 2015.

(51) Int. Cl. G10L 15/18; G06F 15/18; G10L 15/26; G06F 17/21; G06F 17/30; A63F 13/80

(52) U.S. Cl. CPC G10L 15/18; G06F 15/18; G10L 15/26; A63F 2300/8064; G06F 17/3053; A63F 13/80; G06F 17/21

(57) ABSTRACT

Provided herein are intelligent virtual assistant systems and related methods. The intelligent virtual assistant systems include a processor; and memory coupled to the processor, the memory comprising at least one executable instruction that when executed by the process causes the processor to effectuate operations comprising: receiving at least one input parameters indicative of a plurality of campaigns and a plurality of prompts from at least one campaign applications; determining a campaign flow based on the at least one input parameters; and generating, based on the campaign flow, an intelligent virtual assistance application. The disclosed intelligent virtual assistant systems and related methods can be used for counseling and coaching people, for example children and adults with special needs, such as autism.

### CROSS-REFERENCE TO RELATED APPLICATIONS

This application claims benefit under 35 U.S.C. § 119(e) of U.S. Provisional Patent Application No. 62/213,276, filed on Sep. 2, 2015, and titled “Intelligent Virtual Assistant Systems and Related Methods,” the content of which is incorporated by reference herein in its entirety.

### BACKGROUND

Adults with special needs often need help coping with the numerous logistic requirements in life, such as waking up on time to get ready to get to work, using the mass-transit system to get to appointments, remembering to fill a prescription at a pharmacy and being reminded to take their medicine, shopping for food, cooking meals, cleaning their homes regularly, and so on. While many adults with such special needs today rely on friends and family to help them with such tasks, there are many who do not have such support. Although computer technology continues its miraculous pace at becoming faster, smaller, more portable and smarter every year, artificial intelligence systems capable of verbal communication and guiding people to accomplish such simple tasks is lacking.

### SUMMARY

Provided herein are intelligent virtual assistant systems and related methods. The intelligent virtual assistant systems include a processor; and memory coupled to the processor, the memory comprising at least one executable instruction that when executed by the process causes the processor to effectuate operations comprising: receiving at least one input parameters indicative of a plurality of campaigns and a plurality of prompts from at least one campaign applications; determining a campaign flow based on the at least one input parameters; and generating, based on the campaign flow, an intelligent virtual assistance application. The disclosed intelligent virtual assistant systems and related methods can be used for counseling and coaching people, for example children and adults with special needs, such as autism.

Provided herein are intelligent virtual assistant systems, comprising: a processor; and memory coupled to the processor, the memory comprising at least one executable instruction that when executed by the process causes the processor to effectuate operations comprising: receiving at least one input parameters indicative of a plurality of campaigns and a plurality of prompts from at least one campaign applications; determining a campaign flow based on the at least one input parameters; and generating, based on the campaign flow, an intelligent virtual assistance application.

Also provided herein are computer-readable storage medium comprising executable instructions, that when executed by a processor cause the processor to effectuate operations comprising: receiving a plurality of user data indicative of personal characteristics of users; converting the plurality of user data into a matrix of users-by-scores; and generating, based on the matrix of user-by-scores, a first cluster of users; generating, based on the matrix of user-by-scores, a second cluster of users; and determining at least one similarity based on outcomes of each of the first and second cluster of users; wherein each column of the matrix of users-by-scores is indicative of a score given on a task and each row of the matrix of users-by-scores is indicative of a user who performed the task.

Also provided herein are intelligent virtual assistant systems, comprising: a processor; and memory coupled to the processor, the memory comprising at least one executable instruction that when executed by the process causes the processor to effectuate operations comprising: receiving a plurality of user interaction data indicative of patterns of usage within an intelligent virtual assistant application; determining a first path of user interaction based on the plurality of user interaction data, the first path of; and predicting a second path of user interaction based on the first path of user interaction.

Also disclosed are intelligent virtual assistant systems, comprising: a processor; and memory coupled to the processor, the memory comprising at least one executable instruction that when executed by the process causes the processor to effectuate operations comprising: receiving, via an intelligent virtual assistant application, text data indicative of a user's question; receiving a training set data indicative of mapping information that maps existing questions to answers; transforming the text data into a vector space representation; generating, based on the training set data and the vector space representation, a plurality of candidate responses to the user question, each of the plurality of candidate responses includes probabilistic weight scores; determining, based on the probabilistic weight scores, a ranking of the plurality of candidate responses; and providing, based on the ranking, a response to the intelligent virtual assistant application.

Also provided are systems, methods, and instrumentalities to identify an individual's abilities, skills and interests by analyzing how people make decisions and reacts while playing games. For example, a server receives game data indicative of a plurality of games that are designed to assess at least one personal characteristic. The at least one personal characteristic may include at least one of human abilities, cognitive skills, or career interests. Upon receiving the game data, the server may determine a first comparative game performance associated with a first game of the plurality of games. The first comparative game performance is determined, for example, based on the game data and comparative game information. The comparative game information is indicative of a comparison between game performance associated with the first game and respective game performance associated with at least one other game of the plurality of games. Upon determining the first comparative game performance, the server may derive a personal character from the first comparative game performance and provide an indication of the personal characteristic.

By using games and technology, systems and methods for identifying an individual's abilities, skills and interests may provide a directional sense of an individual's cognitive, social, and communicative strengths and weaknesses in a way that might previously have only been found by “accident.”

The identification of an individual's abilities, skills and interests presented herein can build on three time tested frameworks: Howard Gardner's Multiple Intelligences; George McCloskey's work on Executive Functions (EFs); and John Holland's work on career interests. Howard Gardner's Multiple Intelligences work outlines the comprehensive set of human abilities. George McCloskey's work on Executive Functions (EFs) describes the set of cognitive skills that work together to help a person learn and “produce” outputs and achieve goals. John Holland's work on career interests helps people explore careers based on how they like to spend their time.

A set of games can be provided for children and adults who love to play. The games themselves may be designed to collect data on how the player reacts, answers questions, makes decisions, etc. The more games are played by users, the more information about their abilities and executive function skills can be gathered.

The games can be complemented with observations provided by parents (and educators, therapists, etc. invited by the parents) to compile a 360° view of an individual. For example, parents/professionals may complete the McCloskey Executive Function Survey (MEFS) and Autism Speaks' Community-based Skills Assessment (CSA) to provide additional information on an individual. This integration of observations from the people who work most closely with the individual with the data from the games can provide valuable insights into areas of agreement and possible disconnects. This may serve to highlight areas of strengths and developmental needs for an individual.

All the data from games and surveys may be analyzed and displayed on “dashboards” and reports on individual's Gardner intelligences, EFs, and career interests. By combining an understanding of an individual's ability with an understanding of their personal interests and ambitions in the reports, an individual's strengths and interests may be displayed to support the exploration of fulfilling educational and vocational options for each individual. Parents may choose to share these reports with other professionals and educators working with the child.

An artificial intelligence platform may be used to identify each individual's abilities, skills, or interests. The artificial intelligence platform may provide a human avatar to interact with users. The human avatar may make use of speech recognition and conversational context. The human avatar may be based on the artificial intelligence engine, thereby guiding players through website, mobile device, wearable device or the like. For example, the human avatar may answer players' questions, and present the results to the players and their parents in an intuitive and easy-to-understand manner. The human avatar may also be trained to ask questions the way an expert psychologist working with individual clients engages in conversation to build EF skills. In an embodiment, the human avatar may provide functions of life coaching for users to address situations that they may find themselves over the course of a day.

An individual's abilities, skills and interests may be identified by analyzing the data of how individuals make decisions and react while playing games. The results from these analyses may offer parents some directional sense of where to explore further to build on areas of strengths and decide on a course of action for areas of weakness. Over time, the artificial intelligence platform may be “trained” to hold one-on-one conversations in the way that a psychologist converses with clients to build EF skills. Based on the results, individuals and families may identify abilities, skills and interests for the pursuit of fulfilling futures for each individual.

### BRIEF DESCRIPTION OF THE DRAWINGS

The following detailed description of examples is better understood when read in conjunction with the appended drawings. For the purpose of illustration, there is shown in the drawings exemplary embodiments; however, the subject matter is not limited to the specific elements and instrumentalities disclosed. In the drawings:

FIG. 1 is a system diagram of an example identification system that can provide an indication of personal characteristics according to an embodiment.

FIG. 2 is an example process flow that can be performed by the identification system illustrated in FIG. 1.

FIG. 3 is an example process flow that can be implemented using a site to identify personal characteristics according to an embodiment.

FIG. 4A-E illustrates example process flows of account registration to identify personal characteristics according to an embodiment

FIG. 5 illustrates an example process flow of data collection for a game that is designed to assess personal characteristics according to an embodiment

FIG. 6 illustrates an example process flow of generating comparative game information according to an embodiment.

FIG. 7 illustrates an example process flow of determining a player's performance according to an embodiment.

FIG. 8 illustrates an example process flow of reporting a player's relative performance according to an embodiment.

FIG. 9 illustrates another example process flow of reporting a player's relative performance according to an embodiment.

FIG. 10 is a screenshot of an example website for identifying personal characteristics when a user enters the website according to an embodiment.

FIG. 11 is a screenshot of an example website for identifying personal characteristics when a user selects play games according to an embodiment.

FIG. 12 is a screenshot of an example website for identifying personal characteristics when a user selects an informational page to learn the individual's personal characteristics according to an embodiment.

FIG. 13 is a screenshot of an example website for identifying personal characteristics when a user selects a dashboard page according to an embodiment.

FIG. 14 is another screenshot of an example site for identifying personal characteristics when a user selects a deep dive page according to an embodiment.

FIG. 15 is a system diagram illustrating an overview of an example network for identifying personal characteristics according to an embodiment.

FIG. 16 is a flow diagram illustrating data collection when a registered user plays a game on a site for identifying personal characteristics according to an embodiment.

FIG. 17 is a flow diagram illustrating a data mining process when a registered user plays a game according to an embodiment.

FIG. 18 is a flow diagram illustrating a review process for a player's performance by authorized individuals according to an embodiment.

FIG. 19 illustrates types of games that can be used to identify personal characteristics according to an embodiment.

FIG. 20 illustrates examples of repurposed games according to an embodiment.

FIG. 21 illustrates examples of custom games to collect detailed data according to an embodiment.

FIG. 22 illustrates an example flow of a custom game to collect detailed data using face recognition according to an embodiment.

FIG. 23 illustrates an example flow of a custom game to collect detailed data using melody recognition according to an embodiment.

FIG. 24 illustrates an example flow of a custom game to collect detailed data using pattern recognition according to an embodiment.

FIG. 25 illustrates an example of a custom game to collect detailed data with different comprehension mode according to an embodiment.

FIG. 26 illustrates examples of custom games to collect detailed data according to an embodiment.

FIG. 27 illustrates examples of tailored games to assess ability area according to an embodiment.

FIG. 28 illustrate an example process flow for an artificial intelligence platform interacting with users according to an embodiment.

FIG. 29 is a high level illustration of user interaction with an intelligent virtual assistant (Abby) according to an embodiment.

FIG. 30 is a block diagram illustrating a system for an intelligent virtual assistant platform according to an embodiment.

FIG. 31 is a block diagram illustrating an example core framework for the intelligent virtual assistant system described in FIG. 30.

FIG. 32A illustrates a screenshot of an intelligent virtual assistant in an example mobile application according to an embodiment.

FIG. 32B illustrates a screenshot of an intelligent virtual assistant when a user clicks navigation bar according to an embodiment.

FIG. 33 is a flow diagram illustrating a user's engagement with an intelligent virtual assistant system according to an embodiment.

FIG. 34 is a flow diagram of natural language processing by an intelligent virtual assistant system according to an embodiment.

FIG. 35 is a flow diagram of campaign logic processing by an intelligent virtual assistant system according to an embodiment.

FIG. 36 illustrates users' spatial representation within an artificial intelligence that implements an intelligent virtual assistant system according to an embodiment.

FIG. 37 is a flow diagram of extracting user's latent personality factors from the example spatial representation illustrated in FIG. 35.

FIG. 38 illustrates example footage and prediction according to an embodiment.

FIG. 39 displays graphs illustrating prediction for user improvement and danger according to an embodiment.

FIG. 40 is a diagram illustrating prediction of interesting item for users according to an embodiment.

FIG. 41 is a flow diagram illustrating how an intelligent virtual assistant system may understand user interactions and proactively predict the user's intent according to an embodiment.

FIG. 42 is a flow diagram illustrating how an intelligent virtual assistant system may formulate answers to novel questions according to an embodiment.

FIG. 43 is a process diagram illustrating automated question extraction according to an embodiment.

FIG. 44 is a block diagram illustrating prediction of user intent according to an embodiment.

FIG. 45 is a flow diagram illustrating an example workflow according to an embodiment.

FIG. 46 is a flow diagram illustrating an example monitoring process according to an embodiment.

FIG. 47 is a block diagram illustrating a task manager and associated workflows according to an embodiment.

FIG. 48 is a block diagram illustrating a reminder manager and associated workflows according to an embodiment.

FIG. 49 is a block diagram illustrating an education manager and associated workflows according to an embodiment.

FIG. 50A is a system diagram of an example communications system in which one or more disclosed embodiments may be implemented.

FIG. 50B is a system diagram of an example device that can implement a game and be used within the communications system illustrated in FIG. 49A.

FIG. 51 is a block diagram of an example processor in which identification of an individual's abilities, skills and interests may be implemented.

FIG. 52 is a description of Howard Gardner's work for understanding abilities.

FIG. 53 is a description of Executive Functions for understanding cognitive skills.

FIG. 54 is a description of 33 Self-Regulation functions with 7 clusters that can be assessed via gaming.

FIG. 55 is a description of Holland's work for understanding interests.

FIG. 56 is a bar chart illustrating a population impacted with ASD and costs of autism.

FIG. 57 is a block diagram illustrating a system for an intelligent virtual assistant platform according to an embodiment.

FIG. 58 is a flow diagram illustrating natural language processing model creation with intents, according to an embodiment.

FIG. 59 is a flow diagram illustrating matching intents to user questions according to an embodiment.

FIG. 60 illustrates an example data flow of conversational natural language processing according to an embodiment.

FIG. 61 illustrates an example data flow of scheduling an event according to an embodiment.

### DETAILED DESCRIPTION

Autism is one of the biggest childhood epidemics of our time, and up to 1 million individuals on the autism spectrum will transition to adulthood in the coming decade. Specifically, 1 in 68 children (1 in 42 boys) identified with autism spectrum disorder (CDC, May 2014) and the rate is higher than all non-routine childhood diseases (e.g., juvenile diabetes, children cancers, etc.) combined. It is expected that up to 1 million autistic teenagers will become adults in the US between now and 2030. Moreover, approximately 65% to 80% of autistic adults currently unemployed in the US. Those who are employed work fewer hours and earn less than adults with other disabilities. Many autistic adults do not have independent housing and require parental support.

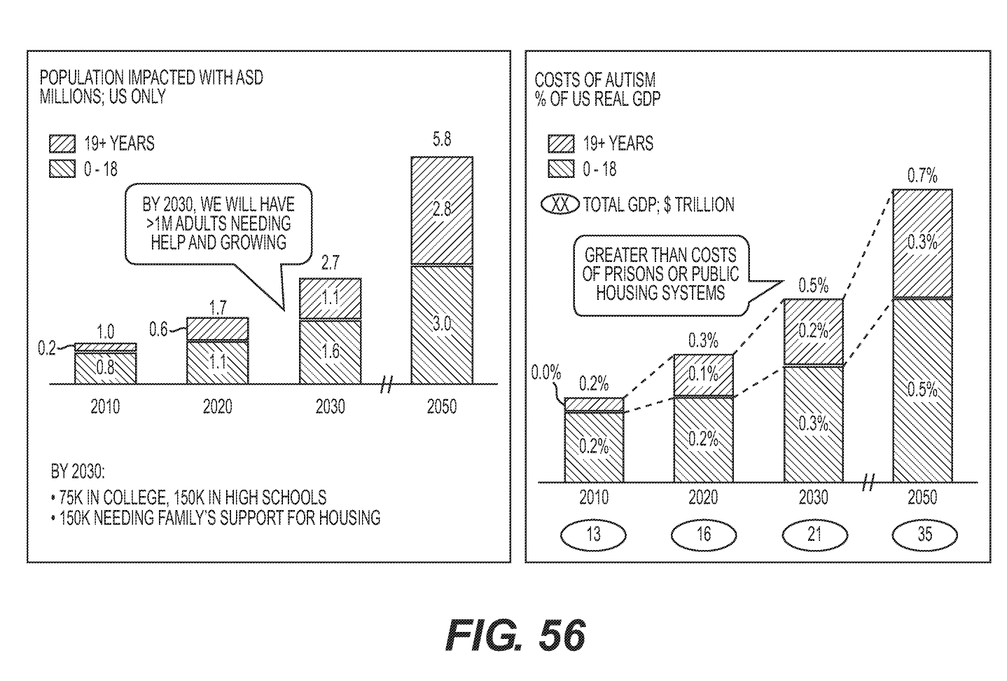

FIG. 56 is a bar chart illustrating population impacted with ASD and costs of autism. As shown in FIG. 56, autism is the costliest condition in the UK and it is more than more than heart disease, cancer and stroke combined. In FIG. 56, upper portions of each bar graph indicate ‘19+ years’ and the lower portions of each bar indicate 0-18.

Thus, unless new tools are created to help these individuals pursue productive lives, they will likely be a drain on society for decades to come.

Parents of typical children may have school grades, standardized test scores, years of extracurricular activities and dinner conversations to help guide the transition to adulthood. School grades and standardized test scores, for example, SAT, ACT, professional interest batteries, etc., may help parent assess their children's ability on dimensions of interest to schools and colleges. Years of extracurricular activities such as dance and sports and dinner conversations may be used as a gauge of interest and ability in area not assessed by pen-and-pencil.

However, these most basic guideposts often are unreliable or missing altogether for parents of autistic children. Autistic teenagers may not do well with grades and test scores. Autistic teenagers may not communicate well. They may have strengths in areas not assessed through traditional means that remain hidden through lack of vehicle for expression. Thus the critical tool for planning is missing for many autistic families, leading to less than ideal post-secondary educational/vocational pursuits, under-employment/unemployment, and housing & transportation challenges later in life.

In an embodiment, the systems and methods of identifying an individual's abilities, skills and interests can provide a directional understanding of their autistic child's underlying abilities, executive function skills, and interests. Understanding abilities and interests can be the first step in helping a child pursue post-secondary educational/vocational plans. Specifically, it may help parents identify where their children reach current limits (“hit the wall”) on a host of abilities and skills, especially those not traditionally assessed by schools and standardized tests. Moreover, it may help the children build skills where research has shown possible, especially with “Executive Function”.

In an embodiment, the systems and methods of identifying an individual's abilities, skills and interests may use 3 time-tested frameworks to identify the characteristics. The 3 time-tested frameworks may include: Howard Gardner's Multiple Intelligences work; Executive Function; and John Holland's work on career interests.

Howard Gardner's Multiple Intelligences work outlines the comprehensive set of human abilities. Abilities assessed by traditional tests are linguistic, logic, and mathematics. Other abilities missed by traditional assessment tools are spatial, bodily, kinesthetic, musical, interpersonal, and intrapersonal.

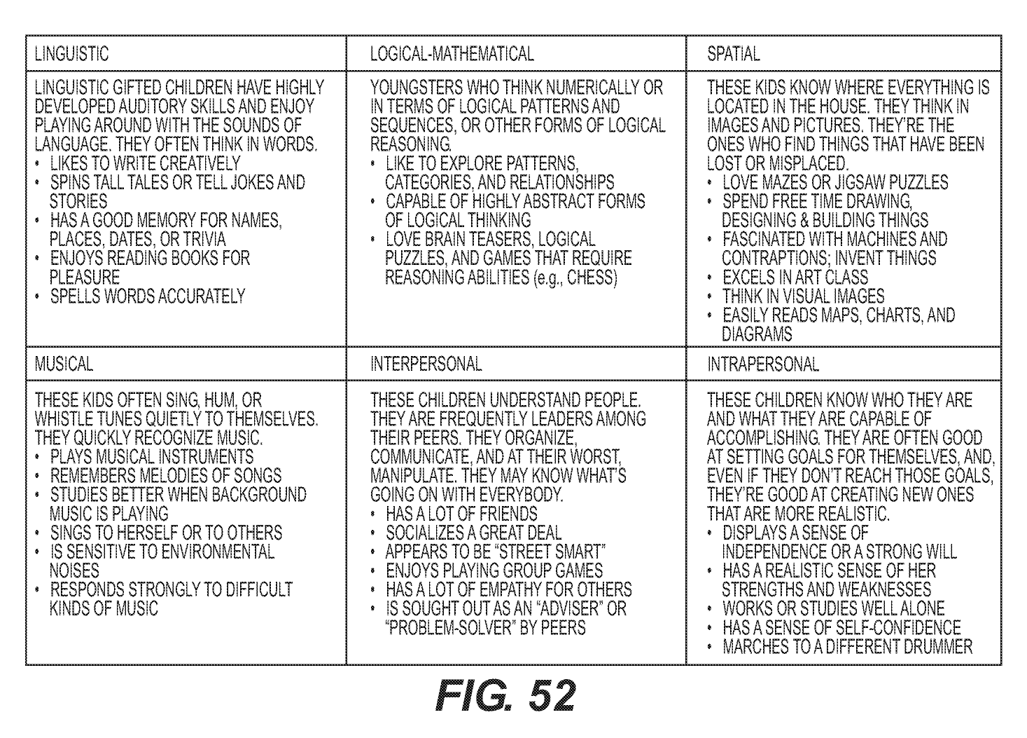

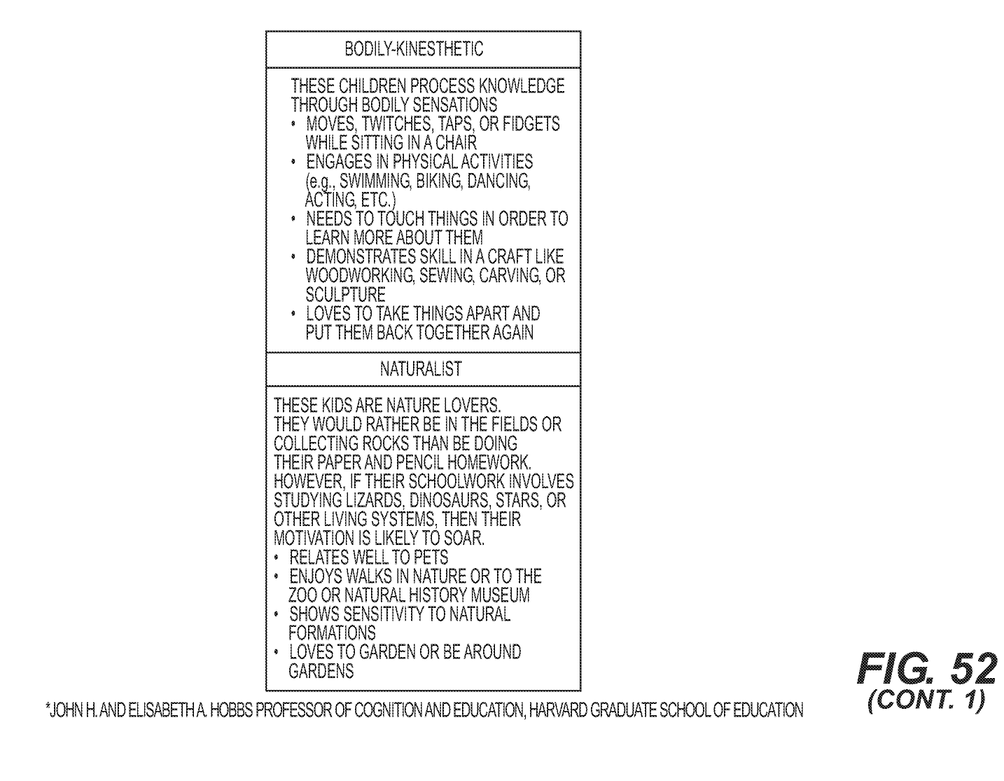

Multiple Intelligences is a theory of intelligence that differentiates it into specific (primarily sensory) “modalities”, rather than seeing intelligence as dominated by a single general ability. Psychologists historically believed that intelligence can be measured and represented by a single factor such as an IQ score. Multiple Intelligences is a different concept advanced by Professor Howard Gardner from the Harvard Graduate School of Education over 30 years ago. Multiple Intelligence suggests that there is not a single intelligence, but 8 different intelligences: 1) Verbal-linguistics; 2) Logical-mathematical; 3) Visual-spatial; 4) Musical; 5) Bodily-kinesthetic; 6) Interpersonal; 7) Intrapersonal; and 8) Naturalistic. Professor Gardner believes that each individual possesses a unique blend of all 8 intelligences. Those 8 intelligences are further described in FIG. 52.

Executive Function describes the set of cognitive skills that work together to help a person learn and “produce” of outputs and achieve goals. Among others, these skills may include “Self-Regulation” functions governing a person's ability to pay attention, engage, remember, ask questions, and use efficiency and optimization to develop solutions, “Self-Realization” and “Self-Determination” functions that enables a person to effectively interact with others and create own long-term plans and goals. When executive function skills break down, behavior becomes poorly controlled thereby limiting the person's ability to go to school or work.

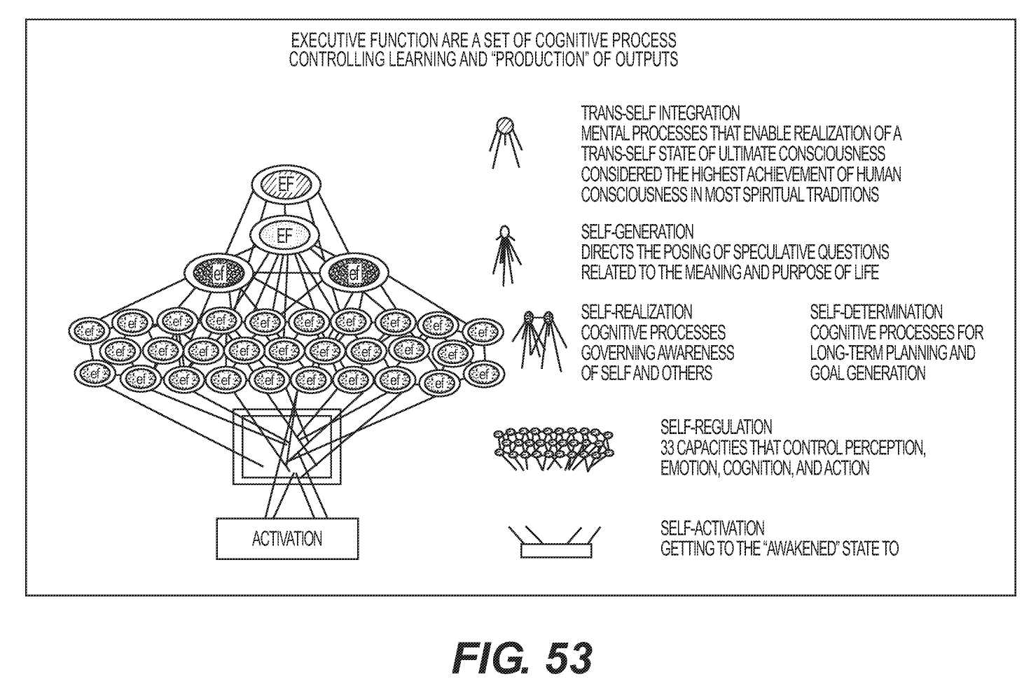

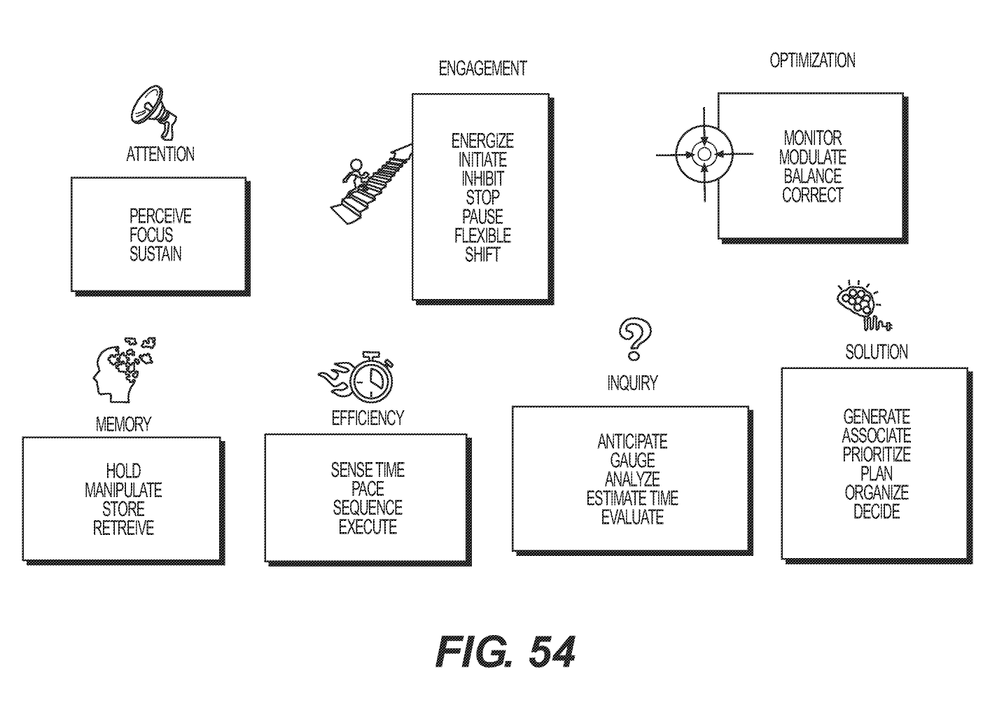

Executive Functions (EFs) are a set of mental processes responsible for directing a person's perceptions, emotions, cognition, and actions. Effective coordination and control of EFs allows one to take in and process information, plan actions and execute on those plans. Conversely, ineffective mastery of EFs results in behaviors that lead to difficulties in school and work environments. According to Dr. George McCloskey, creator of the “Holarchical Model of Executive Functions”, there are five different levels of executive control. Referring to FIG. 53, in Self-Regulation level, the HMEF specifies 33 separate EF skills. About 15 of these Self-Regulation EF skills may be assessed through games as described in FIG. 54.

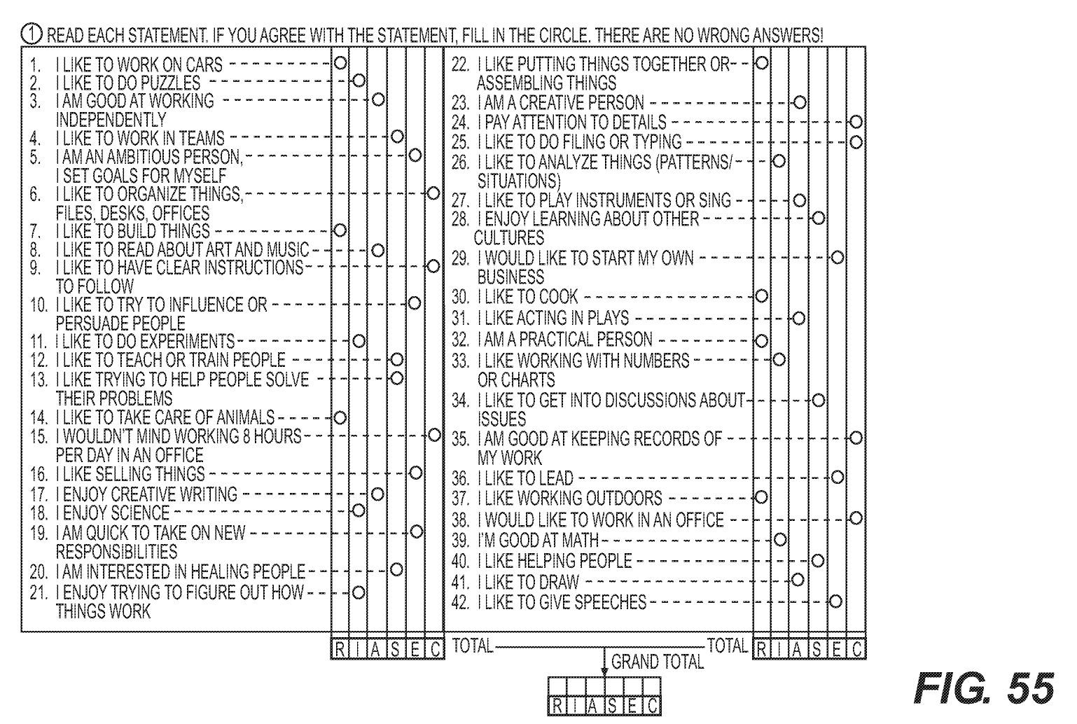

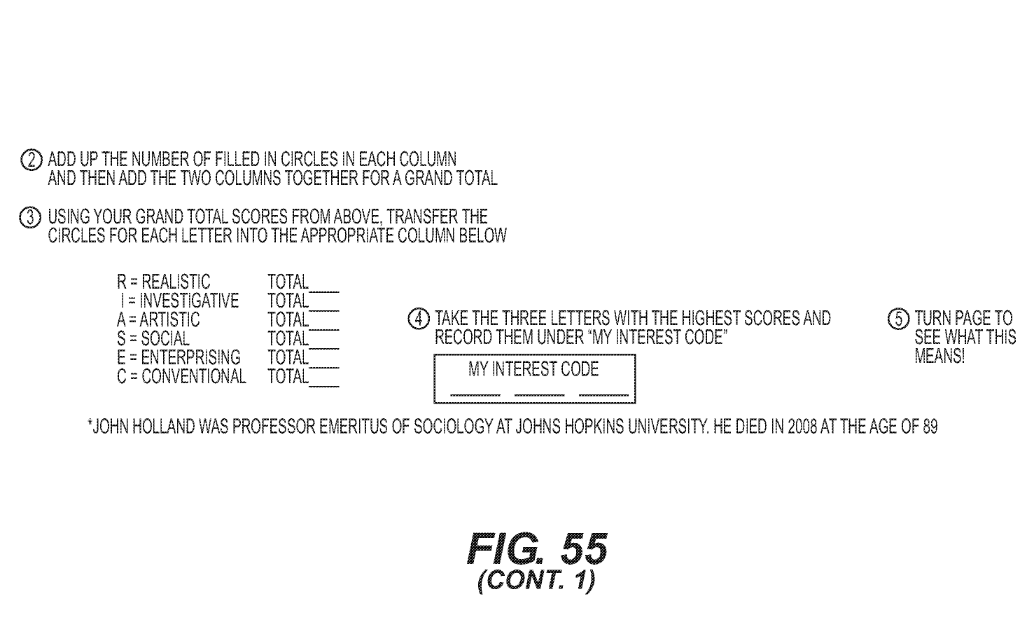

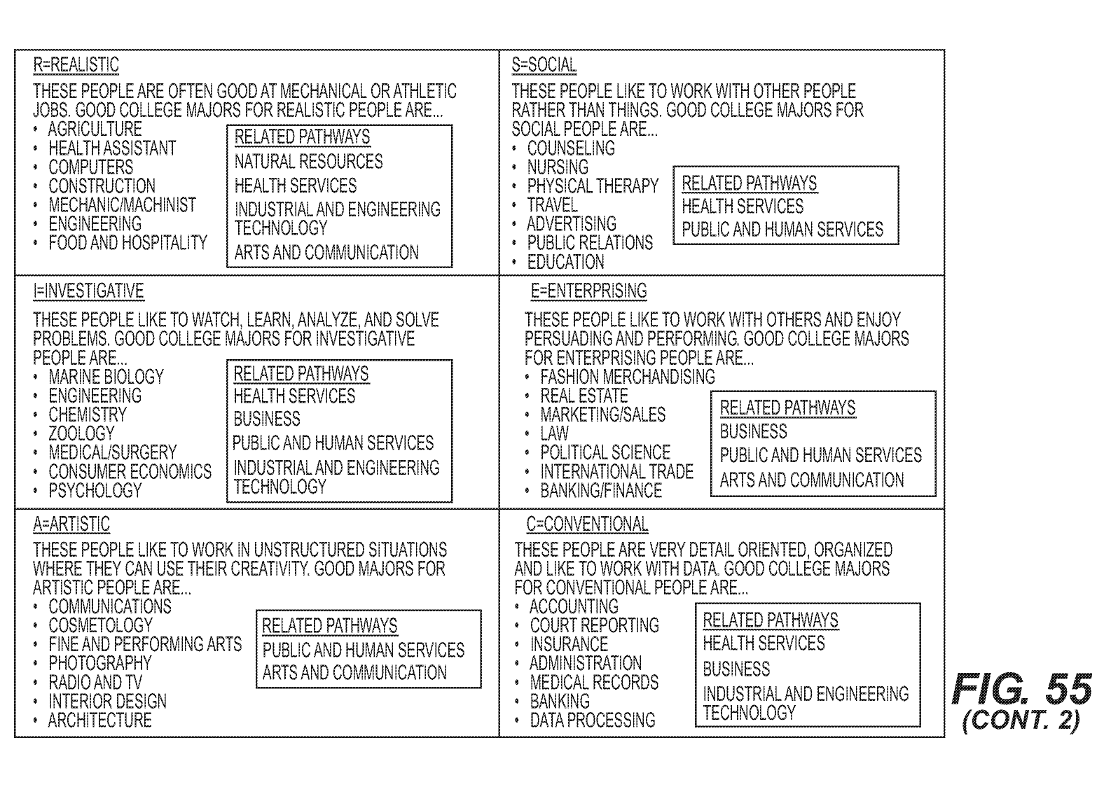

John Holland's work on career interests helps people explore careers based on how they like to spend their time. Professor John Holland from Johns Hopkins University developed a typology of career preferences over years of research on the topic. The Holland occupational preference typology is commonly referred to using the acronym for the various types in Holland's model—RIASEC. Holland suggested that peoples' preferences fit into one or more categories: realistic (doers), investigative (thinkers), artistic (creators), social (helpers), enterprising (persuaders) and conventional (organizers). These six categories describe a preference for particular work-related environments. Implicit in the theory is the concept that a person's career should reflect a person's preferences in order for that person to find fulfillment in his or her chosen career. For example, an “outdoor person” will not enjoy sitting in an office cubicle environment all day. Holland's RIASEC typology helps to highlight for people what types of work environments they may find the most interesting, and this typology has wide acceptance among career counseling professionals over the past many decades. RIASEC and the Holland codes are further described in FIG. 55.

In an embodiment, the systems and methods of identifying an individual's abilities, skills and interests may combine an understanding of a person's ability (Gardner's abilities and Executive Function skills) with an understanding interests described by Holland, thereby enabling the pursuit of educational/vocational options consistent with each individual's profile.

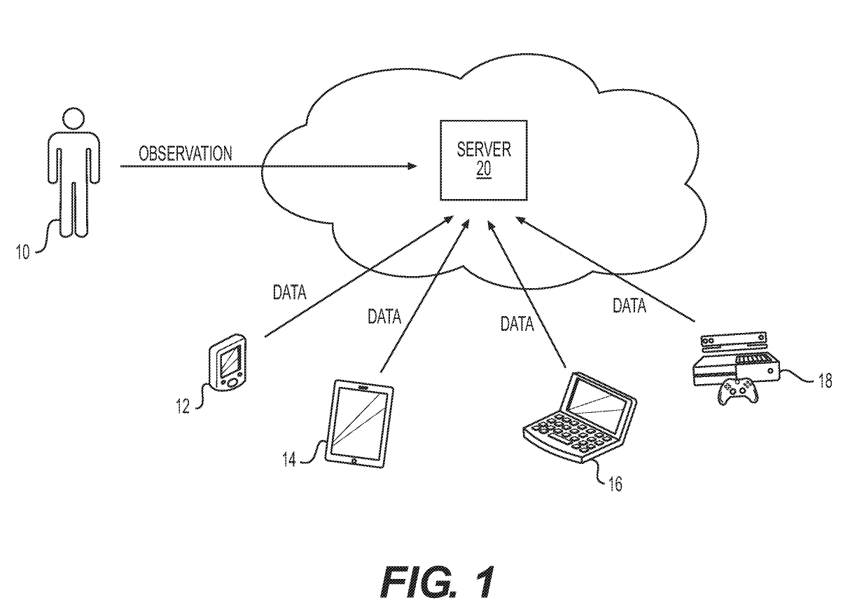

FIG. 1 illustrates an example identification system that can provide an indication of personal characteristics based on game data and game performance according to an embodiment. For example, a server 20 comprises a processor and memory. The memory coupled to the processor may comprise at least one executable instruction that when executed by the processor causes the processor to effectuate operations comprising receiving game data indicative of a plurality of games, determining a first comparative game performance associated with a first game of the plurality of games, deriving a personal character from the first comparative game performance, and providing an indication of the personal characteristic.

Each of the plurality of games can be designed to assess at least one personal characteristic: human abilities, cognitive skills, and career interests. The human abilities can include math skills, logical reasoning skills, linguistic skills, visual-spatial skills, musical skills, bodily-kinesthetic skills, interpersonal skills, intrapersonal skills, naturalistic skills, or the like. The cognitive skills can include attention functions, engagement functions, optimization functions, efficiency functions, memory functions, inquiry functions, solution functions, or the like.

As illustrated in FIG. 1, each game can be played by a mobile communication device 12, tablet 14, computer 16, multimedia console game 18, or wearable devices. Each game may transmit the game data to the server 20 over wireless and/or wired network. The first comparative game performance is determined, for example, based on the game data and comparative game information. The comparative game information may include a comparison between game performance associated with the first game and respective game performance associated with at least one other game of the plurality of games.

In an embodiment, the comparative game information can include benchmark tables displaying scores and performance levels of a user's game performance. The benchmark table can also display scores and performance levels for other users' game performance. Specifically, the user's game performance can include at least one metric, which are measurements for the personal characteristics such as math skills, logical reasoning skills, attention functions, engagement functions, or memory functions. In order to determine the scores and performance levels for the game that the user has played, first, at least one metric associated with the game can be determined. Based on the metric, raw scores for each metric can be calculated and averaged. Lastly, based on the averaged raw scores, the scores and performance levels for each metric can be determined.

In another embodiment, the first comparative game performance associated with the game that the user has played can include at least one percentile rank for each of the metric associated with the game. For example, when a user plays Word Grid, a comparative game performance can include the user's percentile information in the area of logical reasoning skills among all other users. Specifically, the user's percentile information can be determined based on the comparison between the user's game performance and other users' respective game performance.

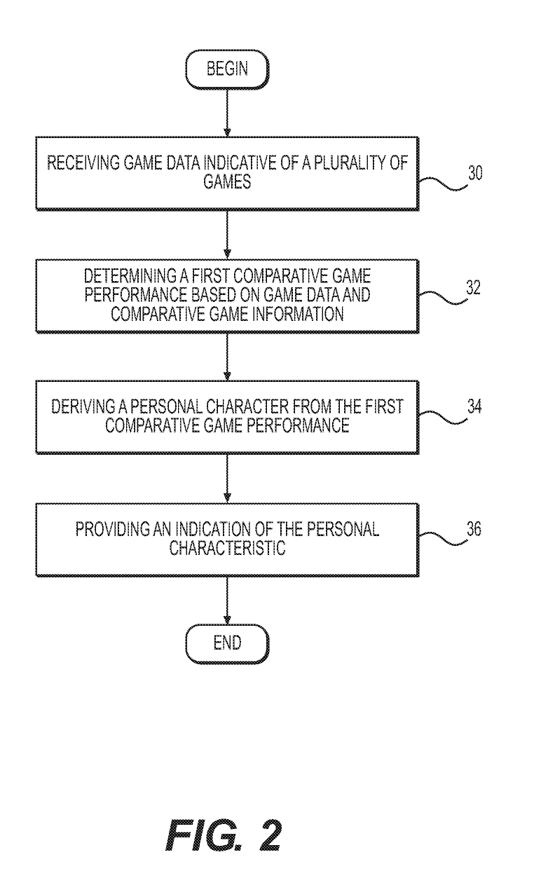

FIG. 2 illustrates an example process flow that can be performed by the identification system illustrated in FIG. 1. For example, at step 30, game data is received at a server from each of the plurality of games that is designed to assess at least one personal characteristic. The personal characteristics may comprise an individual's abilities, skills, and/or interests. Upon receiving the game data, a first comparative game performance associated with a first game of the plurality of games may be determined by the server at step 32. The first comparative game performance is determined, for example, based on the game data and comparative game information. The comparative game information may include a comparison between game performance associated with the first game and respective game performance associated with at least one other game of the plurality of games. At step 34, a personal character from the first comparative game performance may be derived and at step 36, an indication of the personal characteristic may be provided by the server.

In an embodiment, players may play games on PCs, mobile devices, tablets, multimedia console games, wearable devices, or the like. Those games can be designed to assess some aspects of Gardner's Multiple Intelligence through focus of games: linguistics, logic-arithmetic, spatial, music. There is no defined way of measuring multiple intelligences similar to an IQ test. Not an “MI score”, but a directional understanding of a person's abilities, skills and interests can be provided through the process illustrated in FIG. 2. This understanding can be obtained through games that get increasingly difficult and thus require special skills/intelligence in a particular area to advance to the highest levels. By analyzing the data on how a player reacts to the challenges posed, a sense of comparative game performance how a player compares to others who have played that game can be obtained. If a player is among the top 10% of all players in a certain area of the game, there is a high probability that this is an area of strength.

As described above, the games can be designed to capture multiple intelligences. Some intelligence, for example, logic, math, visual, and spatial, can lend themselves better to being evaluated by games than others. Additional games may be created to assess interpersonal skills by using technologies such as Xbox Kinect to assess bodily-kinesthetic abilities.

The games can also be designed to assess Executive Functions, focusing on the 33 Self-Regulation functions and moving to Self-Realization and Self-Determination. Executive Functions is traditionally measured through direct observation by trained psychologists and professionals. Dr. McCloskey advanced the field by creating the McCloskey Executive Function Scale (MEFS). The MEFS can be completed by parents, educators, other professionals, and the individual himself/herself if able to provide a 360° view of a person. In addition to direct observations through the MEFS, the games can also provide a profile of a player on some of the EF skills that can be detected using games.

It is believed that effective Executive Function is critical in both the classroom and the workplace. Effective mastery of EF skills may allow a person to pay attention, engage, optimize his/her plans to achieve efficiency, and generate/execute solutions. These are skills that enable success in both the classroom and the workplace.

The games can be designed to assess Holland interest battery through interactive version of the Career Interest Survey. In assessing the RIASEC, the traditional RIASEC word-based survey is not likely used because a significant portion of individuals with autism, dyslexia, etc. has difficulties using these tools. Instead, image-based career interest assessment tool can be used to assess the career interest. The image-based career interest assessment tool may ask participants to choose between pairs of careers that are presented using text, images, and voice. This multi-media presentation of the RIASEC types can maximize the likelihood that the test taker truly understands each item. Using the science of discrete choice analysis, the most preferred work environments can be inferred more effectively than more conventional approaches. The career interest assessment to identify an individual's primary work interests can be used. This information, in turn, can be used to identify possible careers the individual may find fulfilling.

In an embodiment, the games requiring bodily movement can be designed to assess aspects of body-kinesthetic. For example, the games using Xbox Kinect motion detector assess the aspects of bodily-kinesthetic. In another embodiment, the games can be designed to remotely assess the individual's abilities, skills and interests described above by using video conferencing tools such as Skype. In addition, the games can be designed to perform in-person assessments at centers around the country or world.

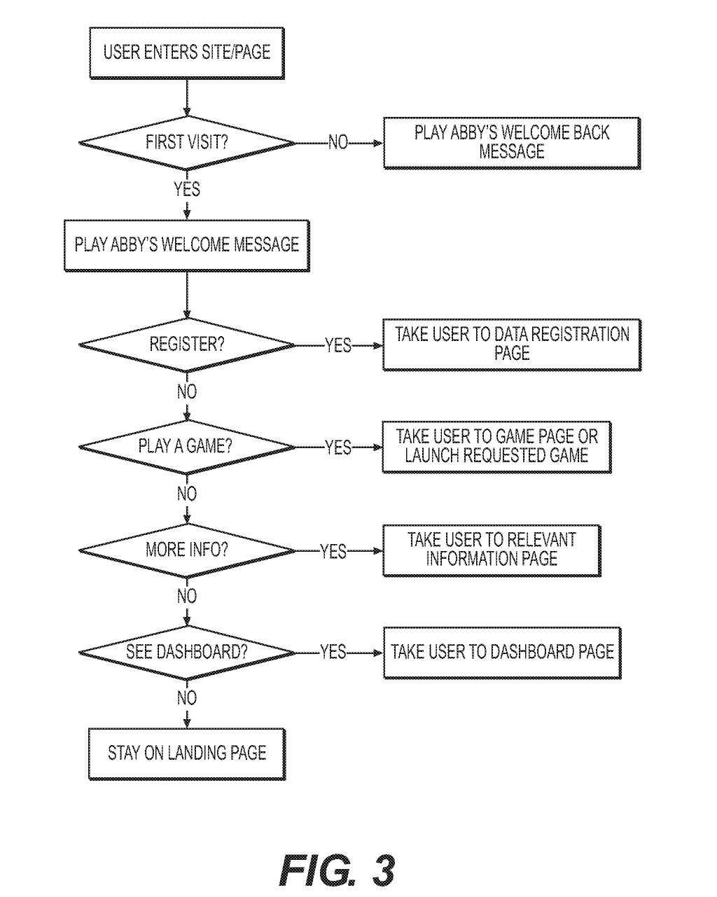

FIG. 3 is an example process flow that can be implemented using a site to identify personal characteristics according to an embodiment. As illustrated in FIG. 3, a user who enters the site may register his account, play games, receive information about Howard Gardner's Multiple Intelligences work, Executive Function, and John Holland's work on career interests, and review the results for completed games through dashboard. The site can be implemented by a webpage, a mobile application, or the like.

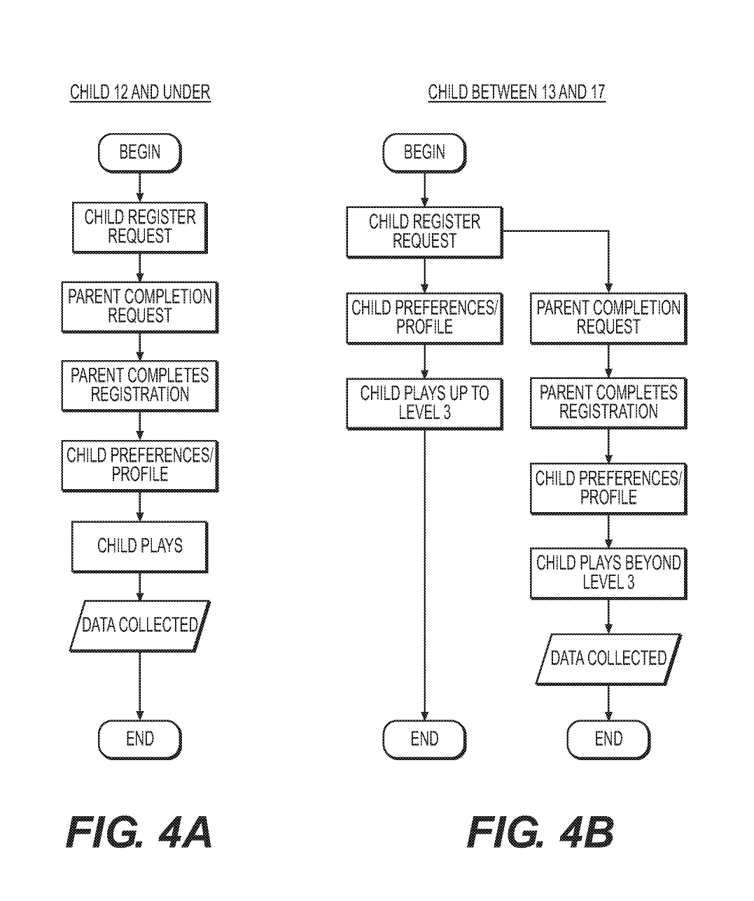

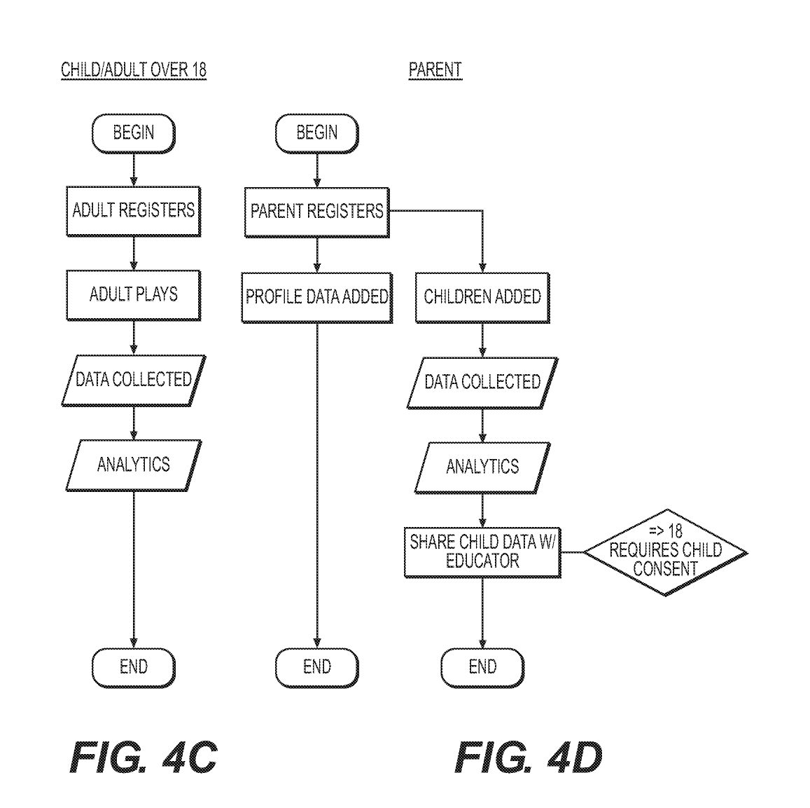

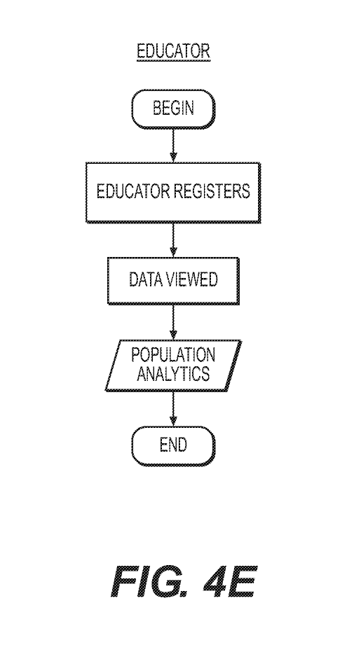

FIGS. 4A-E illustrate various account registration flows to identify personal characteristics according to an embodiment. For example, a website may have different registration processes based on the users' age. FIG. 4A illustrates an account registration flow for children who are 12 or under 12 years old. FIG. 4B illustrates an account registration flow for children between 13 and 17 years old. FIG. 4C illustrates an account registration flow for children or adults over 18 years old. FIG. 4D illustrates an account registration flow for parents. FIG. 4E illustrates an account registration flow for educators.

In an embodiment, registration can be free and required to enable users to have complete access to all levels in the games. A subscription can be required to access the parents' reports on the child's abilities, skills, and interests. These reports may provide invaluable insights that help parents explore areas of strengths and plan for productive futures for their child.

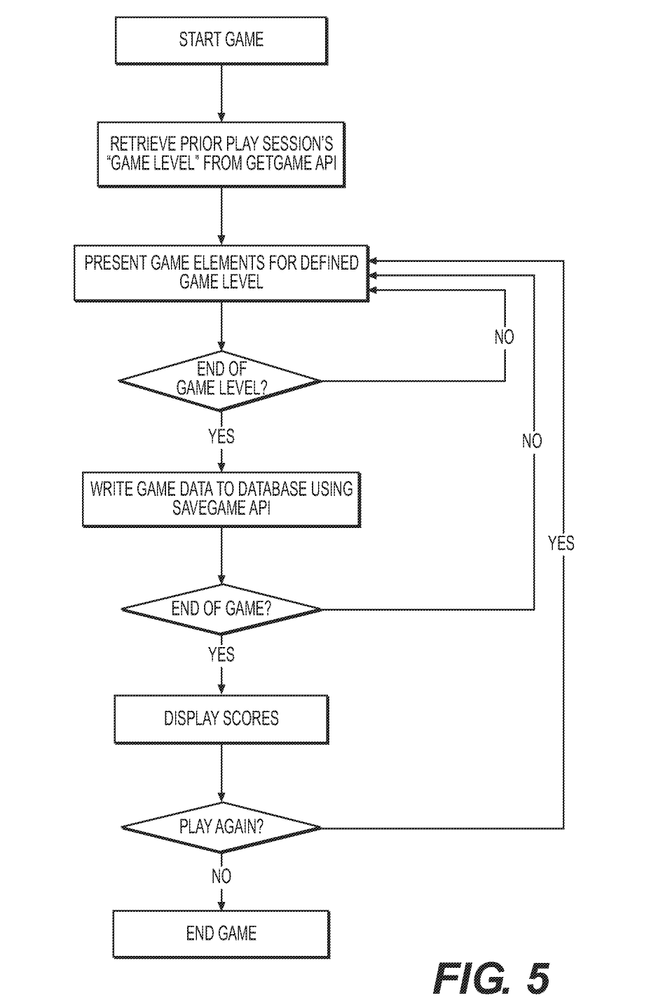

FIG. 5 illustrates a data collection flow of a game that is designed to assess personal characteristics according to an embodiment. When a user plays a game, game data can be stored to database using application programming interface (API). The game data can be transmitted to a cloud server over the wired/wireless network. Examples of data elements collected for each level and round by various games are:

Date/time stamp

Level Number

Level Successfully Completed (Yes/No)?

Score

Amount of time available

Amount of time used

% of available time used

Number of cars in lot

Theoretical minimum # moves

# Moves taken

Number of mirrors used

Theoretical minimum mirrors needed

Hint mode was used (Yes/No)

# word possible

# words correct

# words missed

Number of squares on grid

Was Incorrect click on a Number or Empty Space

High number in sequence to be remembered

# hidden eggs

# eggs found

# wrong clicks

# times hint was used

# Correct answers

# Wrong answers

# children in level

# adults in level

# elderly in level

# problems shown in level

Number of Incorrect Matches

Max umber of Spaces between numbers

Total # of balls presented in Line

# Balls fired

# Times User clicked on correct ball to complete Match

# of Times user fired to group same numbers for bonus points

How many balls not cleared at end

# Unique Items shown Number of Duplicated Items shown

Number of Non-Clicked Duplicated Items

# of correct clicks

# of incorrect clicks

# of Shapes Shown

# shapes used

# shapes discarded

# shapes untouched

# of Rotations

Total # of Cubes

# of Visible Cubes

# of Hidden Cubes

# of wrong answers

# of Seesaws

# of Weights In Problem

# incorrect answers

# Images to compare

# Differences to find

# wrong clicks

# of Hints Used

Matrix size

# of rotations

Total number of clicks

# of Bulbs

Total # of Clicks

Theoretical minimum number of clicks to complete

# Resets

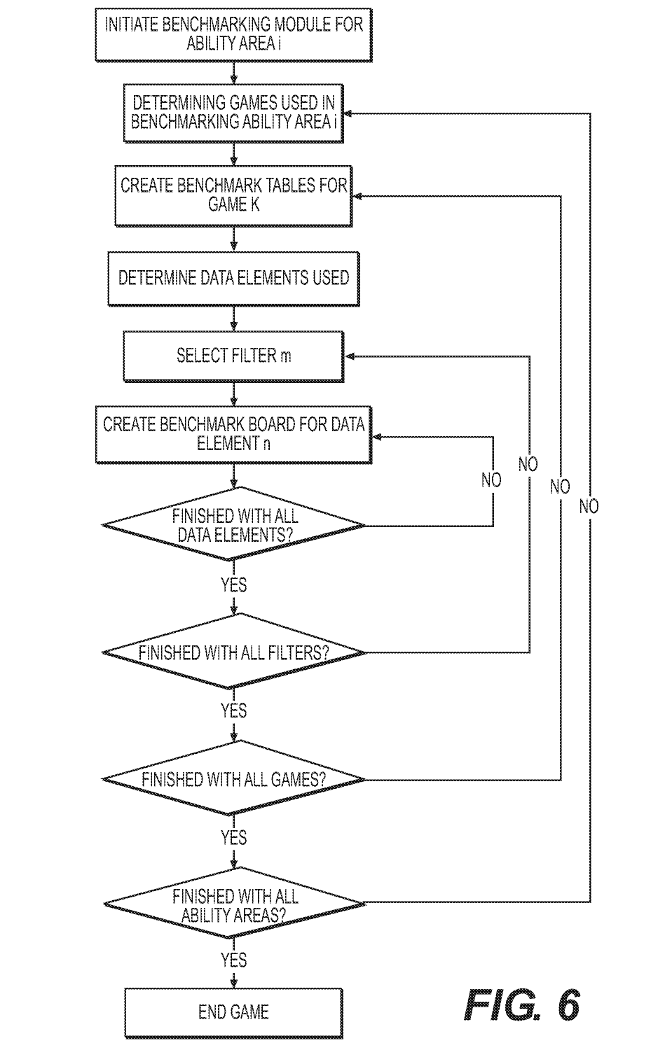

FIG. 6 illustrates an example process flow of generating comparative game information according to an embodiment. The comparative game information may indicate how the player plays in comparison to other players in the games. The comparative game information may have a format of benchmarking tables.

Referring to FIG. 6, the process for preparing benchmarking tables may go through all the players who have played the various games to create benchmark table. The benchmark table can help determine the scores and/or performance level required to be at the 99^{th} percentile, 98^{th} percentile, etc. As shown in FIG. 6, the Ability Area can be Logic, Math, Music, Attention, Focus, etc. The filters may provide the ability to look at all players or select the comparison set based on (among other possibilities): gender, age, clinical diagnosis, etc. In an embodiment, a batch process can be initiated periodically, for example, hourly, every x hours, or daily. The periods for the batch process may be predetermined.

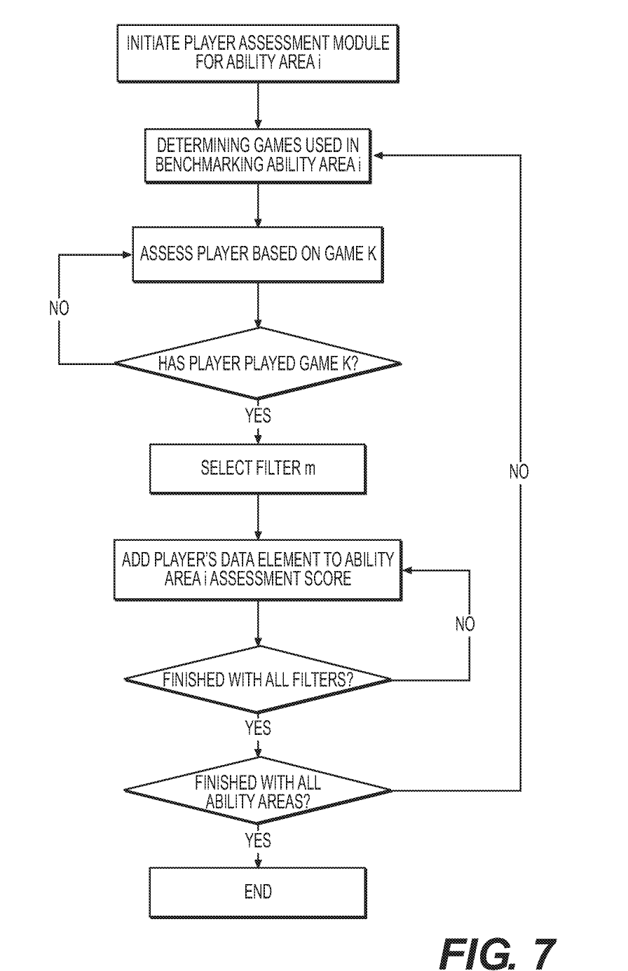

FIG. 7 illustrates an example process flow of determining a player's performance according to an embodiment. As described in FIG. 6, once the benchmark tables have been calculated, the process for determining player's levels can be used to determine how each player in the database stands in comparison to all other players using data from the games that the player has played. In FIG. 7, the Ability Area can be Logic, Math, Music, Attention, Focus, etc. The filters may provide the ability to look at all players or select the comparison set based on (among other possibilities): gender, age, clinical diagnosis, etc. In an embodiment, a batch process can be initiated periodically, for example, hourly, every x hours, or daily. The periods for the batch process may be predetermined.

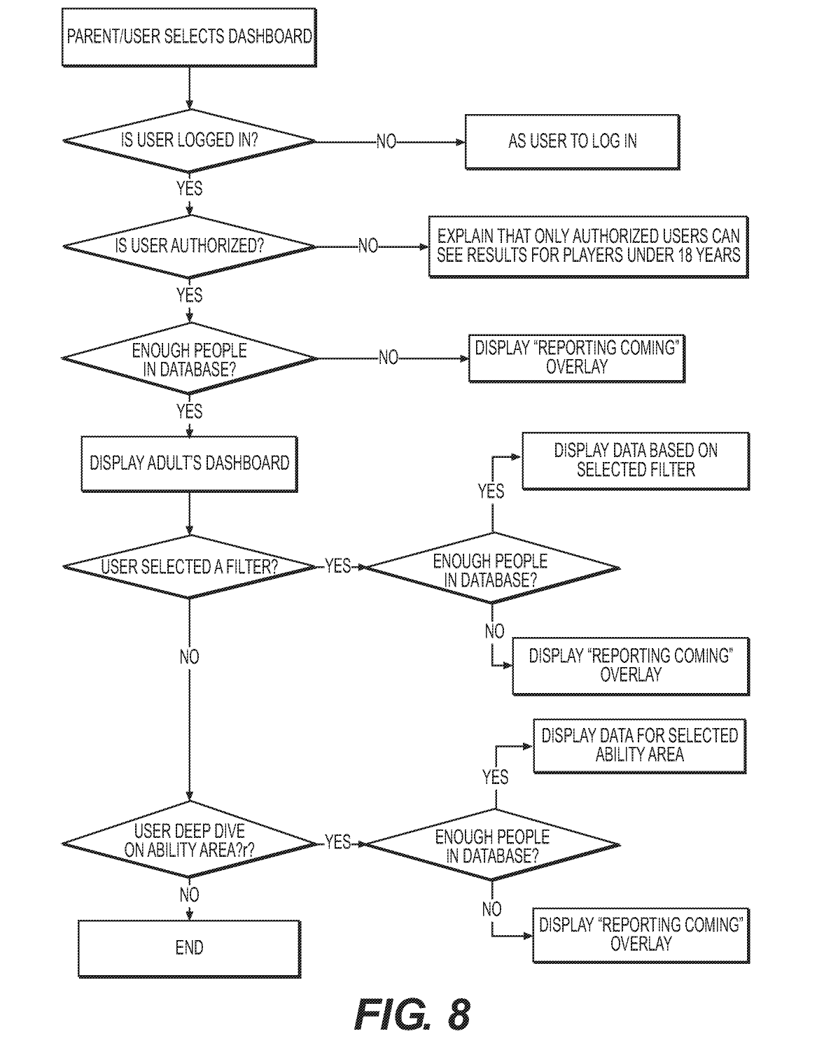

FIG. 8 illustrates an example process flow of reporting a player's relative performance on dashboard according to an embodiment. Once a player's relative performance to other players' performance in various filter groups have been determined, the resulting data can be shown to parents and other authorized adults using dashboard. In FIG. 8, the Filters may provide the ability to look at all players or select the comparison set based on (among other possibilities): gender, age, clinical diagnosis, etc. The Ability Area can also be Logic, Math, Music, Attention, Focus, etc.

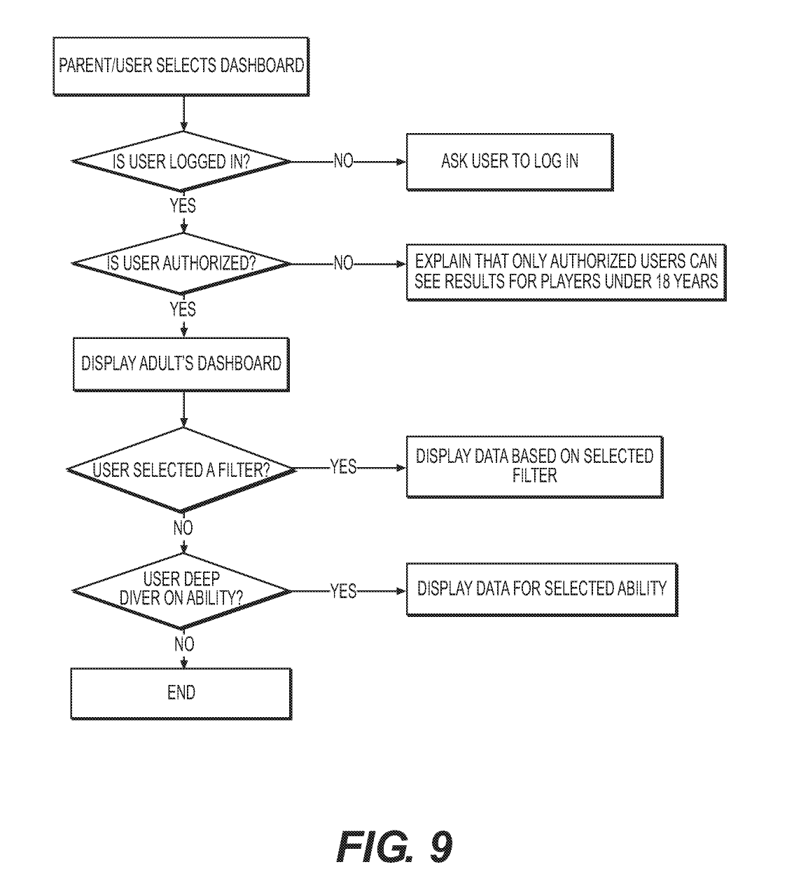

FIG. 9 illustrates another example process flow of reporting a player's relative performance according to an embodiment. As described in FIG. 8, once a player's relative performance to other players' performance in various filter groups has been determined, the resulting data can be shown to parents and other authorized adults using dashboard. In FIG. 9, the Filters may provide the ability to look at all players or select the comparison set based on (among other possibilities): gender, age, clinical diagnosis, etc. The Ability Area can also be Logic, Math, Music, Attention, Focus, etc.

In an embodiment, game results and reports can be sent to parents and/or professionals who subscribe to the service. The authorized parents and/or professional can view reports on an individual through the website, mobile application, or the like. Parents (or subscribing educator/professionals) may have the option of sending the reports to others with the parent's discretion.

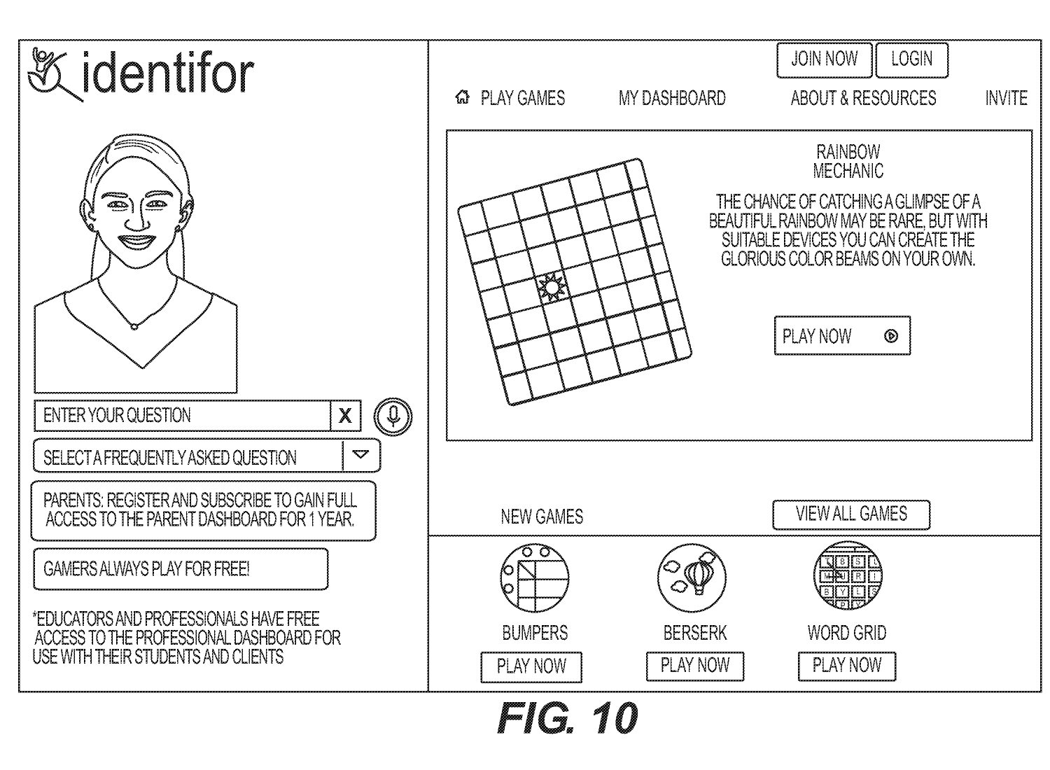

FIG. 10 is a screenshot of an example website to identify personal characteristics when a user enters the website according to an embodiment. The website may include a human avatar as a user interface based on an artificial intelligence engine. The human avatar may recognize natural language and speech to engage users into the website. The human avatar can be implemented across multiple channels such as PCs, tablet PCs, mobile devices, wearable devices, or the like.

In an embodiment, the human avatar can listen to user's comments and give responses to the comments. For example, if a user asks the human avatar about his or her medical information, then the human avatar may provide users the medical information such as autism, ADHD, dyslexia, and other medical conditions. The human avatar may also provide information about individual's characteristics including multiple intelligences, executive function, and job/career interests. In another embodiment, the human avatar may suggest games that a user should play in order to assess their multiple intelligences and executive function. This recommendation can be based on usage patterns of users. For example, the human avatar can adopt a collaborative filtering technique to predict games based on usage patterns of users. The human avatar may also ask players to choose between job choices. The sounds of the human avatar may be implemented with a recording of a real person. The human avatar can take many forms of interfaces such as a personal assistant, email, audio, robot, cartoon, or the like. In an embodiment, the avatar can be a verbally generated personification of text.

The human avatar can also provide functions of life coaching to the users. The life coaching by the human avatar can include advising, educating, monitoring, reminding, or the like. Through the life coaching process, the human avatar can address various situations that users may find themselves in the course of a day. The situation can be in any context such as school settings, work environment, housing, transportation, or social settings that users face every day. Example life coaching conversations between the human avatar (Abby) and a user are illustrated below:

### Abby Greeting Upon App Start

Hi, I'm Abby. I'm here with you throughout the day to answer questions you may have and to help you get organized. So just ask and I'll do what I can to help.

### Conversation Sequence 1:

User: Abby, I have to be at work on time tomorrow morning, so could you set my alarm for 6:00 a.m.?
Abby: Sure. Would you like me to call you on your phone with a reminder as well?
User: Yes please. Could you call with a reminder 15 minutes after the alarm?
Abby: OK, I'll call you at 6:15 a.m.
Abby: I see that “pick up milk” is still on your to-do list. Did you stop by the grocery store on the way home yesterday?
User: No, I forgot
Abby: Would you like for me to remind you when you get off the bus to walk home today?
User: Yes please. How do you know when I get off the bus
Abby: You gave me access to your phone's GPS when we started, so I can see where you are. I'll call you when I see you arrive at your usual bus stop. Is there anything else you need from the grocery store?
If the answer is YES
User: Yes, could you add cereal and bread to the list?
Abby: You got it.
If the answer is NO
User: No thank you
Abby: No problem. Just let me know in the future if you want me to add anything.

### Conversation Sequence 2

User: My parents are coming over for dinner this weekend, and I'd like to make tacos for them. Can you tell me how?
Abby: Sure. There are different types of tacos. The regular beef tacos are most popular, but chicken, shrimp, fish are other options as well. What do you want to make?
User: Beef tacos is what they like
Abby: Fine. I will email you a recipe. Would you like me to add the ingredients to your shopping list as well?
If the answer is YES
User: Yes please.
Abby: Done. You'll see it in your shopping list when you are at the grocery store tomorrow.
If the answer is NO
User: No thank you
Abby: No problem. Just let me know in the future if you want me to add anything

### Conversation Sequence 3

User: When should I take my medication?
Abby: You should take your medication at the times directed by your physician. I can help you create a reminder for each medicine if you like. Creating this schedule may take some time, depending on how many medicines you need to take. Would you like to create the schedule now?
If the answer is NO
User: Not now Abby
Abby: No problem. Just let me know in the future if you want me to help you create this schedule
If the answer is YES
User: Yes please.
Abby: OK, let's get started. First, you will need to collect the medicine bottles that you need to take. I'll wait for you. Just tell me when you're ready
User: I'm ready
Abby: What's the name of the medicine you need to take?
User: Lipitor
Abby: Got it. How frequently do you need to take it?
User: The bottle says once a day
Abby: Great. Does the instruction indicate a particular time?
User: It says before going to bed
Abby: OK, would to like me to remind you at 9:00 p.m. each day as you go to bed?
If the answer is YES
User: Yes please
Abby: Done. Your to-do alarm will go off each night at 9:00 p.m. to remind you to take your medicine
If the answer is NO
User: No, I'd like another time please
Abby: No problem. When would you like to be reminded?
User: I usually go to bed around 11:00 p.m. So please remind me then
Abby: You got it. Your to-do alarm will go off each night at 11:00 p.m. to remind you to take your medicine
Abby: OK, we're set with your first medicine. Is there another medicine you would like to be reminded of?
If the answer is YES
User: Yes please
Abby restarts loop at step 4
If the answer is NO
User: No, I'm done
Abby: Great

### Conversation Sequence 4

User: How much should I leave for a tip at a restaurant?
Abby: American waiters and waitresses usually expect 18% of the bill as a tip. If you tell me the total amount of your bill, I can calculate the tip for you. Would you like me to calculate a tip amount for you?
If the answer is YES
User: Yes please.
Abby: OK, how much is your total bill?
User: $27.85
Abby: OK, 18% of $27.85 is $5.02. You can just round it to $5.00
If the answer is NO
User: No thank you
Abby: No problem. Let me know if I can help you with anything else.

As described above, the human avatar can provide answers to various questions raised by users. Examples of questions and answers between the human avatar and the users are illustrated below:

Question: Someone said to me TGIF. What does that mean?
Answer: TGIF is short for Thank God It's Friday. It means that the person is glad the work week is over and it's time for the weekend
Question: What does a pedestrian crossing sign mean?
Answer: This means people have the right to cross between the lines and the cars should need to stop for you even if not at a traffic light. You will see a sign . . . Check to make sure no cars or coming or that they have stopped, cross the street swiftly between the cross walk lines
Question: What should I do when the pedestrian light doesn't change to let me cross the road?
Answer: Always wait to see the walking person icon on the pedestrian light. You may need to push a button to tell the traffic light you are waiting to across. See if there is a button similar to this image. Push it if you find one.
Question: There are no sidewalks on this road. What side of the road should I be walking on?
Answer: You should always walk against traffic so that the cars are coming at you and you can see them.
Question: Is it okay to put my feet on an empty seat across from me on a bus or a train?
Answer: You should not put your legs and feet on the seat as someone else may need to sit there and it should be kept clean.
Question: What should I do if the person on the bus or train is too close and makes me feel uncomfortable?
Answer: You should quietly get up and move to another seat some distance away and around people you feel are safe. You may also speak to the train conductor.
Question: What does “a quarter to nine mean”?
Answer: It means 8:45. Since there are 60 minutes in an hour, one quarter means 15 minutes. A quarter to 9 means 15 minutes before 9, so that's 8:45
Question: How do I complete assignments at work that I don't like or agree with?
Answer: This is a very difficult question to answer. It really depends on what needs to be done and why you dislike or disagree with the work assignment. Sometimes there are good reasons for not doing something because it is inappropriate or wrong. But other times the task still needs to be completed even if you don't like it. The best way to figure out your situation is to discuss it with a trusted colleague. You may also consider raising your concerns with your boss and ask for his or her guidance on what you need to do.
Question: My total for my groceries is $56.67, but I only have $20 bills. What should I give the cashier?
Answer: You should give him/her 3, $20 bills, which is $60, and he/she will give you change in return
Question: I haven't gotten my pay check in 3 weeks, what should I do?
Answer: You should call your employer and explain that you have not received your paycheck in a long time. Ask them what needs to be done.
Question: Someone I don't know is at the door asking me to let them in. What should I do?

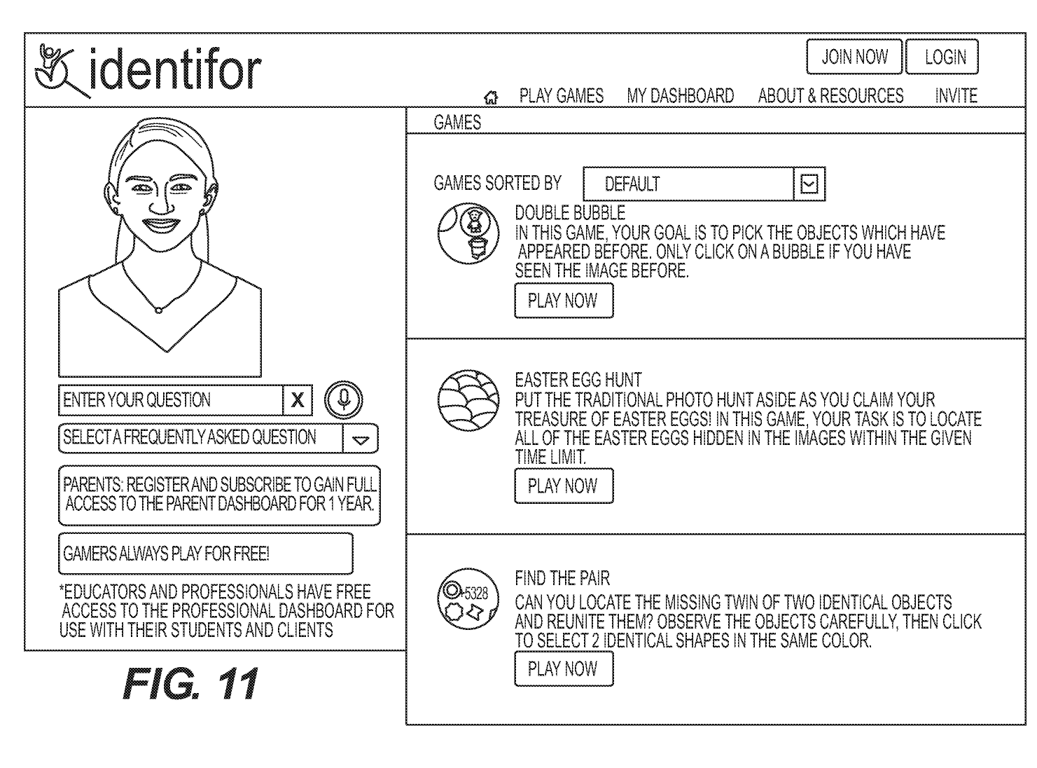

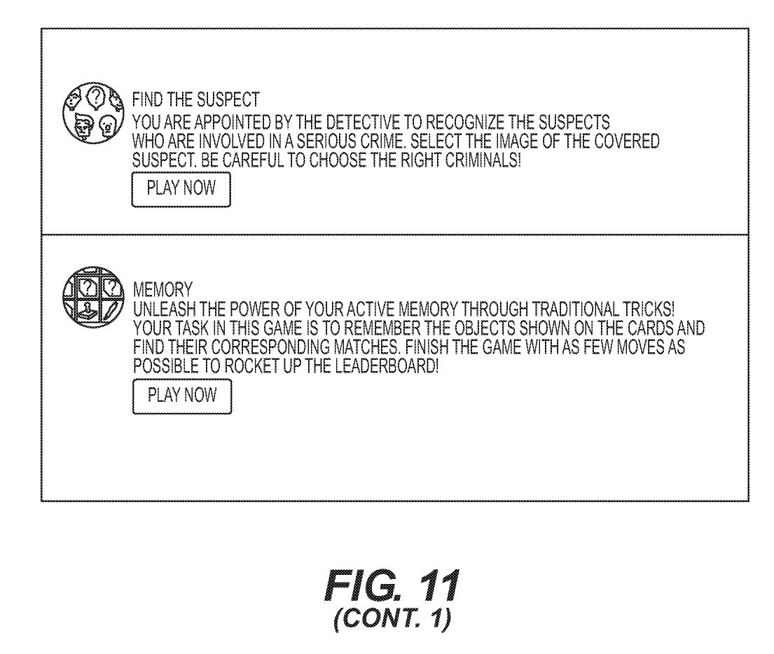

Answer: You should never let anyone enter your house unless you know them or if they have a good reason for entering. A good reason may be someone delivering a package and may need you to sign for it. If you are not certain, call your parent or someone you trust to ask. FIG. 11 is a screenshot of an example website to identify an individual's abilities, skills and interests when a user selects play games according to an embodiment. In an embodiment, games can be casual games that children, teens and adults find interesting to play on their mobile phones, PCs, or tablets. These games can be designed to provide insights into three important areas: a person's multiple intelligences, Executive Functions, and career interests. Duration of a game can vary widely, ranging from a few minutes to tens of minutes. This may depend on a player's abilities to advance and interest in continuing. The game may give a player the choice to stop or continue.

In another embodiment, games can be designed to be intuitive and require no supervision. Since they examine a person's abilities, parents/adults do not help an individual play (except if the person has motor challenges and can benefit from motor support). Although the games are designed for autistic teenagers, it can be played by anyone—at any age and regardless of clinical diagnoses.

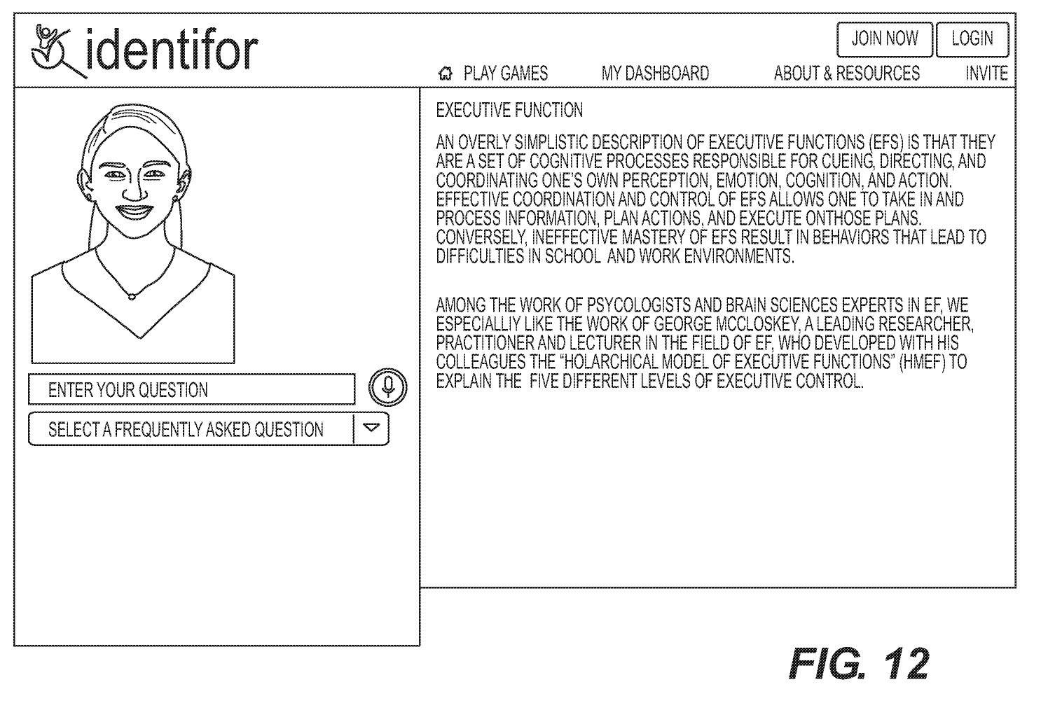

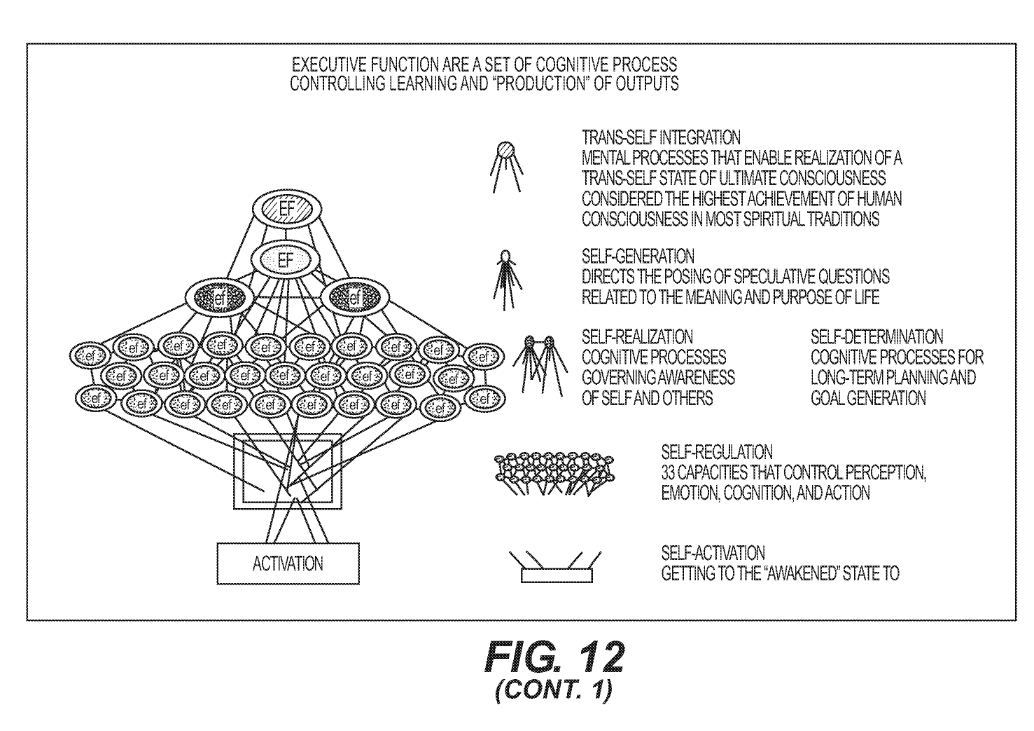

FIG. 12 is a screenshot of an example website to identify personal characteristics when a user selects an informational page to learn the individual's abilities, skills and interests according to an embodiment. As shown in FIG. 12, the informational page may explain details of Howard Gardner's Multiple Intelligences, George McCloskey's work on Executive Functions (EFs), and John Holland's work on career interests.

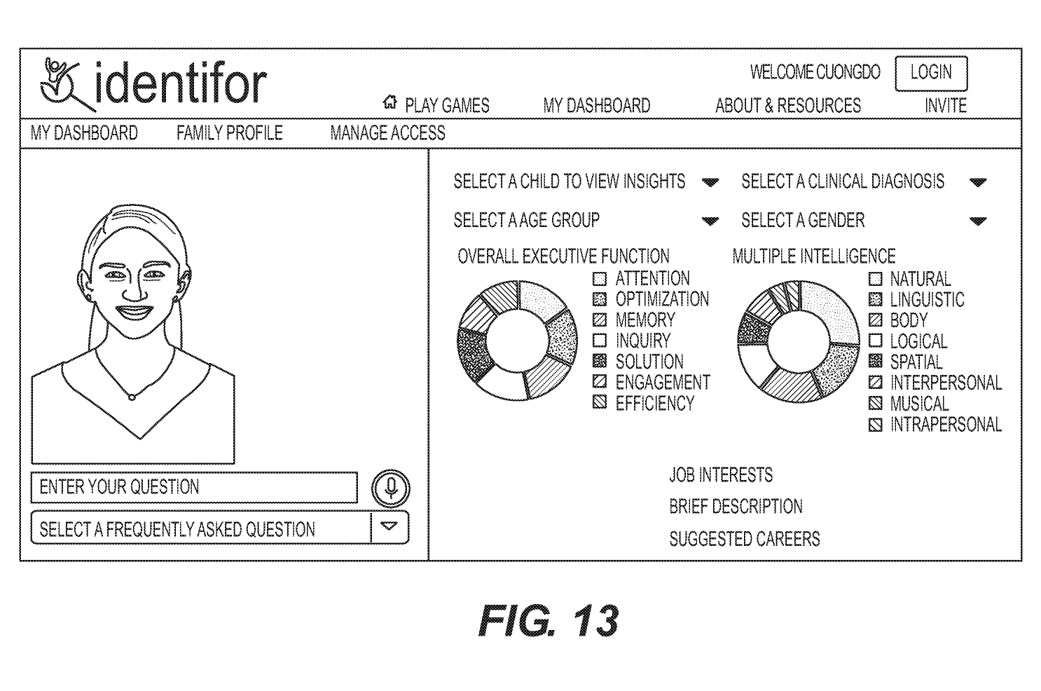

FIG. 13 is a screenshot of an example website to identify personal characteristics when a user selects a dashboard page to review the results according to an embodiment. The dashboard page may include analysis of individual's Gardner intelligences, EFs, and career interests based on the game data transmitted from games.

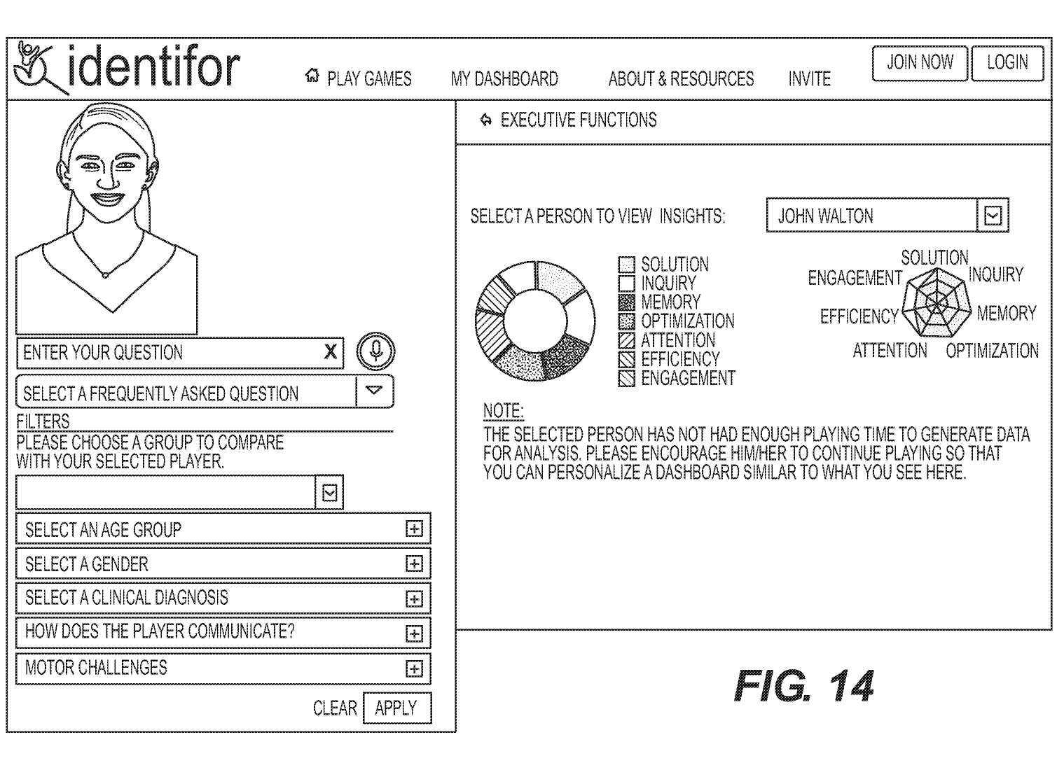

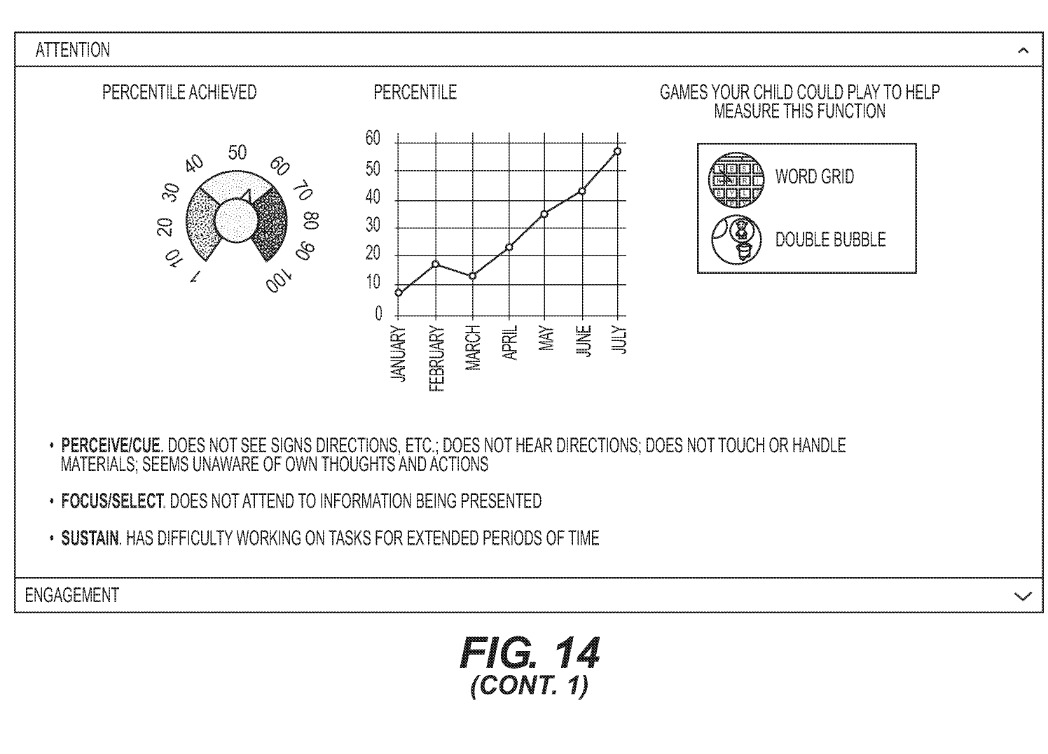

FIG. 14 is another screenshot of an example website to identify personal characteristics when a user selects a deep dive page to further review the results according to an embodiment. The dashboard page may display detailed analysis for one of the individual's Gardner intelligences, EFs, and career interests.

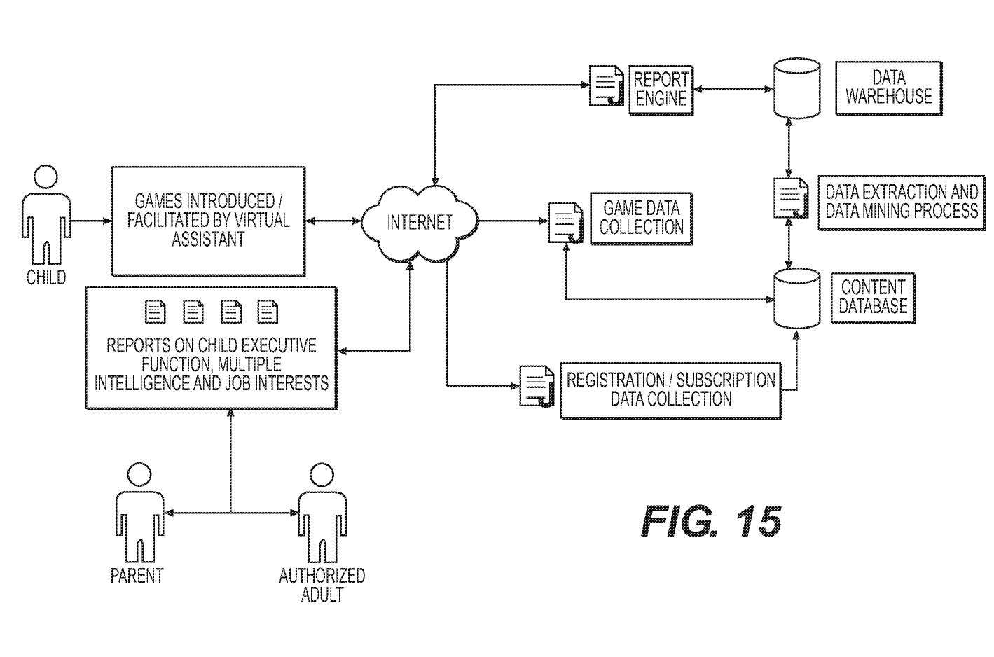

FIG. 15 is a system diagram illustrating an overview of example network to identify personal characteristics according to an embodiment. The system to identify an individual's abilities, skills and interests may comprise report engine, game data collection, registration/subscription data collection, data warehouse, content database, data extraction and data mining process.

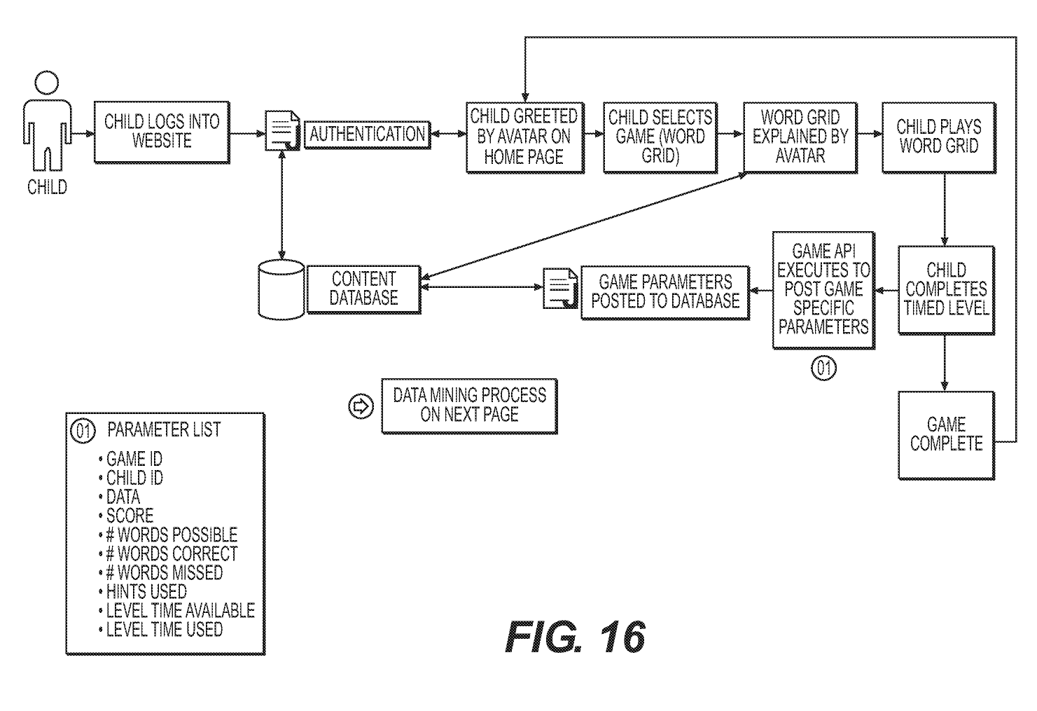

FIG. 16 is a flow diagram illustrating data collection when a registered user plays a game to identify personal characteristics according to an embodiment. In this example embodiment, a registered child age of 13 may return to the site to play game such as Word Grid. For example, the child logs into the website and authentication is performed to check whether the child is an authorized user. Once the child is authenticated, the child is greeted by a human avatar on the home page. If the child selects a game such as Word Grid, the game is explained by the human avatar. The child plays Word Grid. Once the child completes timed level, game API executes to post game specific parameters to content database. The parameter may include: Game ID, Child ID, Date, Score, # Words Possible, # Words Correct, # Words Missed, Hints Used, Level Time Available, and Level Time Used.

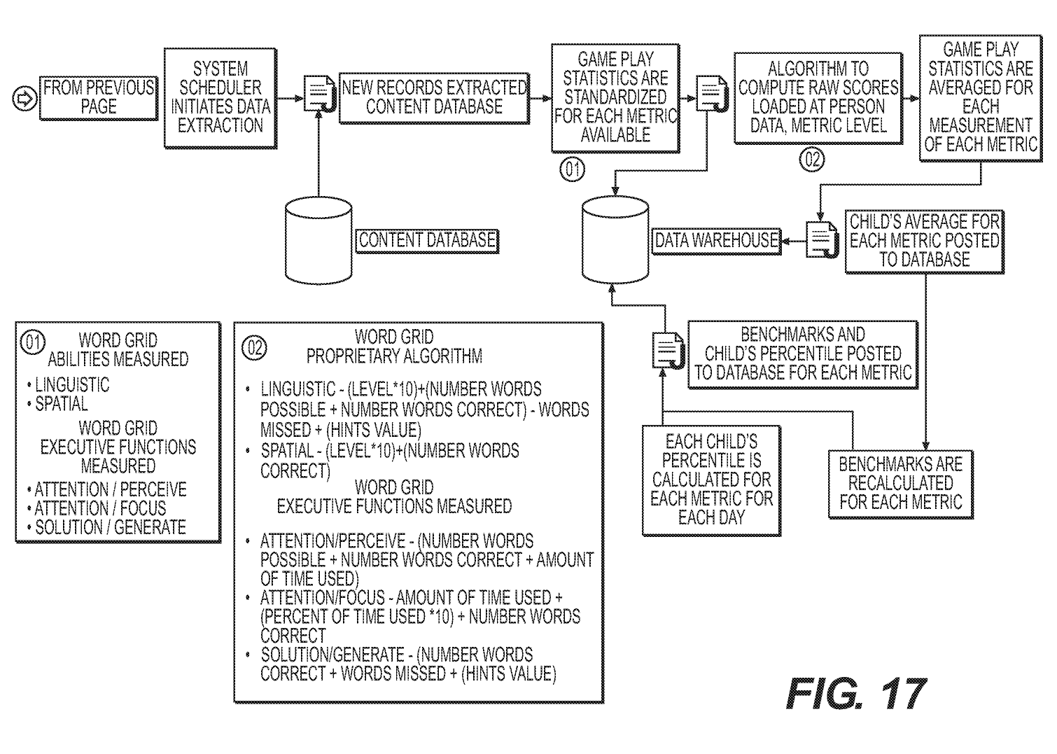

FIG. 17 is a flow diagram illustrating data mining process when a registered user plays a game according to an embodiment. Upon posting game specific parameters to content database, system scheduler may initiate data extraction process. Once data extraction process is initiated, new records are extracted from the content database and game play statistics are standardized for each metric available. For example, abilities measured by Word Grid may have: Linguistic and Spatial. Executive Functions measured by Word Grid may include: Attention/Perceive, Attention/Focus, and Solution/Generate. Upon the game play statistics are standardized for each metric, raw scores loaded at person, data, and metric level are computed with following equations:

### Word Grid Proprietary Calculation □

Linguistic—(Level*10)+(number words possible+number words correct)−words missed+(Hints Value)□
Spatial—(Level*10)+(number words correct)

### Word Grid Executive Functions Measured□

Attention/Perceive—(number words possible+number words correct+amount of time used)□
Attention/Focus—amount of time used+(Percent of time used*10)+number words correct□
Solution/Generate—(number words correct+words missed+(Hints Value)
   Upon computing raw scores, game play statistics are averaged for each measurement of each metric and the child's average for each metric is posted to data warehouse. Benchmarks are recalculated for each metric and each child's percentile is calculated for each metric for each day. These benchmarks and child's percentile are posted to database for each metric.

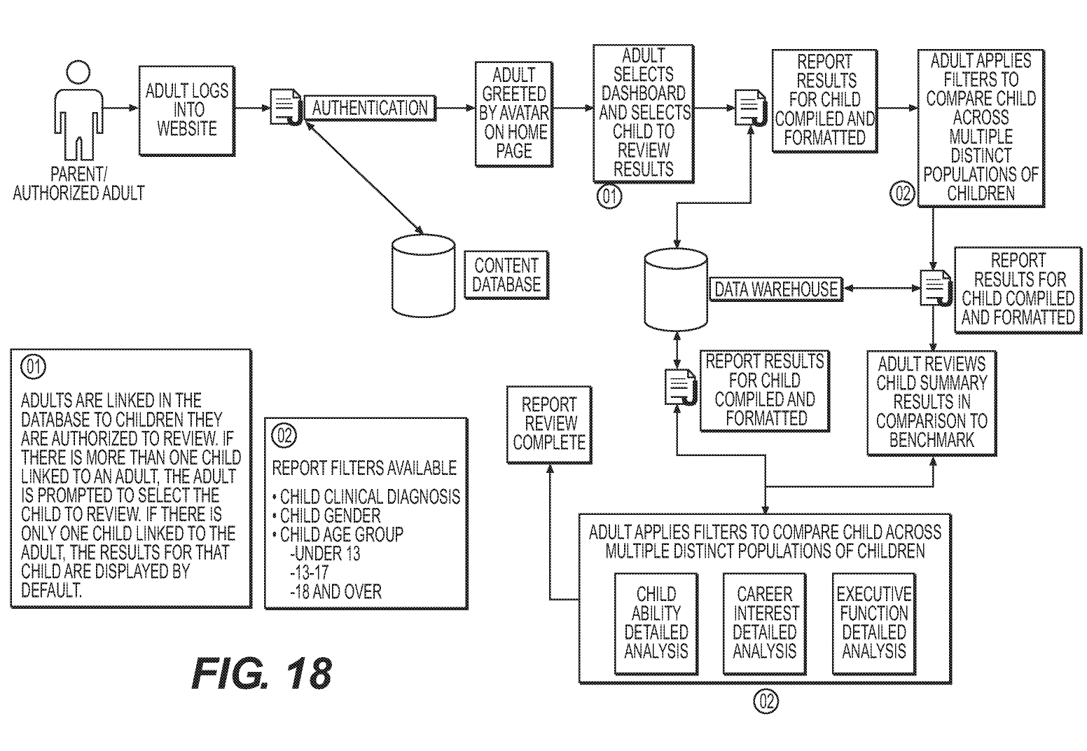

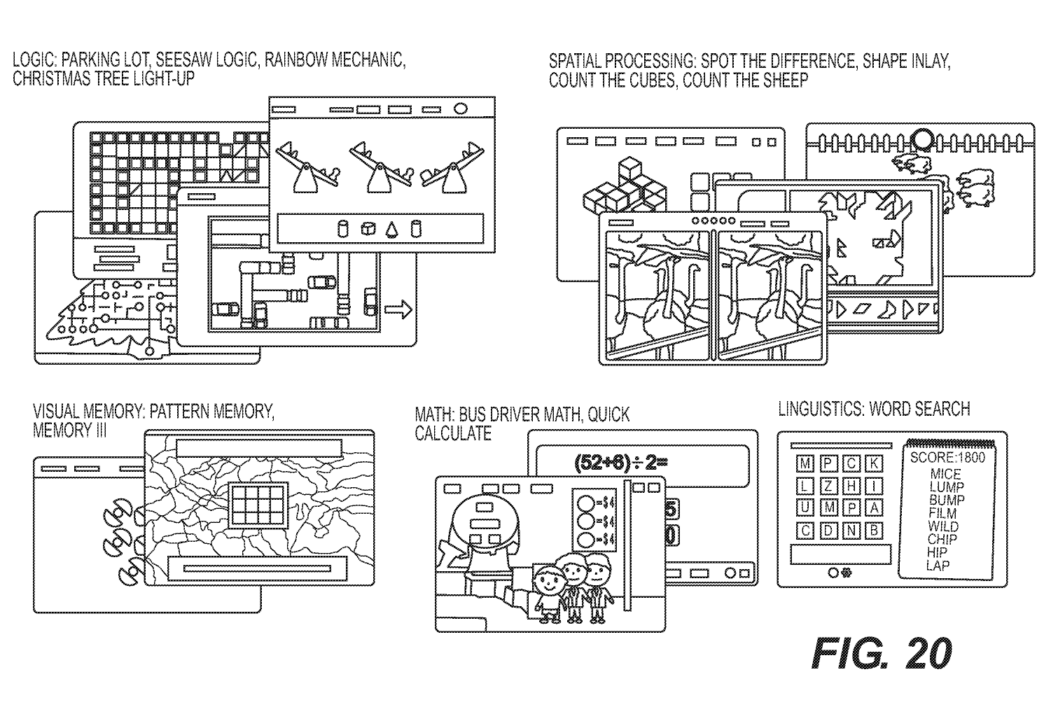

FIG. 18 is a flow diagram illustrating a review process for player's performance by authorized individuals to identify personal characteristics according to an embodiment. As shown in FIG. 20, parent and authorized adults may return to the dashboard page to review player's performance. The adult users who want to review player's performance can first log into a website or mobile application, and then they can be authorized for the performance review. Once the adult users are authorized, a human avatar greets the adult users on the home page. To review player's performance, the adult users can select dashboard and select a child to review the results. The adult users can be linked in the database to each associated children whom they are authorized to review. If there is more than one children linked to an adult, the adult can be prompted to select the children to review. If there is only one child linked to the adult, the results for that child are displayed by default.

Upon selecting the child, result report for the child is compiled and formatted. The adult may apply filter to compare the child across multiple district population of children. Available report filters can be:

Child Clinical Diagnosis□

Child Gender□

Child Age Group—Under 13/between 13 and 17/18 and Over

After the filters are applied, result reports for the child may be compiled and formatted again. The adult may review summary results of the child in comparison to benchmark. In an embodiment, the adult can apply filters to compare the child across multiple distinct populations of children. The result reports may include a child ability analysis, a career interest analysis, and an executive function analysis.

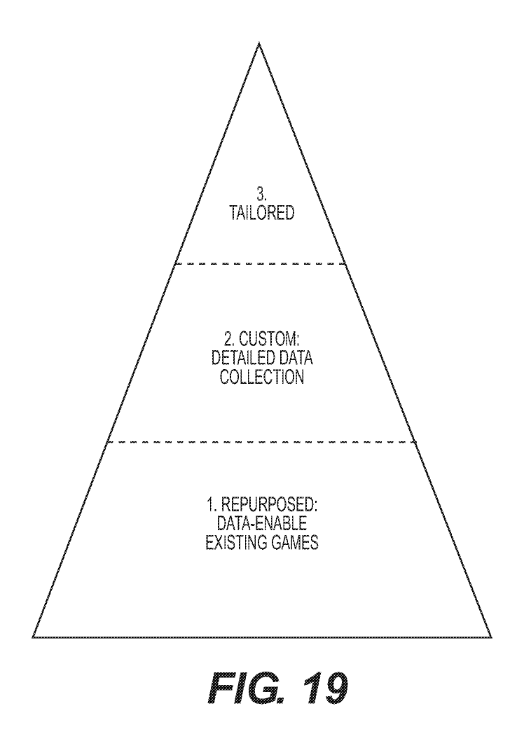

FIG. 19 illustrates types of games that can be used to identify personal characteristics according to an embodiment. Three types of games can be designed to assess the individual's abilities, skills and interests: repurposed, custom, and tailored. The repurposed game can be a game that is modified existing games to enable data collection. It can be applicable for selected ability areas such as math, logic, and spatial. The custom games can be a game that is developed to capture more data or to explore some areas not possible with current games. The tailored game can be a game that is developed as a new game to assess currently unassessed or under-assessed skill areas.

FIG. 20 illustrates examples of repurposed games according to an embodiment. As shown in FIG. 20, the repurposed games may assess abilities such as logic, spatial processing, visual memory, math, and linguistics. The repurposed games for logic may include: Parking Lot, Seesaw Logic, Rainbow Mechanic, and Christmas Tree Light-up. The repurposed games for spatial processing may include: Spot the Difference, Share Inlay, Count the Cubes, and Count the Sheep. The repurposed games for visual memory may include: Pattern Memory, and Memory III. The repurposed games for math may include: Bus Driver Math, and Quick Calculate. The repurposed games for linguistics may include a Word Search. Each repurpose game may also assess a number of Executive Functions, for example, focus, engagement, initiation and stop, memory manipulation, prioritization, time sensitivity, etc.

The game data for The Parking Lot collected and passed to the API when a level ends may include:

Date/time stamp

Level

Successful (yes or no)

score

amount of time available

amount of time used

percent of available time used

no of cars in lot

theoretical minimum no of moves

no of moves taken

no of times the game is extended

The game data for Rainbow Mechanic collected and passed to the API when a level ends may include:

Date/time stamp

Level

Successful (yes or no)

score

amount of time available

amount of time used

percent of available time used

no of mirrors used

theoretical minimum mirrors needed

whether hint mode is used (yes or no)

The game data for Word Grid collected and passed to the API when a level ends may include:

Date/time stamp

Level

Successful (yes or no)

score

amount of time available

amount of time used

percent of available time used

no of possible words

no of words correct

no of words missed

no of times the hint was used

The game data for Sequence Master collected and passed to the API when a

level ends may include:

Date/time stamp

Level

Successful (yes or no)

score

amount of time available

amount of time used

percent of available time used

no of squares on grid

was incorrect click on a number or an empty space (yes or no)

high number in sequence to be remembered

no of times the game is extended

The game data for Easter Egg Hunt collected and passed to the API when a level ends may include:

Date/time stamp

Level

Successful (yes or no)

score

amount of time available

amount of time used

percent of available time used

no of hidden eggs

no of eggs found

no of wrong clicks

no of times the hint is used

no of times the game is extended

The game data for Pattern Memory II collected and passed to the API when a level ends may include:

Date/time stamp

Level

Successful (yes or no)

score

amount of time available

amount of time used

percent of available time used

total no of blocks in the grid

no of colours used

no of incorrect clicks

was incorrect click on incorrect color or blank square (yes or no)

no of times the game is extended

The game data for Count the Sheep collected and passed to the API when a

level ends may include:

Date/time stamp

Level

Successful (yes or no)

score

amount of time available to view moving sheep

amount of time used to answer

no of sheep

no of wolves

answer provided

no of times the game is extended

The game data for Bus Driver's Math collected and passed to the API when a level ends may include:

Date/time stamp

Level

Successful (yes or no)

score

no of correct answers

no of wrong answers

no of children in level

no of adults in level

no of elderly in level

no of problems shown in level

The game data for Spot the Difference II collected and passed to the API when a level ends may include:

Date/time stamp

Level

Successful (yes or no)

score

amount of time available

amount of time used

% of available time used

image name

no of correct answers

no of wrong clicks

no of hints used

no of times the game is extended

The game data for Number Twins collected and passed to the API when a level ends may include:

Date/time stamp

Level

Successful (yes or no)

score

amount of time used

no of incorrect matches

max no of spaces between matched numbers

no of times the game is extended

The game data for Math Lines collected and passed to the API when a level ends may include:

Date/time stamp

Level

Successful (yes or no)

score

amount of time used

total no of balls appeared

no of balls fired

no of times the ball is fired to complete a match

no of times the ball is fired next to a same numbered ball

no of balls left uncleared

no of times the game is extended

The game data for More of Less collected and passed to the API when a level ends may include:

Date/time stamp

Level

Successful (yes or no)

score

amount of time used

no of squares in matrix

operator used (more or less)

no of wrong answers

The game data for Double Bubble collected and passed to the API when a level ends may include:

Date/time stamp

Level

Successful (yes or no)

score

amount of time available

amount of time used

percent of available time used

no of unique items shown

no of duplicated items shown

no of non clicked duplicated items

no of correct clicks

no of incorrect clicks

no of times the game is extended

The game data for Scene Memory collected and passed to the API when a level ends may include:

Date/time stamp

Level

Successful (yes or no)

score

amount of time available to view image

amount of time used to answer

no of items in level

no of changed items

no of correct items found

no of times the game is extended

The game data for Find the Suspect collected and passed to the API when a level ends may include:

Date/time stamp

Level

Successful (yes or no)

score

amount of time available

amount of time used

no of suspects shown

image chosen

correct image

no of times the game is extended

The game data for Find the Pair collected and passed to the API when a level ends may include:

Date/time stamp

Level

Successful (yes or no)

score

amount of time available

amount of time used

correct shape

total no of shapes shown

no of mistakes

The game data for Shape Inlay collected and passed to the API when a level ends may include:

Date/time stamp

Level

Successful (yes or no)

score

amount of time used

no of shapes shown

no of shapes used

no of shapes discarded

no of shapes untouched

no of rotations

no of times the game is extended

The game data for Quick Calculate collected and passed to the API when a level ends may include:

Date/time stamp

Level

Successful (yes or no)

score

amount of time used

question

correct answer

no of incorrect answers

The game data for Count the Cubes collected and passed to the API when a level ends may include:

Date/time stamp

Level

Successful (yes or no)

score

amount of time used

total no of cubes

no of visible cubes

no of hidden cubes

no of wrong answers

no of times the hint button is clicked

The game data for Seesaw Logic collected and passed to the API when a level ends may include:

Date/time stamp

Level

Successful (yes or no)

score

amount of time used

no of seesaws

no of weights in problem

no of incorrect answers

The game data for Spot the Difference collected and passed to the API when a level ends may include:

Date/time stamp

Level

Successful (yes or no)

score

amount of time used

no of faces shown

no of differences to find

no of wrong clicks

no of hints used

no of times the game is extended

The game data for Memory III collected and passed to the API when a level ends may include:

Date/time stamp

Level

Successful (yes or no)

score

amount of time used

no of pairs shown

total no of clicks

The game data for Moving Memory collected and passed to the API when a level ends may include:

Date/time stamp

Level

Successful (yes or no)

score

amount of time used

matrix size

no of rotations

total no of clicks

The game data for Christmas Tree Light Up collected and passed to the API when a level ends may include:

Date/time stamp

Level

Successful (yes or no)

score

amount of time used

no of hints used

no of bulbs

total no of clicks

theoretical minimum no of clicks to complete

no of resets

The game data for Math Search collected and passed to the API when a level ends may include:

Date/time stamp

Level

Successful (yes or no)

score

amount of time used

equation

no of wrong answers

no of times the game is extended

The game data for Memory collected and passed to the API when a level ends may include:

Date/time stamp

Level

Successful (yes or no)

score

amount of time used

total no of clicks

The game data for Tower of Hanoi II collected and passed to the API when a level ends may include:

Date/time stamp

Level

Successful (yes or no)

score

amount of time used

total no of moves

theoretical minimum no of moves

no of times the game is extended

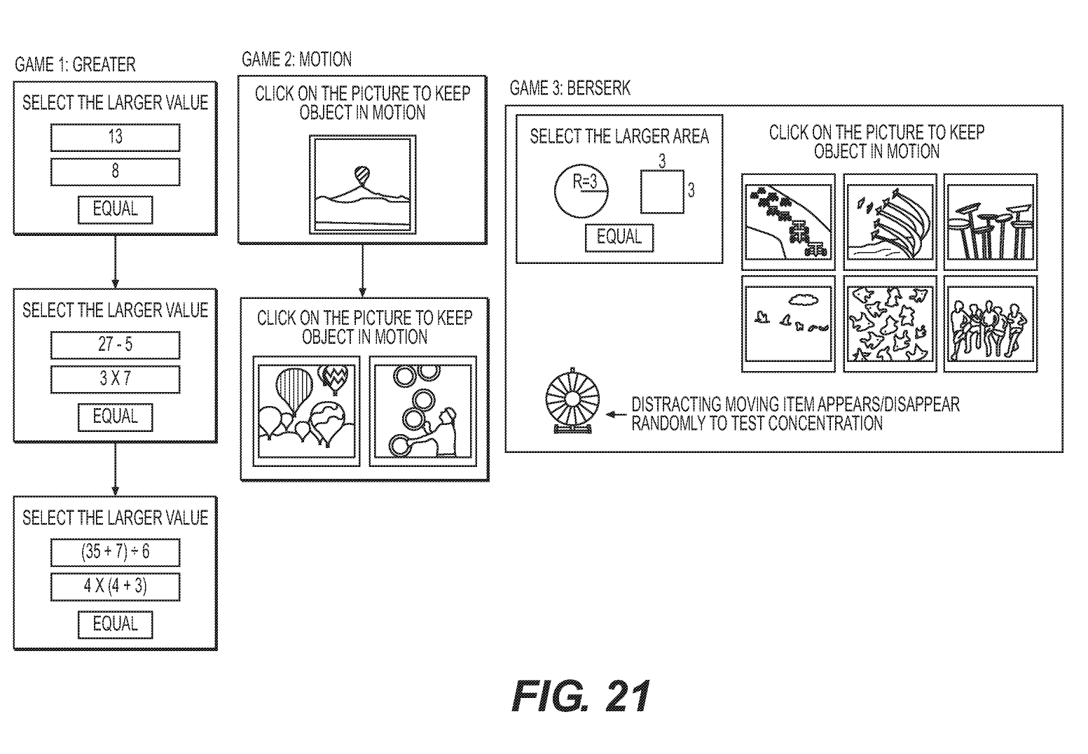

FIG. 21 illustrates examples of custom games to collect detailed data according to an embodiment. The game 1 Greater may operate by showing two “cards”, each displaying a number or an equation. The numbers can be adaptively presented and its difficulty can be increased up to high school geometry. The player is asked to select which card is the greater value (or click on an “Equal” button if they are equal). The game displays increasingly difficult problems through [20] levels. A few parameters:
Player can complete 3 problems in a level to proceed to the next
A player has up to 1 minute to solve problems in levels 1-10 and 2 minutes for levels 11-20
Game may end when player has answered 5 incorrect questions
   The system may need to randomly select a multitude of parameters to display the two cards, including:
Type of problem to display on each card (e.g., addition, area of an object, algebraic equation, etc.)
The numeric values used in the problem
The mathematic operator to be used in some of the problem types (e.g., parenthetical problems)

There are 11 problem types:
Addition
Subtraction
Multiplication
Division
Exponents
Circumference of squares, rectangles, circles
Circumference of triangles
Area of squares, rectangles, circles
Area of triangles
Volume
Parenthetical equations where each parenthesis could contain any of the problem categories above—e.g., (342−125)×(5³−3²)

When the game is initiated, a “Level 0” is presented before score begins to be calculated to give the player a feel for the game. After completion, the game begins on Level 1. Upon completing 3 correct answers, system may display, “Congratulations on completing Level 1. Moving to Level 2.” After completing Level 10, system can display “Congratulations on completing Level 10. Would you like to stop or continue on”? “Stop” and “Continue on” buttons can be displayed. If the player decides to continue on, system reset the “wrong problems” counter to zero and start counting wrong problems again. At the end of the game or when the player chooses to end the game, display “Congratulations!” and show the player's core in this game relative to the last 5 scores he/she had.

Points can be earned the following ways:
Correct answer: Each time a problem is answered correctly, point are awarded based on two components:
   The level number is multiplied by 10 and that value is given to the player as “correct answer points” (e.g., correct answers in Level 1 yields 10 points. Correct answers in Level 20 yield 200 points).
   A point is award for each second remaining as “time bonus points.”
Level bonus: Each time a level is finished the number of that level is multiplied by 100 and those points are given (100 points are awarded upon completion of Level 1; 2,000 points for completing Level 20)
Consecutive correct answers bonus:
   Answering 5 correct problems in a row results in 5× the points awarded for the last correct answer (e.g., if the last correct answer in the sequence of 5 earned 100 points, the 5-series bonus is 500)
   Answering 10× correct problems in a row results in 10× the points awarded for the last correct answer
      Points can be deducted for answering incorrectly. Points equaling 5× the level number can be deducted for each incorrect response.

The following elements of Greater are captured and passed back to the API:

Date/time stamp

Level

Successful (Yes/No)?

Score

Amount of time available

Amount of time used

% of available time used

Problem type correctly answered most frequently from start of this game

Problem type incorrectly answered most frequently from start of this game

The following items can be dumped to file outside of the API for each question posed to the player:

UserID

Date/time stamp

Level

Problem type

Problem posed

Answer given

Correct answer (Yes/No)?

Amount of time available

Amount of time used

The game 2 Motion in FIG. 21 may operate by showing pictures. The pictures can be adaptively presented and its difficulty can be increased up to 15 simultaneous frames to assess multitasking. The number of objects in each frame can be varied to assess logical reasoning and prioritization. The game 3 Berserk can combine Great and Motion into one simultaneous game. The cards and pictures can be adaptively presented.

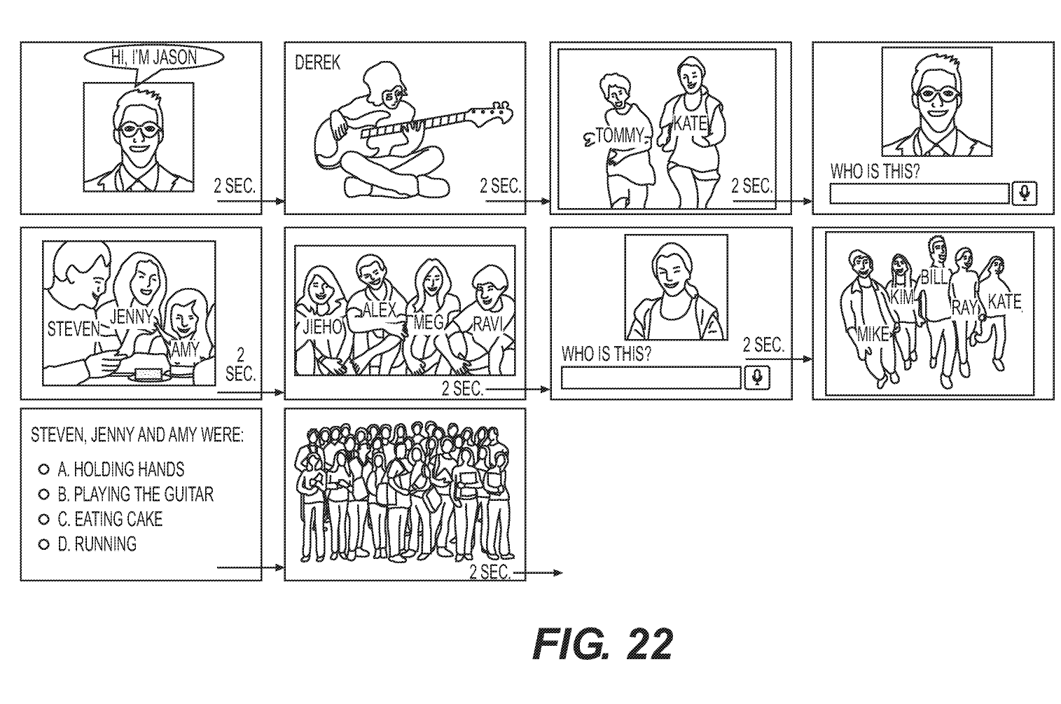

FIG. 22 illustrates an example flow of a custom game to collect detailed data using face recognition according to an embodiment. The game Faces can continue to adaptively present increasingly complex pictures of people engaged in various activities and asking questions. The questions asked can include:

What is the color of Derek's guitar?

How many faces were in the last picture?

How many people were holding folder?

How many yellow folders were held by the people?

When the Faces is initiated, at level 0, the player is presented with a 1-person picture. The individual can have 5 seconds to look at the picture and the name of the person in the picture. The three elements to focus on are: (1) the person's name; (2) what they are doing in the picture; and (3) questionable aspects such as color or pattern of clothing, what the person in the picture is holding, environment around the person, etc. After the picture is shown for the designated time, a picture adjusted to the individual's face can appear. At this point, the player can be asked either one of the following questions randomly selected by the system:

What is the name of the individual in the picture shown? Sophia

What is Sophia doing? Playing tennis

What is Sophia holding? A tennis racquet

The system can give 4 choices for the player to select from.

Faces can work for a 4 person image. For example, a picture having four person can be displayed for a designated amount of time with the names “Marilyn, Jayden, Andy, Aubrie” listed respectively. The questions asked can include:

What is the color of Marilyn's shoes? Red

What is Jayden holding? A clipboard

What is the color of Andy's folder? Purple

What is her name? Aubrie

At level 1, for one picture before quiz, the player can be presented with a picture randomly selected from among the 1-face images for 5 seconds. The system then quizzes the player by displaying a randomly select question about the picture just shown. If the player gets the answer wrong, they will be shown the correct answer with the full picture of the individual. The system then repeats step 1. If the player gets the answer correct, proceed to step 2.

For two pictures before quiz, the player can be shown a new image with 1 face for 5 seconds. The player can be shown another new image with 1 face for 5 seconds. The system quizzes the player randomly selecting one of the 3 possible quiz questions for the select image. If the player gets the answer wrong, repeat these two pictures before quiz step. If the player gets the answer correct, continue to next step.

The game can become increasingly difficult by showing three pictures before quiz and then four pictures before quiz. Once the player answers a question after 4 pictures, they will move up a level.

Level 2 and beyond can work the same way as Level 1, but the system can randomly select from images with 2 or more faces.

Levels:

Level 1: 1 face

Level 2: 2 faces

Level 3: 3 faces

Level 4: 4 faces

Level 5: 5 faces

Level 6: 6 faces

Level 7: 7 faces

Level 8: 8 or more faces

When quizzing the player, the system can select from any face shown up to that point. That is, even though the player may be in Level 3 (3-face images), the system can still select from a face shown during Level 1.

The player can be given points if they answer any of the following 3 questions correctly: (1) Name of the individual(s); (2) Their activity; and (3) Answer to the unique questions. The player can earn 100 points for 1-face images, 200 points for 2-face images, and 300 for 3-faces, etc. The points are not taken away for wrong answers. The Faces game ends upon player getting 20 correct answers or 5 incorrect answers.

At the end of each level, the system can use the API to record the following data elements:
Date/time stamp
Level
Score
# name questions presented
# name questions answered correctly
# activity questions presented
# activity questions answered correctly
# unique questions presented
# unique questions answered correctly
Maximum number of intervening images for a correct answer (i.e., how far back can the player remember a face)

At the end of each level, the system can also use the API to record the following data elements:

Date/time stamp

Level

Successful (Yes/No)?

Score

# Correct names

# Correct male names

# Correct male names

% Correct names

% Correct male names

% Correct male names

# correct activities

% correct activities

Max # of people in image where player answered name correctly

# of correct answers where there's 1 person in the image

# of correct answers where there's 2 people in the image

# of correct answers where there's 3 people in the image

# of correct answers where there's 4 people in the image

# of correct answers where there's 5 people in the image

# of correct answers where there's 6 people in the image

# of correct answers where there's 7 people in the image

# of correct answers where there's 8 or more people in the image

% of correct answers where there's 1 person in the image

% of correct answers where there's 2 people in the image

% of correct answers where there's 3 people in the image

% of correct answers where there's 4 people in the image

% of correct answers where there's 5 people in the image

% of correct answers where there's 6 people in the image

% of correct answers where there's 7 people in the image

% of correct answers where there's 8 or more people in the image

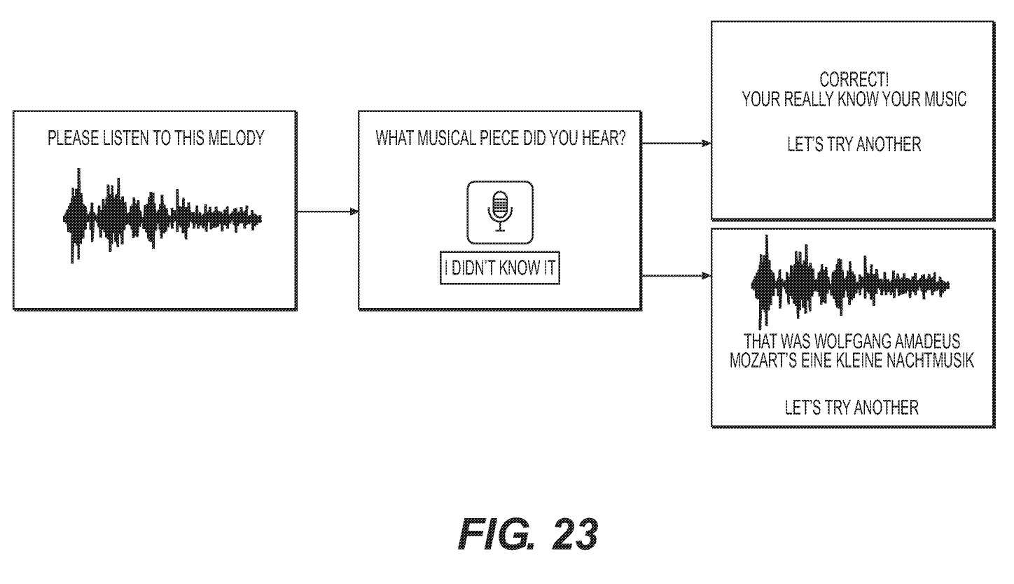

FIG. 23 illustrates an example flow of a custom game to collect detailed data using melody recognition according to an embodiment. The game Melodies can test musical memory, not whether someone already knows a melody. As such, the real value from the game can come from understanding what happens after a player gets a melody wrong. Whether he/she is able to remember the name of the melody when we serve it up again. The fact that a player already knows a piece is helpful in increasing his score, but the real value of the game is its tracking of correct answers the first time it is played vs. when played the second or third or fourth time.

At level 0 practice round, on one screen, the system can displays a nice background, play a clip, and ask the player to choose from 4 possible options—3 of which are names musical pieces and the 5^{th} choice is “I don't know; never heard this before.”

The system can play a clip randomly selected from among all possible pieces from our collection as well as from the “Previously Incorrect” list. The system randomly select only from the previously un-played collection for the first 4 clips. Thereafter, the system has 50% probability of choosing from un-played and 50% probability of choosing from “Previously incorrect” list. Once the player has correctly answered for a clip, that clip is not presented again.

The system can ask the player to choose from 4 possible options. If player provides the correct answer, the system notes the piece has been answered correctly, increase the # correct answers count by 1, increase the score and proceed to Step 1 again. If the player provides the wrong answer or does not know, the system: (1) plays the piece again with the correct name for the piece; (2) increases the “# wrong” counter for this piece by 1 and put piece in “Previously incorrect” queue of musical pieces to be chosen from again; (3) increases the # wrong for the game by 1; and (4) proceeds to Step 1 again.

As this game really doesn't have levels, it continues until the player reaches 10 incorrect answers or 20 correct answers. If the game ends by reaching the 10 incorrect answers constraint, the system displays “Game over. Would you like to try again?” If the game ends by reaching to 20 correct answers constrain, the system displays “Congratulations on getting 20 correct answers—you have great musical memory. Would you like to continue?” The system writes the data using the API. If player wants to continue, the system restarts the correct/incorrect counters and continue on until player reaches the next 10 incorrect/20 correct constrain.

At the end of the game or each “round”, the system can write the following to the database via the API:
Date/time stamp
Score
# pieces answered correctly the first time (i.e., player already knew the piece)
% of pieces answered correct on the 1^{st} presentation
# pieces answered correct on the 2^{nd} presentation
% of pieces answered correct on the 2^{nd} presentation
# pieces answered correct on the 3^{rd} or subsequent presentation (i.e., player learned the piece)
% of pieces answered correct on the 3^{rd} presentation
# pieces answered incorrectly despite multiple presentations

In addition, the system may keep track of the individual names/IDs for the pieces that player already knew, learned, and never learned. For every clip presented, the system can write to a file the a record that has the following items:
UserID
Date/time stamp
Music clip name/ID
Answer player provided
Whether player correctly answered (Yes/No)
If player answered correctly, how many presentations did it take for player to get correct (1^{st} time, 2^{nd}, 3^{rd}, etc.)

At the end of the game or each “round”, the system can also write the following to the database via the API:

Date/time stamp

Level

Successful (Yes/No)?

Score

# of melodies answered correct on 1^{st} hearing (i.e., already know the tune)

# of melodies answered correct on 2^{nd} hearing

# of melodies answered correct on 3^{rd} hearing

# of melodies answered correct on 4^{th} hearing

% of melodies answered correct on 1^{st} hearing (i.e., already know the tune)

% of melodies answered correct on 2^{nd} hearing

% of melodies answered correct on 3^{rd} hearing

% of melodies answered correct on 4^{th} hearing

% classical clips answered correctly

% jazz clips answered correctly

% pop music clip answered correctly

% classic rock clips answered correctly

% country clips answered correctly

% children clips answered correctly

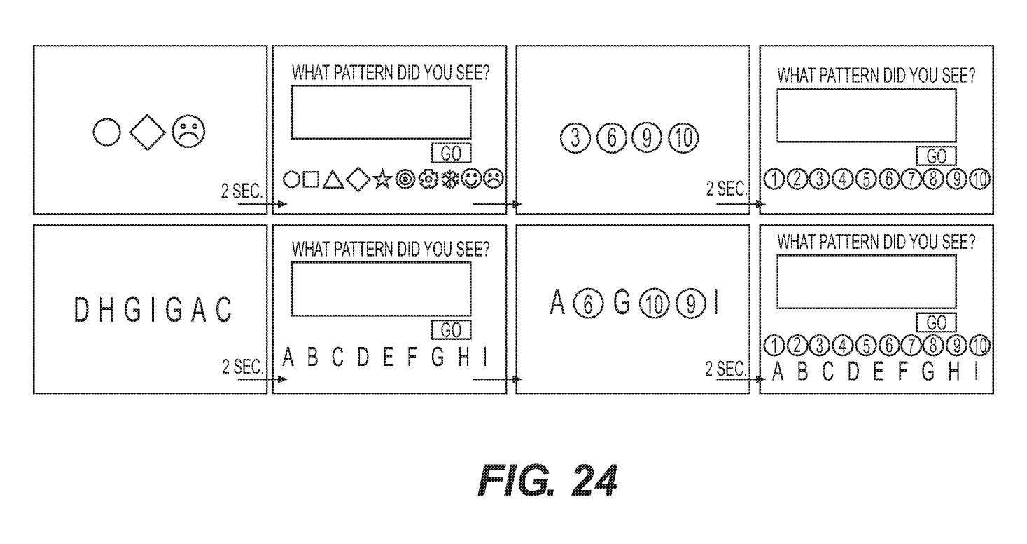

FIG. 24 illustrates an example flow of a custom game to collect detailed data using pattern recognition according to an embodiment. As illustrated in FIG. 24, the game Patterns can continue to adaptively present increasingly complex patterns, mixing from the shapes, numbers, and letters palettes.

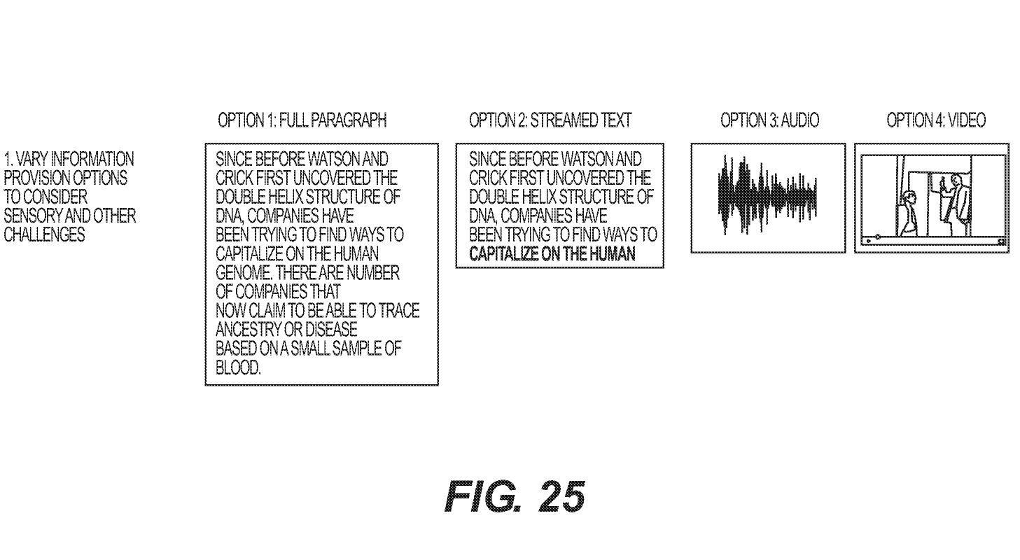

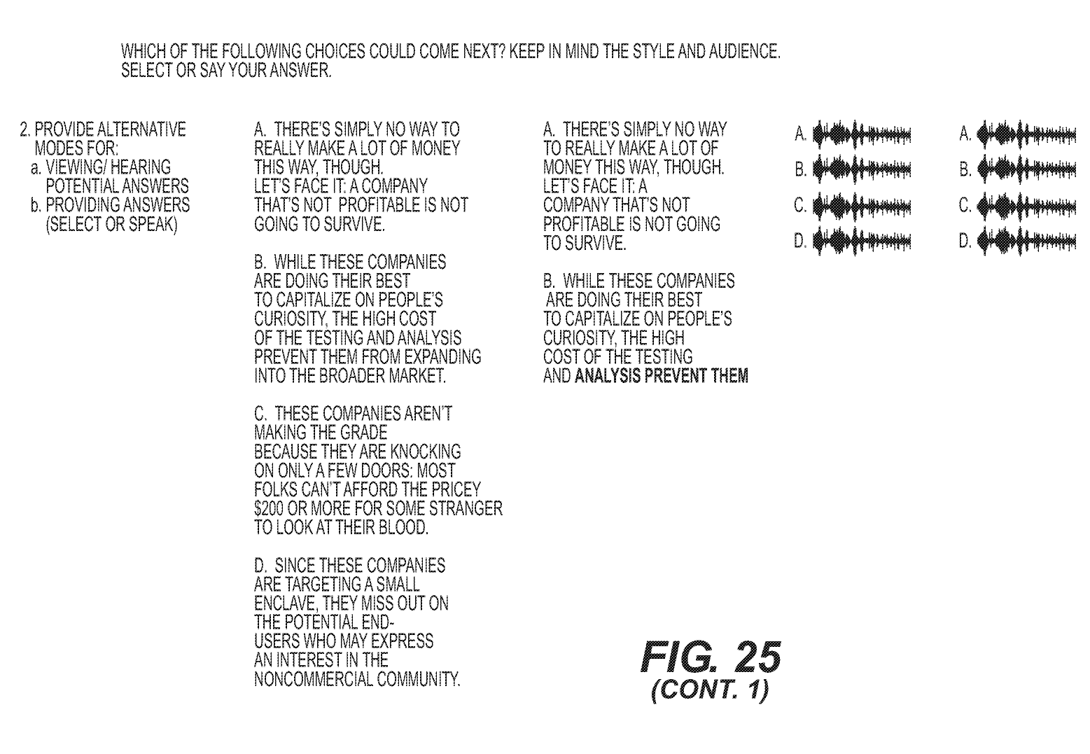

FIG. 25 illustrates an example of a custom game to collect detailed data with different comprehension mode according to an embodiment. Most autistic students do poorly on reading comprehension test, yet source of failure is unclear. The possible cause of failure can be that: (1) they cannot receive information due to sensory overload from a paragraph of text; (2) they cannot comprehend information received; or (3) they cannot provide answer due to motor challenges. As described in FIG. 25, offering different comprehension mode can isolate factors that can interfere with comprehension to the autistic students. For example, adaptive, random presentation of different presentation options over a battery of questions can isolate respondent's preferred interaction mode.

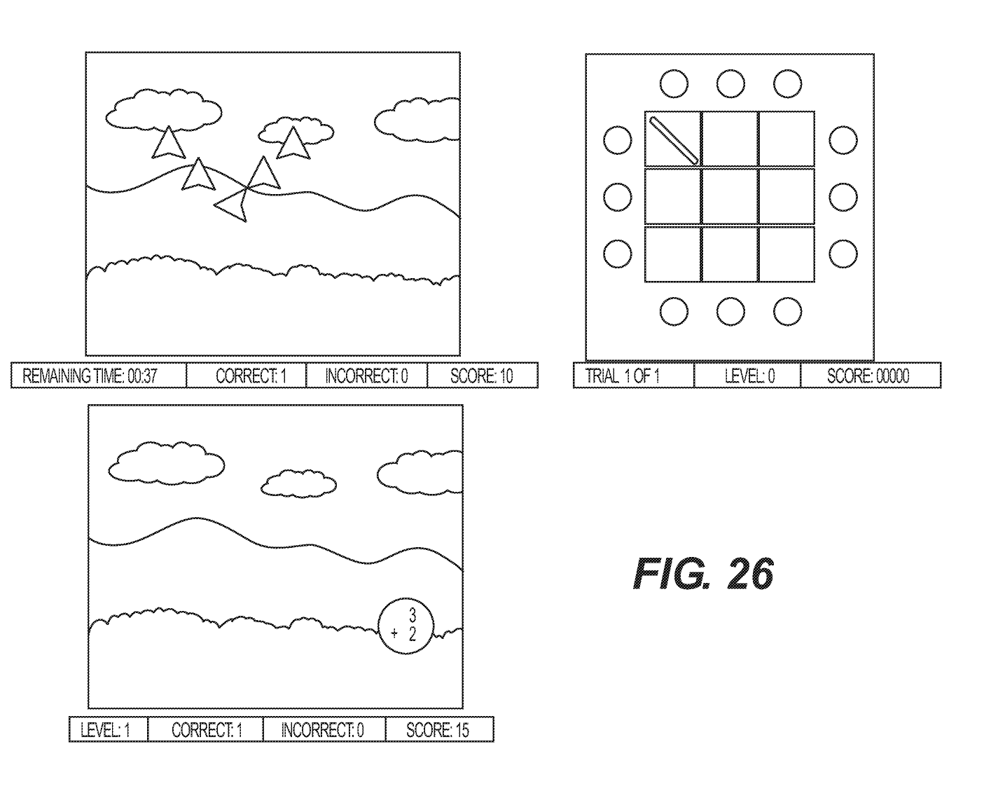

FIG. 26 illustrates examples of custom games (Arrows, Math Bubbles, and Bumpers) to collect detailed data according to an embodiment. The game Arrows can primarily measure focus whether the player is able to focus despite distractions. At the end of the game or each “round”, the system can write the following to the database via the API:
Date/time stamp
Level
Successful (Yes/No)?
Score
# correct answers against the pack (i.e. when the bird of focus is flying in a different
direction as the rest of the pack)
# correct answers with the pack
% time correct when against the pack—this is perhaps the single most revealing metric of focus
% time correct when with the pack
Average speed to answer
Average speed to answer correctly—against the pack
Average speed to answer correctly—with the pack
Average speed to answer incorrectly—against the pack
Average speed to answer incorrectly—with the pack

The primary purpose of the game Bumpers is logical process (visual recall of the bumpers is secondary). At the end of the game or each “round”, the system can write the following to the database via the API:

Date/time stamp

Level

Successful (Yes/No)?

Score

Grid size (number of cells)

# correct tries

# incorrect tries

Max # paddles shown in a turn in the level

Max # paddles touched in a turn in the level

Shortest time taken to answer

Longest time taken to answer

Total # paddles touched for all the correct answers for all turns in the level

# times hint used

The game Math Bubbles can primarily measure logic-arithmetic. The arithmetic problems can be generated based on the following table:

| | Addition | Subtraction | Multiplication | Division |
|---|---|---|---|---|
| Level 1: | [0 . . . 5] + [0 . . . 5] | | | |
| Level 2: | [0 . . . 10] + [0 . . . 10] | [0 . . . 5] − [0 . . . 5] | | |
| Level 3: | [0 . . . 20] + [0 . . . 20] | [0 . . . 10] − [0 . . . 10] | | |
| Level 4: | [10 . . . 25] + [10 . . . 25] | [0 . . . 20] − [0 . . . 20] | [0 . . . 5] × [0 . . . 5] | [0 . . . 10]/[0 . . . 10] |
| Level 5: | [20 . . . 50] + [25 . . . 50] | [10 . . . 25] − [10 . . . 25] | [0 . . . 10] × [0 . . . 10] | [0 . . . 20]/[0 . . . 20] |
| Level 6: | [35 . . . 75] + [35 . . . 75] | [20 . . . 50] − [25 . . . 50] | [5 . . . 11] × [5 . . . 11] | [0 . . . 30]/[0 . . . 30] |
| Level 7: | [50 . . . 100] + [50 . . . 100] | [35 . . . 75] − [35 . . . 75] | [5 . . . 13] × [5 . . . 13] | [0 . . . 40]/[0 . . . 40] |
| Level 8: | [75 . . . 125] + [75 . . . 125] | [50 . . . 100] − [50 . . . 100] | [5 . . . 15] × [5 . . . 15] | [0 . . . 50]/[0 . . . 50] |
| Level 9: | [100 . . . 150] + [100 . . . 150] | [50 . . . 125] − [50 . . . 125] | [7 . . . 17] × [7 . . . 17] | [10 . . . 75]/[10 . . . 75] |
| Level 10: | [125 . . . 200] + [125 . . . 200] | [50 . . . 150] − [50 . . . 150] | [7 . . . 19] × [7 . . . 19] | [10 . . . 100]/[10 . . . 100] |
| Level 11: | [175 . . . 250] + [175 . . . 250] | [50 . . . 200] − [50 . . . 200] | [9 . . . 20] × [9 . . . 20] | [5 . . . 75]/[5 . . . 75] |
| Level 12: | [225 . . . 275] + [225 . . . 275] | [50 . . . 250] − [50 . . . 250] | [10 . . . 21] × [10 . . . 21] | [5 . . . 100]/[5 . . . 100] |
| Level 13: | [275 . . . 350] + [275 . . . 350] | [50 . . . 300] − [50 . . . 300] | [10 . . . 22] × [10 . . . 22] | [5 . . . 125]/[5 . . . 125] |
| Level 14: | [350 . . . 425] + [350 . . . 425] | [50 . . . 400] − [50 . . . 400] | [10 . . . 23] × [10 . . . 23] | [5 . . . 150]/[5 . . . 150] |
| Level 15: | [425 . . . 500] + [425 . . . 500] | [50 . . . 500] − [50 . . . 500] | [10 . . . 25] × [10 . . . 25] | [0 . . . 200]/[0 . . . 200] |

The greater number generated is always first in the presented equation. For division the greater random generated number is the numerator and the lesser is the denominator. The answer to all questions can be a whole number.

The player starts at level one. To proceed to the next level, the player may accurately answer five questions in a row. If a question is answered incorrectly, the level is started over. The operation of the question is randomly selected from the available options for that level. Then the two numbers are randomly generated as per the ranges listed above. Once the maximum level is finished regardless of future failures, the player can receive Level 15 difficulty questions until they fail or decide to quit. For every 50 questions answered correctly, the player is presented with a screen saying “Congrats! You have answered 50 questions correctly! You can choose to quit now with your current score or can opt to continue and answer another 50 questions from where you left off” The player can here click whether they wish to continue or stop.

In Math Bubbles, there are four aspects to scoring: (1) Difficulty of Problem; (2) Velocity of Bubbles; (3) Density of Bubbles on screen; and (4) Time taken to answer. The difficulty score of the problem is the level of the problem×10. For example, answering a level 6 question correctly is worth 60 points.

There are three possible velocities of the bubbles: 1× speed, 1.5× speed, and 2× speed. The speed multiplier is multiplied with the difficulty score of the problem. If the level 6 questions were answered correctly on 1.5× speed, answering the question is now worth 1.5×60 or 90 points. The slow bubble can take 12 seconds to reach the bottom of the screen. The medium speed bubbles can take 8 seconds to reach the bottom of the screen, and the fast bubbles can take 6 seconds to reach the bottom of the screen

The density of the bubbles is decided by how much time is allowed between bubble releases. The base release rate (slow) is one per 12 seconds with a 1× multiplier. The medium release rate is one per 9 seconds with a 6× multiplier. The fast release rate is one per 4.5 seconds with a 2× multiplier. If the bubble from before released at medium speed on level 6 is released after 6 seconds (1.5× multiplier) the score is then 90×1.5=135.

The time taken to answer is the last factor in scoring. If the bubble is correctly answered in the top ⅓ of the screen a 2× multiplier is applied. If the bubble is answered in the middle ⅓ of the screen a 1.5× multiplier is awarded. If the bubble is answered in the last ⅓ of the screen a 1× multiplier is awarded. This is multiplied at the end to the existing score. If using the same bubble as before is answered in the middle ⅓ of the screen, then the final score is 135×1.5=202.5 which will be rounded up to the nearest whole number, in this case 203.

The equation for score is:

(Level of Problem×10)×(VelocityMultiplier)×(RateMultiplier)×(TimeToAnswerMultiplier)

The starting velocity is 1× speed and the starting release rate is one per 8 seconds. For every 15 problems answered correctly both velocity and release rate are increased one stage until the 3 level (fast) is released. If a player answers a problem incorrectly, the level of speed and velocity are moved down one level. For example, if a player has answered 32 questions correctly in a row (and is thus on a 2× multiplier for both speed and rate of release) and the 33^{rd} question is answered incorrectly, the velocity and rate of release are moved down to 1.5× until 15 questions are answered correctly in a row again.

At the end of the game or each “round”, the system can write the following to the database via the API:

Date/time stamp

Level

Successful (Yes/No)?

Score

# problems solved correctly

# addition problems solved correctly

# subtraction problems solved correctly

# multiplication problems solved correctly

# division problems solved correctly

# problems missed/incorrect

Value of largest “top number”—the first number presented in the equation

Value of largest “bottom number”—the second number presented in the equation

Value of largest “answer”

Max number of problems on the screen at one time.

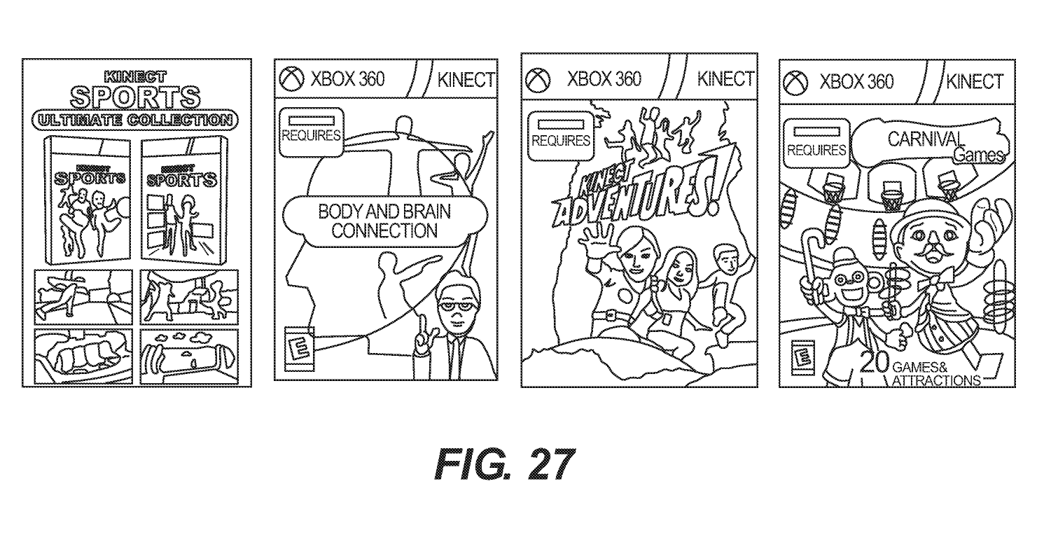

FIG. 27 illustrates examples of tailored games to assess ability area according to an embodiment. These tailored games can assess difficult ability areas such as bodily-kinesthetic. This type of games can be created from existing Xbox games using Kinect's camera to assess bodily movement abilities.

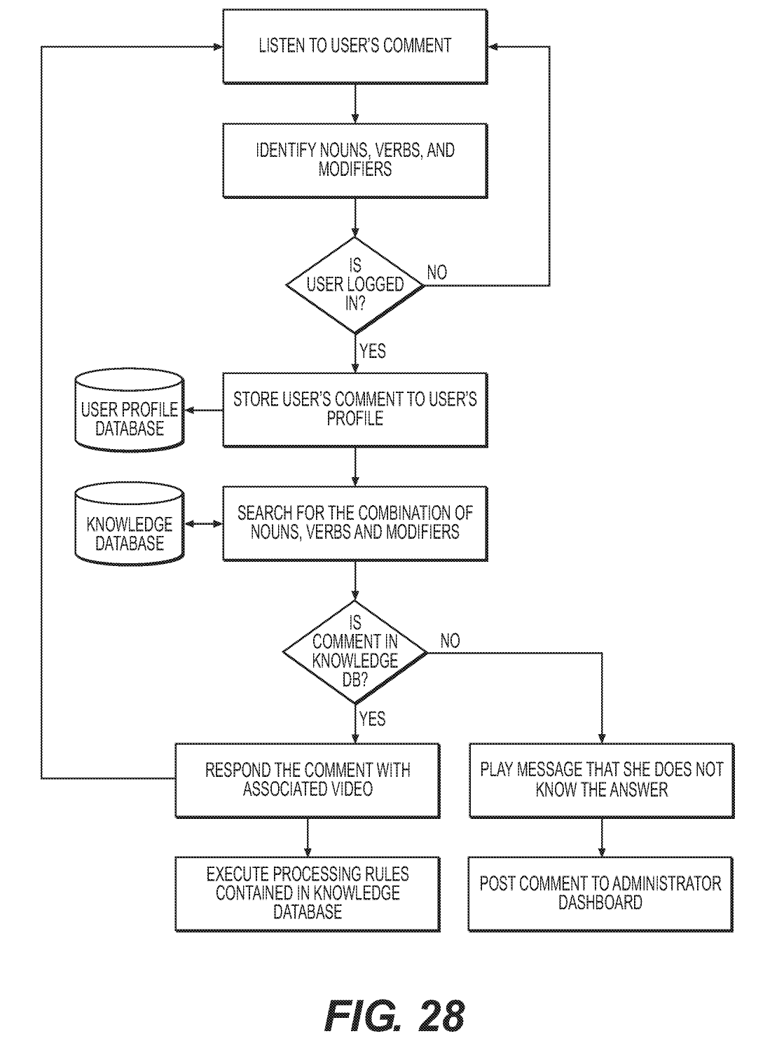

FIG. 28 is an example process for providing functions of life coaching based on an intelligent virtual assistant platform according to an embodiment. As described above, a human avatar can listen to users' comments, questions, or statements. The users can bring any kinds of comments that they can face in the course of a day. For example, a user may ask the human avatar that “my boss asked me something that I do not agree with. How should I respond?” Once the user's comment is received at a server implementing the artificial intelligence engine, the comments can be parsed to nouns, verbs, and modifiers to infer the intention of the statement. If the user is logged in, the user's comment is stored in a user profile database. After posting the comment, the combination of nouns, verbs, and modifiers can be searched in a Q&A knowledge database. If the question is found in the Q&A knowledge database, the human avatar can generate answer by playing the associated video. After that, the human avatar can keep monitoring for follow-up comments and execute additional processing rules contained in the knowledge database. If the question is not found in the Q&A knowledge database, the human avatar can play message stating that she does not know the answer to the question posed. After that, the artificial intelligence platform can post the question to administrator dashboard for follow-up actions.

The human avatar based on the intelligent virtual assistant platform can educate, monitor, and remind the users across any device or medium. The intelligent virtual assistant platform can leverage data from any source to enhance its coaching ability. For example, a user may have a wearable device that tracks sleep and steps. The intelligent virtual assistant can pull this data into the system to evaluate patterns and cross-reference it with the protocols. The intelligent virtual assistant can also monitor other actions that the user has taken in order to make recommendations for the user. The intelligent virtual assistant platform can combine natural language understanding, artificial intelligence, machine learning, customizable knowledge-base, customer data, customer interactions, workflow such as rules and process, or the like.

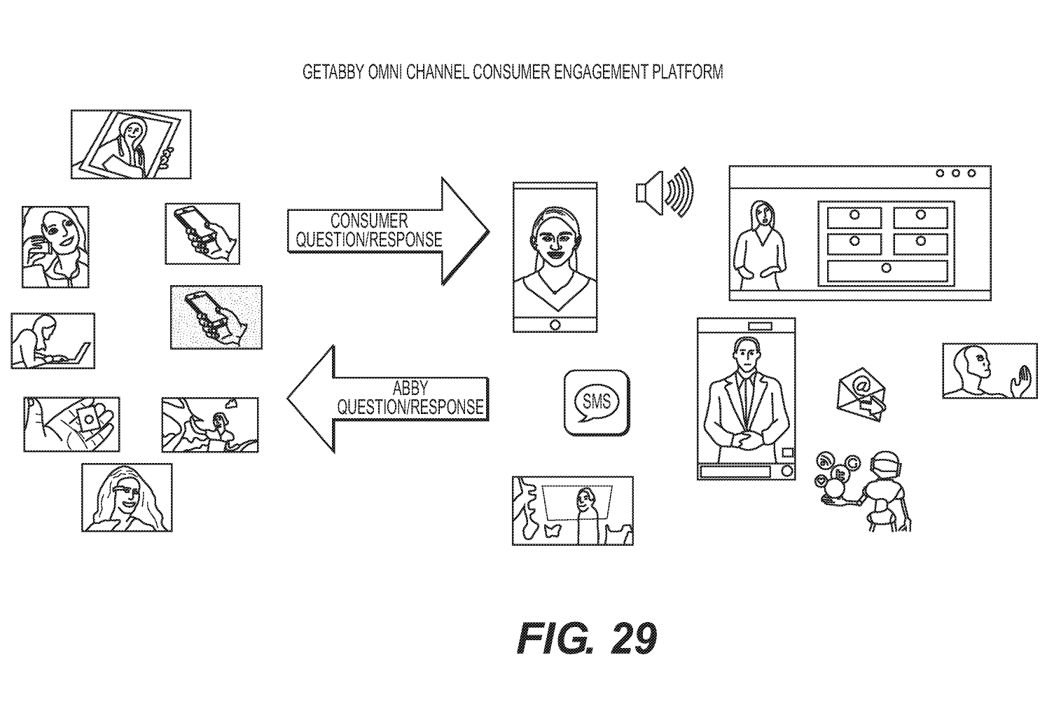

FIG. 29 illustrates a high level user interaction with an intelligent virtual assistant (Abby) at various forms according to an embodiment. A user can engage Abby across any device or medium. The device or medium can include a web, phones (IVR), mobile devices, tablet PCs, glasses, wearable devices, or the like. The intelligent virtual assistant can take many forms of interfaces, for example, an assistant on a website, a mobile personal assistant, sms, email, audio on a phone call, interactive screen, inside a robot, or the like. The user maybe presented with various forms of visual or audible media such as a human avatar, text, buttons, video, documents, links, audio, images, diagrams, forms, or the like.

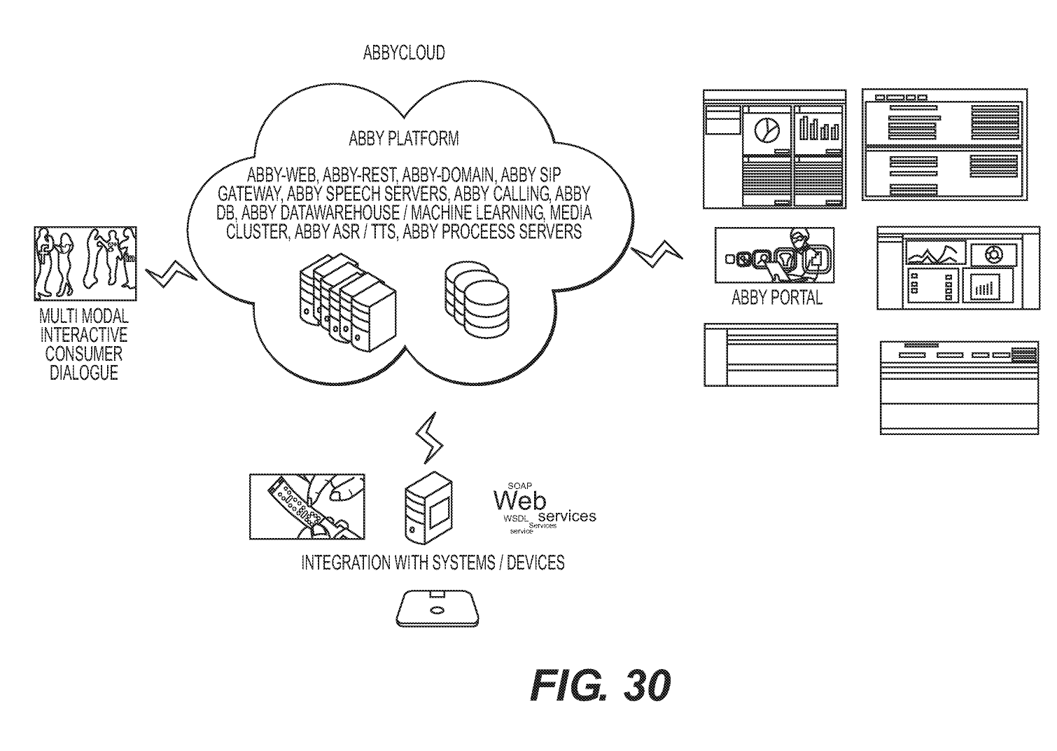

FIG. 30 illustrates overall system for an intelligent virtual assistant platform according to an embodiment. The intelligent virtual assistant platform can be designed as a cloud-based application that runs on one server or horizontally scaled applications depending upon the volume needed. As illustrated in FIG. 30, the intelligent virtual assistant platform can comprise various types of servers in a cloud-based environment. Each type of servers can include its own cluster of servers. Thus, if any node in the system fails, the rest can automatically take over. The intelligent virtual assistant can be configured via a portal site by an admin user. This means that non-developer users can build and manage an intelligent virtual assistant without programming. The intelligent virtual assistant platform can be integrated with other systems and devices to pull data as well as push data. The systems and devices may include Web Service, mobile/wearable devices, PCs, tablets, Flat file, FTP, Socket connection, CSV, IoT devices, or the like.

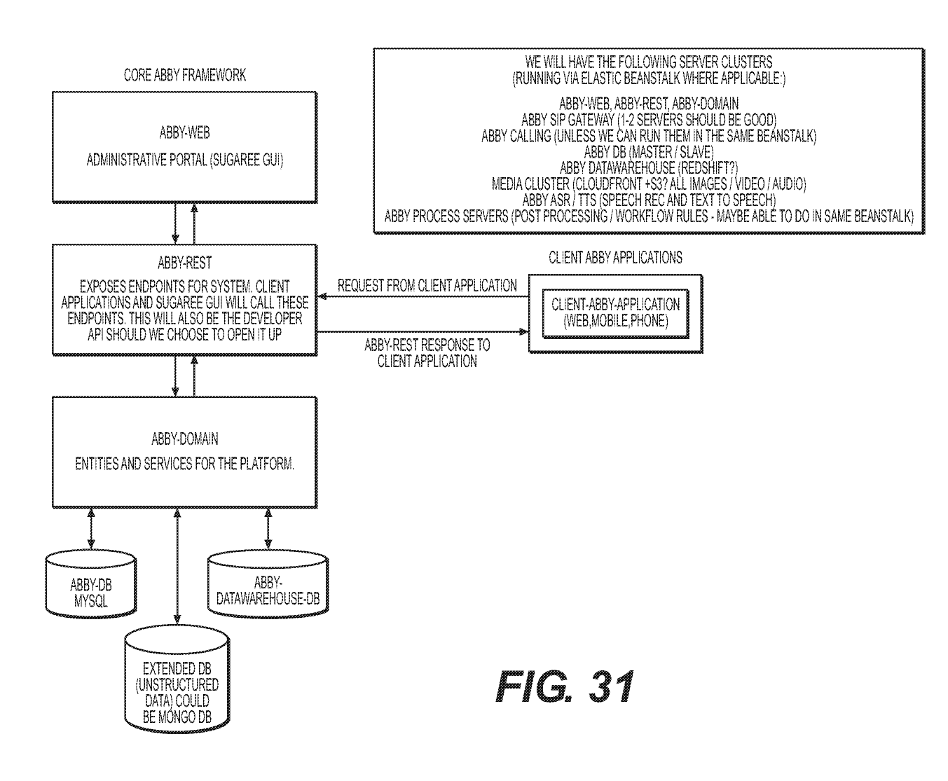

FIG. 31 illustrates core framework for the intelligent virtual assistant system described in FIG. 30. The core framework can comprise following types of servers: Abby-web, Abby-Rest, Abby-Domain, Abby-SIP Gateway, Abby Speech servers, Abby Calling, Abby ASR/TTS, Abby Process Servers, Abby-DB, Abby-Datawarehouse or the like. Abby-web is a web server for the purpose of serving web/mobile applications. For example, Abby-web can provide an administrative portal site for admin user so that they can configure their own intelligent virtual assistant. Abby-Rest is a server that serves the RESTful APIs for the system, It can expose endpoints for the system. A client application and graphical user interface of the intelligent virtual assistant can call theses endpoints. Abby-Domain is a server that runs the Services/Entities and connects to DB. Abby-SIP Gateway is a SIP gateway proxy that connects to carriers and manages inbound and outbound call traffics. Abby Speech Server is a speech server used for natural language process (NLP). Abby Calling is a server to control phone calls and runs an interactive voice response (IVR). Abby ASR/TTS is a server that performs automated speech recognition (ASR) and text to speech (TTS). Abby Process Servers are background processing servers for machine learning (ML), artificial intelligence (AI), Media Conversion, Data manipulation, Workflow, Reminders, or the like.

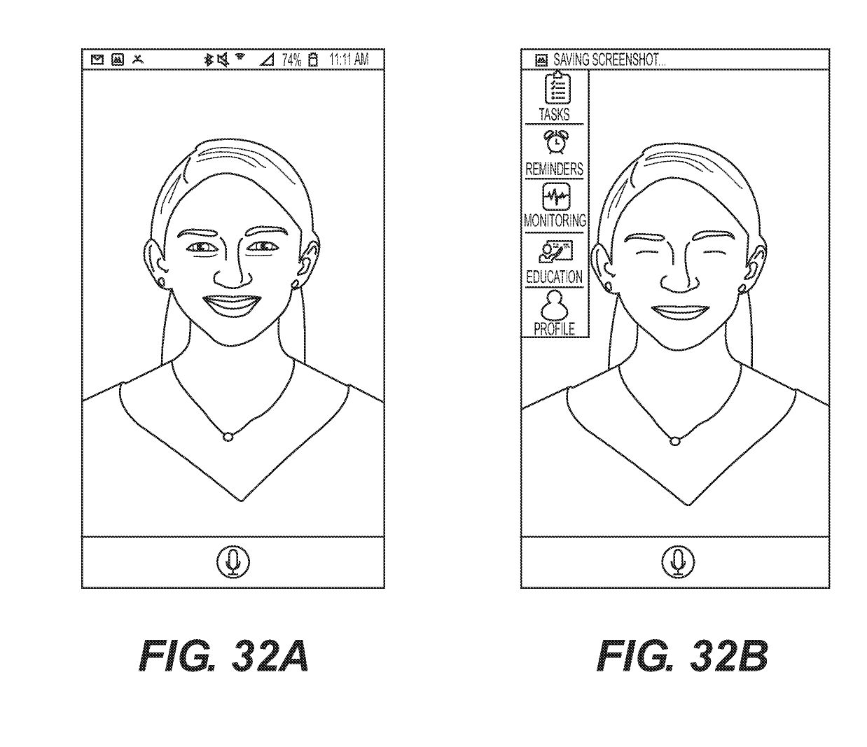

FIG. 32A illustrates the user interface of an intelligent virtual assistant in a mobile application according to an embodiment. FIG. 32B illustrates the user interface of an intelligent virtual assistant when a user clicks navigation bar according to an embodiment. The mobile application can be installed in a mobile device, or wearable device and can provide users the same functionalities of the website as described above. For example, users can register accounts, play the games, and receive information related to their personal characteristics. The mobile application can also provide functions of life coaching through the human avatar as illustrated in FIG. 32A. The human avatar can receive users' questions and give answers contained in the knowledge database.

As illustrated in FIG. 32A, the intelligent virtual assistant can be the center of the interface and be designed to function as a human life coach. The intelligent virtual assistant (Abby) can be engaged by clicking on the microphone button for the user to speak and Abby to respond. The user can also click on the screen to slide in the navigation bar which allows the user to navigate the tasks, reminders, monitoring, education and profile sections of the application. The task section can be located where Abby displays the recommended tasks the user should be doing. These tasks can be based upon the profile that Abby has for the user. The tasks can also be assigned, customized, or personalized by the Abby portal, the interface through which users interact with Abby. The reminder section can be located where Abby reminds the user of events. Dynamic events can be pulled in from 3rd party systems such as a medical record or doctor's office. The reminders can also be linked to any 3rd party system. For example, Abby can remind the user via any other delivery system even if the user is not logged into the application. Monitoring can be automatic or self-reported. For example, if Abby is configured to track weight for a user, Abby can pull the data into the system from a Bluetooth enabled scale. If the user does not have such a scale, he or she can directly input the weight on the form provided by Abby. The education section can be located where Abby can dynamically educate the user based upon their interactions with Abby. The users can configure the education section through Abby portal. The education can also include teach-back method that can be used for Abby and the Abby portal to determine the level of understanding of the subject matter. This enables Abby to re-enforce and dynamically configure the education for that user.

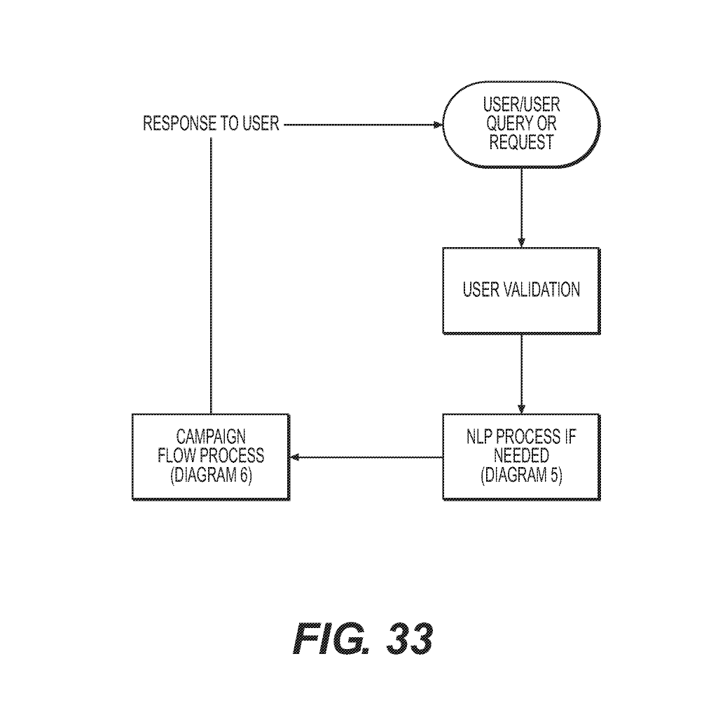

FIG. 33 illustrates an example process that a user engages with an intelligent virtual assistant system. For example, once the user query or request is received at the system implementing the intelligent virtual assistant, the system checks to see if the user is registered in the system. If the user is authorized, the system can determine whether Natural Language Processing (NLP) is necessary. After that, the system can proceed to Campaign Process flow and sent its response to the user.

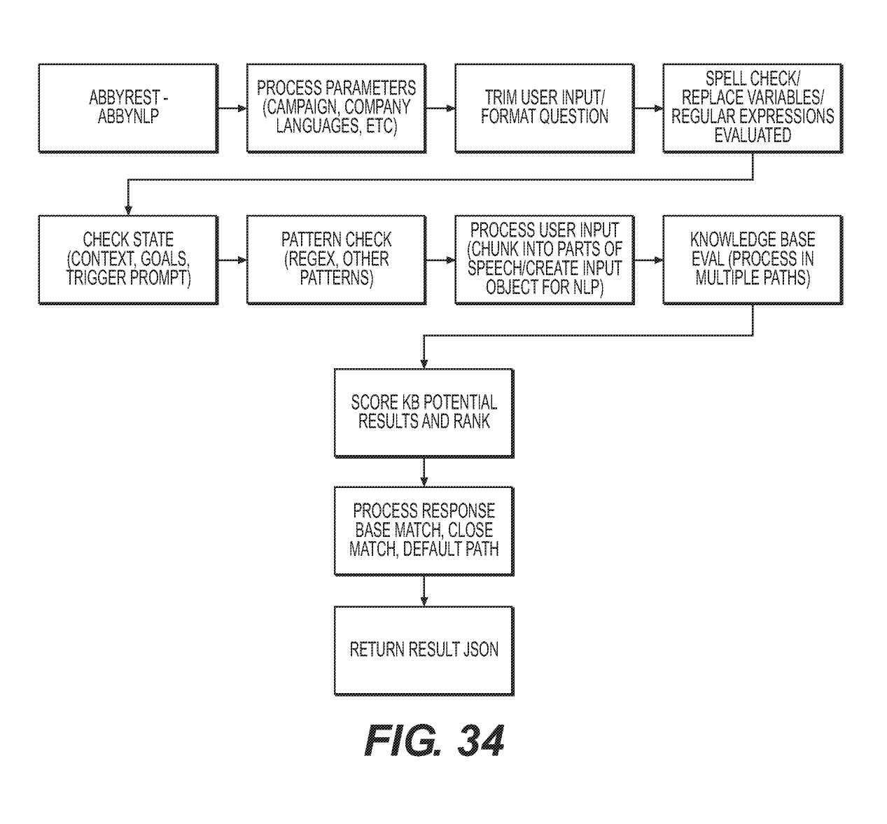

FIG. 34 illustrates an example process for natural language processing by the individual intelligence assistant (Abby) system according to an embodiment. First, Abby can receive a spoken or written request from the user through its user's interface. As illustrated in FIG. 34, the AbbyRest-NLP service can take in the request and initiate processing the parameters. The parameters can include the campaign, knowledge-bases, company, language, user input, other configuration parameters, or the like. Once the parameters are processed, a series of actions can follow: cleaning up the user inputs, spelling check if it is on, replacing dynamic variables, evaluating regular expression, etc. After that, the state and context can be evaluated and set into memory. And then any patterns or 3rd party look ups can be performed so that the system can handle dynamic queries. After this, the user input can be chunked into parts of speech and compared against the knowledgebase. The results can be scored and compared with context and state. The highest scoring result that is above a threshold can be returned. If the result set does not include any result above the threshold but yields a result above the minimum threshold, a list of most likely results can be returned. If no result above the minimum threshold is found, then the default goal/path can be returned. The result can comprise a complex object with JavaScript Object Notation (JSON) that contains video, audio, text, documents, links, forms, user interface information and configuration variables.

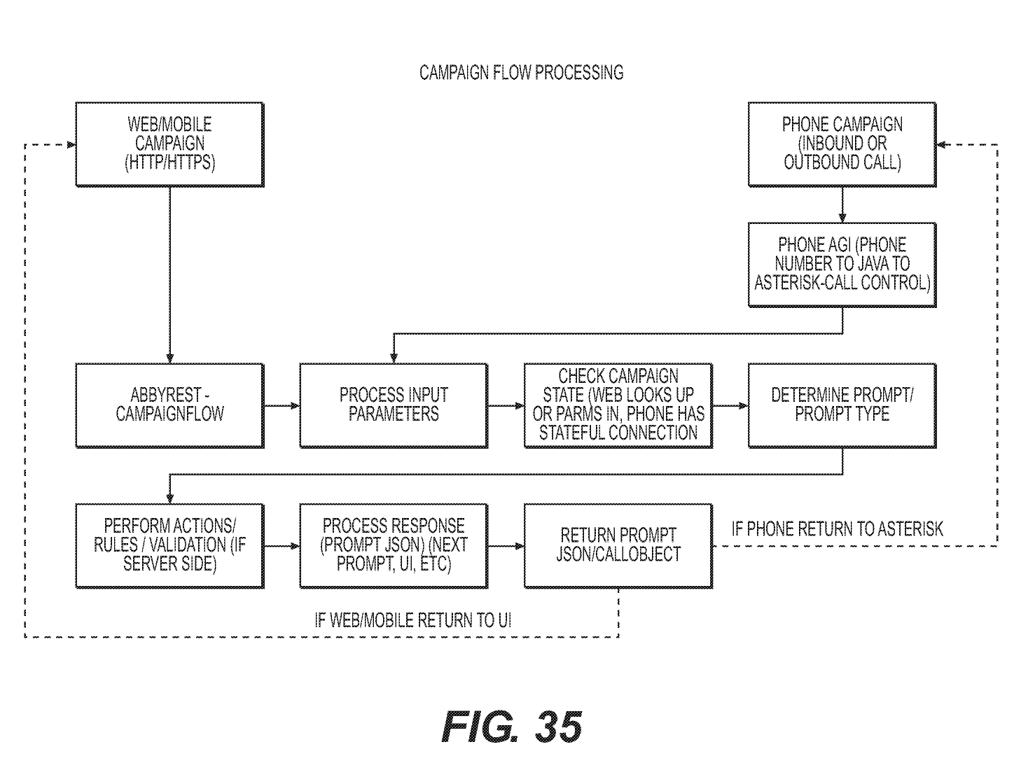

FIG. 35 illustrates how campaign logic is processed by an intelligent virtual assistant system according to an embodiment. Specifically, the campaign logic can include how the system decides, how the system responds, and who the system determines what the next step is. Depending on the interface that the user engages, the request can come in to the server via HTTP or SIP (SMTP can be considered HTTP for this purpose). The first step is to evaluate the input request and parameters. The system can check the campaign state and prompt type. Based upon the state and prompt type, the system can determine what actions need to be taken and what rules are needed to be evaluated. For example, a prompt may need to evaluate the user input and pull in variables from a previous prompt. The prompt may also need to evaluate other campaign variables to log into a third-party system and retrieve account information. After the prompt actions and rules are completed, the system can prepare the response to be returned. The campaign can be an application. It can include a prompt or collection of prompts.

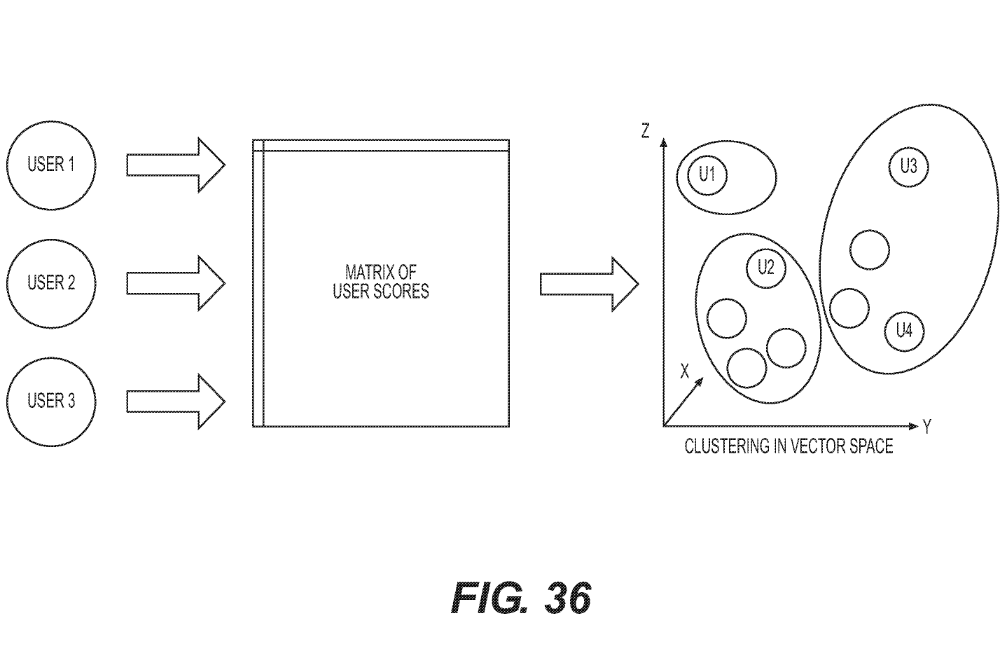

FIG. 36 is illustrates users' spatial representation within an artificial intelligence that implements an intelligent virtual assistant system according to an embodiment. As illustrated in FIG. 36, users can be given a spatial representation within the system. This representation can occur during preprocessing stage. The data can be input as a matrix of (users-by-scores) where each column represents a score given on a task and each row represents a user. This can be a basic vector space representation that treats each user as a point in d-dimensional space. Using this representation, applications can cluster users into a fixed number of groups and predict outcomes given other, similar users.

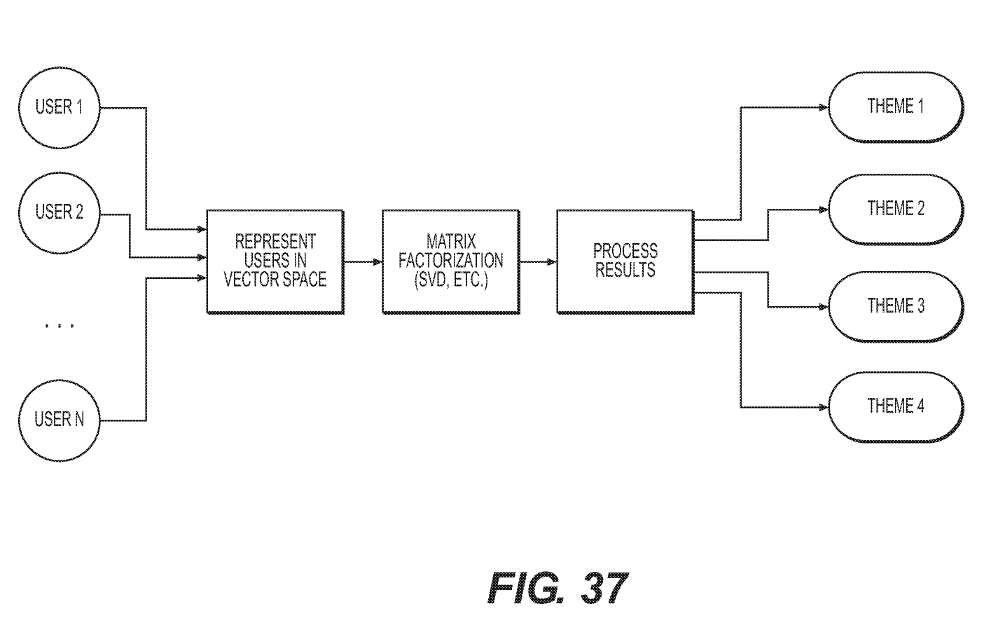

FIG. 37 illustrates an example process how users' latent personality factors can be extracted from a vector space representation of users described in FIG. 36. Matrix factorization techniques can be used to discover latent “themes” within vector space matrix data. For example, a set of topics can be automatically discovered in a group of text documents. This allows for soft grouping of games and also for mapping of users to the themes. In an embodiment, a person can inspect the emerging topics to determine what they correspond to, for example, measuring specific aspects of performance, aligning with different executive functions, or the like.

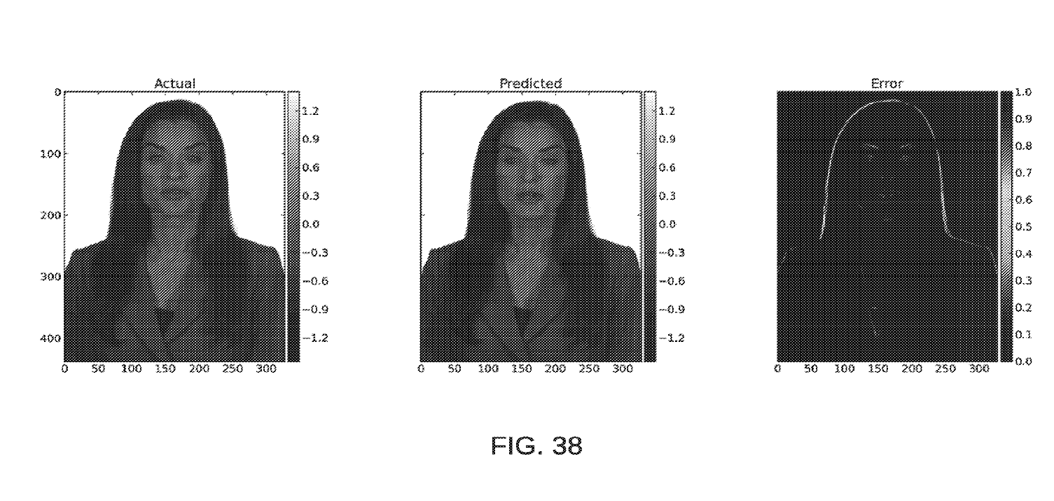

FIG. 38 illustrates an actual example footage and prediction according to an embodiment. With machine learning, it can be learned to model the live action avatar using training footage. It can also come up with probability models over the space of video clips. This allows the prediction of which frame is most likely given a previous set of frames. Thus, synthetic footage can be generated eventually.

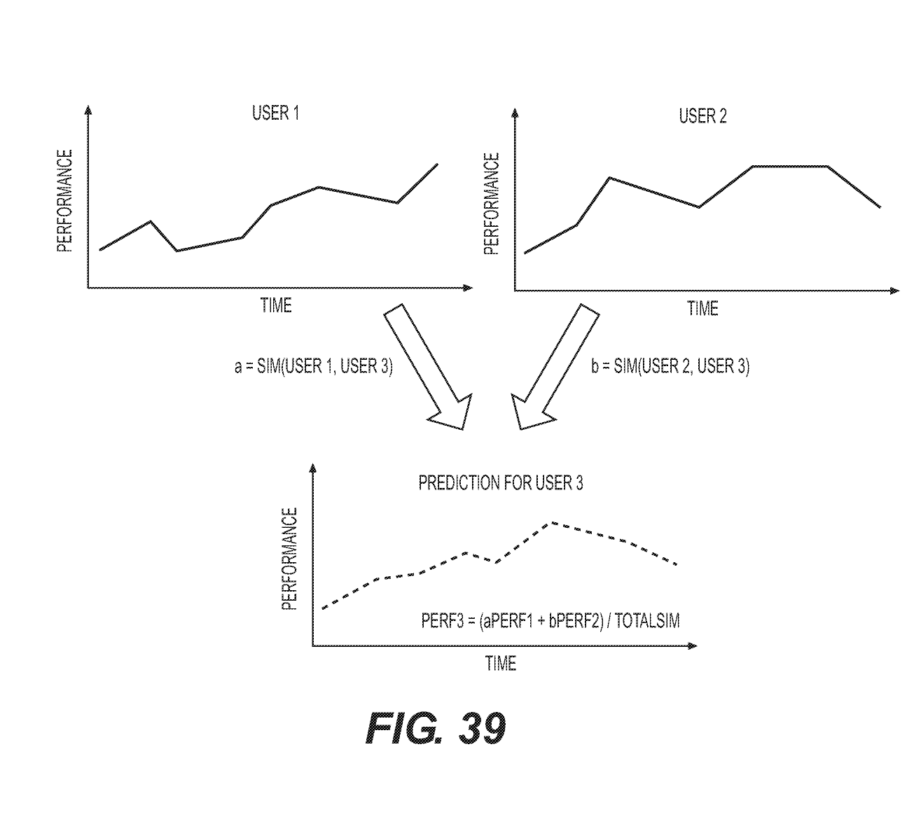

FIG. 39 illustrates prediction for user improvement and danger according to an embodiment. For example, predictive models can be learned based on a temporal history of how users interact with the system, The predictive models can include how users will improve over time, and when users are in danger of no longer using the system.

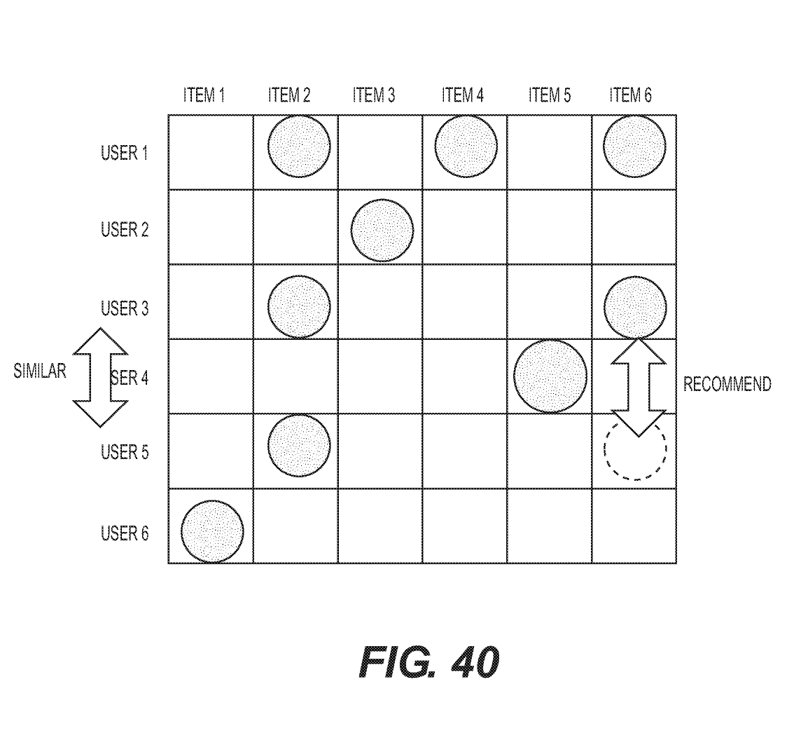

FIG. 40 illustrates prediction of interesting item for users according to an embodiment. Based on a user's past interests and the interests of other, similar users, it can be learned to predict which items will interest the user. For example, the system can adapt collaborative filtering technique to predict the interesting item for the user.

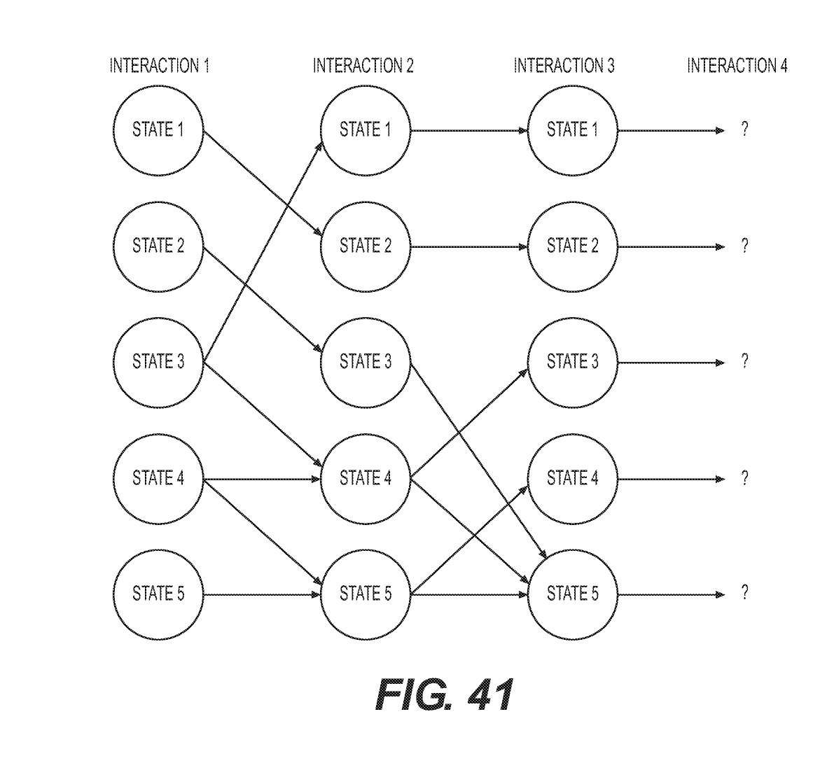

FIG. 41 is a flow diagram illustrating how an intelligent virtual assistant system understand user interactions and proactively predict the user's intent according to an embodiment. Through the use of machine learning, patterns of usage and their correlation can be discover so that the system can obtain insight why someone is using the system, what they hope to achieve, and what their likely next steps of action are. These insights can be further applied to steer suggestions and potentially drive sales. Through campaigns, users' likely paths can be predicted. Moreover, common “exit points” that result in lost sales from frustrated users can be identified. Proactive suggestions that answer questions before a user asks them can also be created. It can lead to more natural navigation through the system, much like that auto-typing search engine suggestions lead to easier use of Google. Aside from user facing aspects, the same analytics capability can be leveraged on the client facing backend, providing valuable insights into customers and campaigns. This knowledge can assist directly in crafting better campaign strategies in quantitatively justified ways. With this knowledge, the system can: (1) find and predict likely paths through a campaign; (2) understand and predict high-level user intent when entering the system; and (3) predict likely next questions and topics, given historical interaction data.

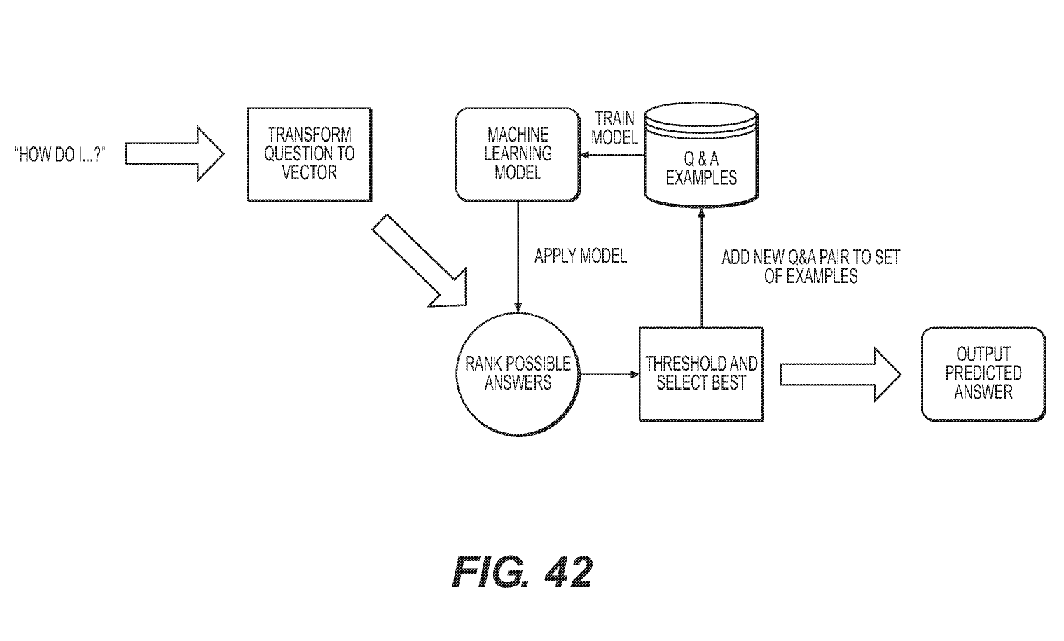

FIG. 42 is an example flow illustrating how an intelligent virtual assistant system can formulate answers to novel questions according to an embodiment. One of the quickest ways to convince users that a system is not intelligent is to repeatedly respond to their queries with replies of “I don't know” and “I do not understand your query.” Machine learning can be used to answer novel questions in the Q & A system. Given a set of possible answers, and a training set mapping existing questions to these answers, the system can formulate a probabilistic weighting of how likely each answer is for a new question never-before-seen by the system. This may require use of natural language processing, specifically, transforming sentences into vector space representations and learning a multiclass classification algorithm predicting answers given sentence features.

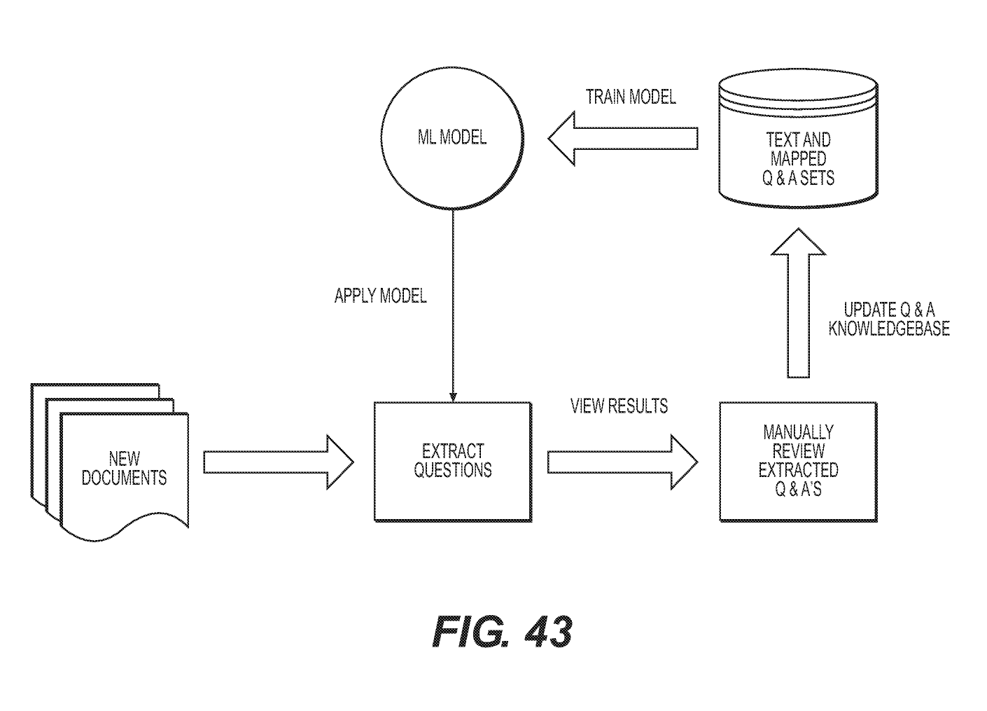

FIG. 43 is an example process illustrating automated question extraction according to an embodiment. Given free-form client supplied text documents, a goal is to eventually automatically populate a knowledgebase with a list of possible questions and answers to these questions. This knowledgebase can then be hand-curated to ensure quality and add any question/answer pairs that were missed by the automated process.

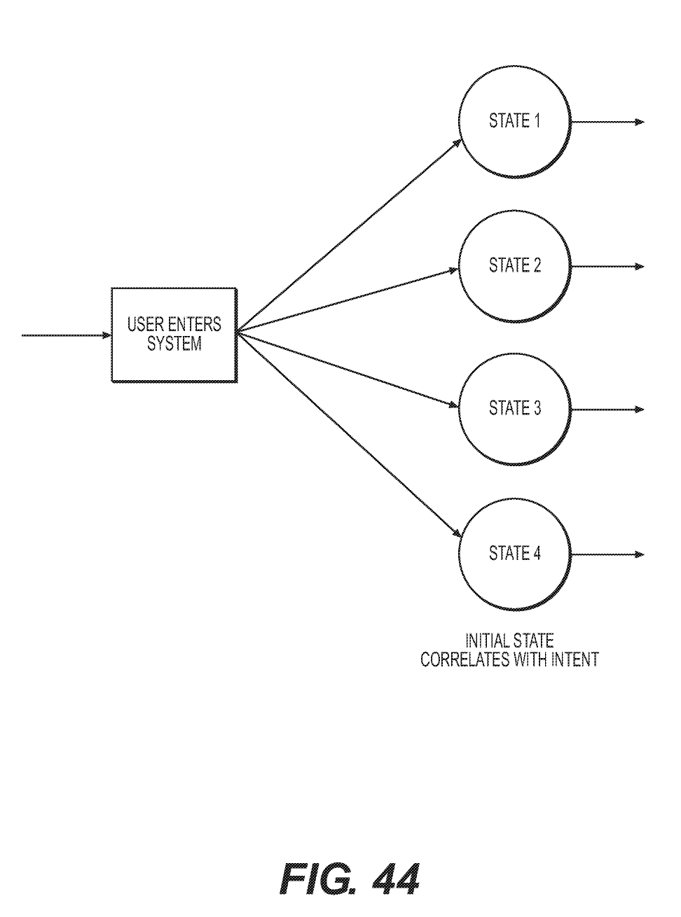

FIG. 44 is a block diagram illustrating prediction of user intent according to an embodiment. As illustrated in FIG. 38, given historical user data and current user context, the system can learn which of the possible first states is likely to be visited by the user. Finding these correlations can allow for proactive suggestions to the user, predicting the issue(s) they need help with.

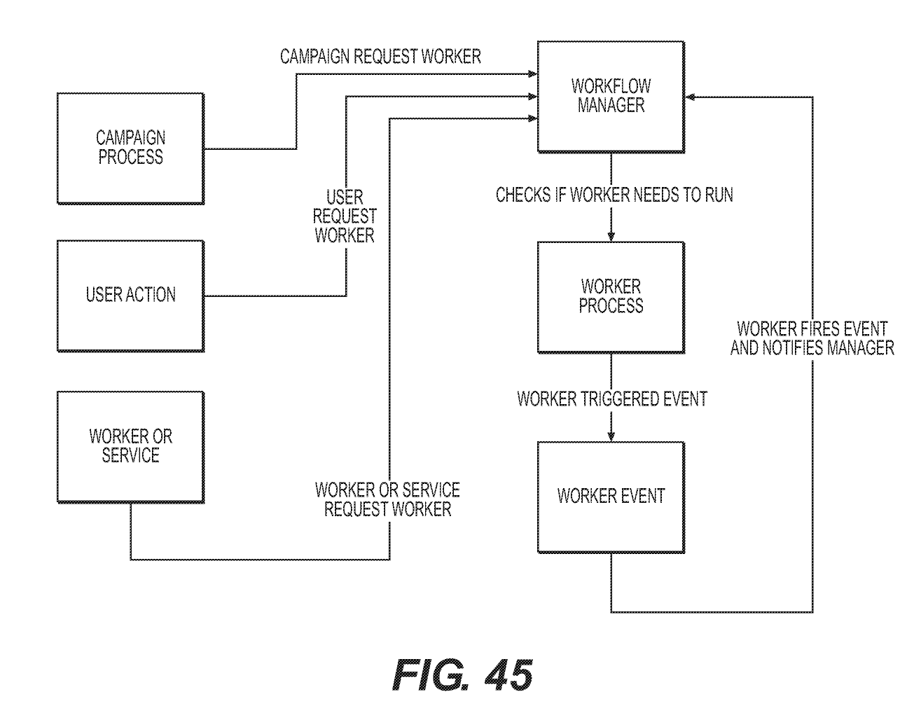

FIG. 45 is a flow diagram illustrating workflow according to an embodiment. The workflow engine can be a state and schedule system that triggers actions based upon rule sets. This engine is where the business logic can be dynamically configured and managed. Each worker can be triggered by one or many events, rule and conditions. The action taken by a worker can be one or many of the following actions: running a campaign, pushing Abby response, sending an email, accessing a 3rd party web service, sending a call, sending an SMS, creating a reminder, creating a task or the like. Workers can run on a schedule, for example, one off or on demand.

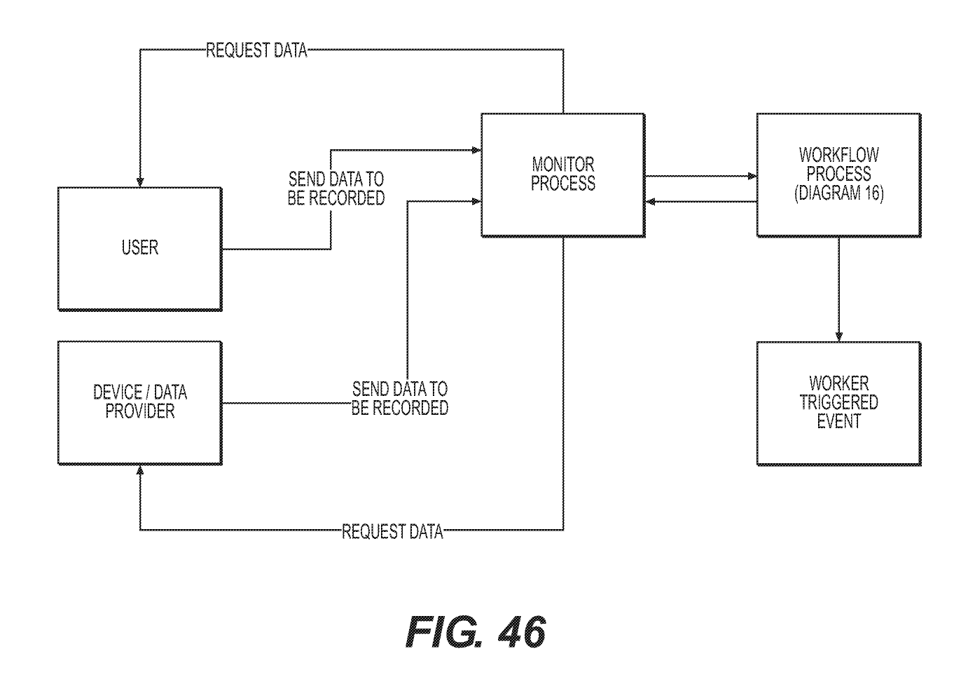

FIG. 46 is a flow diagram illustrating monitoring process according to an embodiment. Monitoring can be an action of capturing and recording information about a particular item. For example, the system can have the user record their weight and pull the data from a third party or Bluetooth device. Workflow workers can configure the methods of data collection, frequency, and rules around capturing the data. Complex rules can be set up in the workflow engine of nested workers in order to check multiple pieces of data that is being monitored. For example, if a user who: (1) has a Congestive Heart Failure patient gained four pounds in three days; (2) have been taking their prescribed medications (another item that can be monitored); and (3) their heart rate is taking longer to return to normal standing heart rate after an exercise (again another monitored item), a worker or group of workers can notice this and trigger an event such as a call to their doctor.

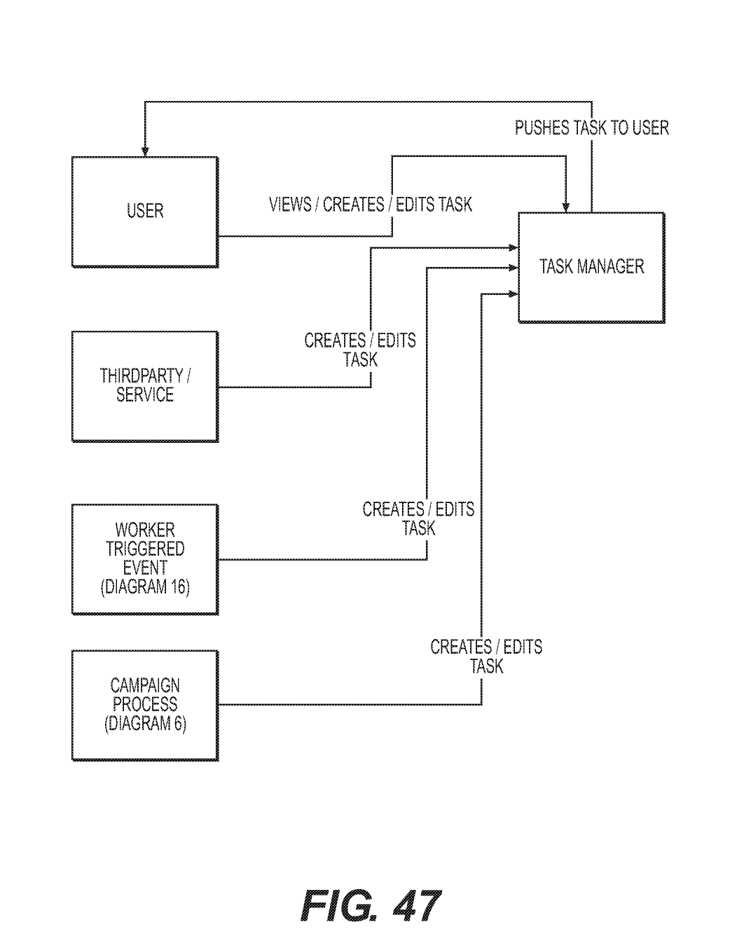

FIG. 47 is a block diagram illustrating tasks according to an embodiment. Tasks can be to do items, for example, a campaign, triggering a worker in workflow engine, simple data collection, reminder, or education item. Tasks can be created by a user role, Abby portal admin user, or a user. In one embodiment, tasks can be dynamically created by a worker trigger event. Tasks can be scheduled or unscheduled. For example, a Congestive Heart Failure patient need to weigh themselves daily or a doctor need to put an appointment request on patients' task list.

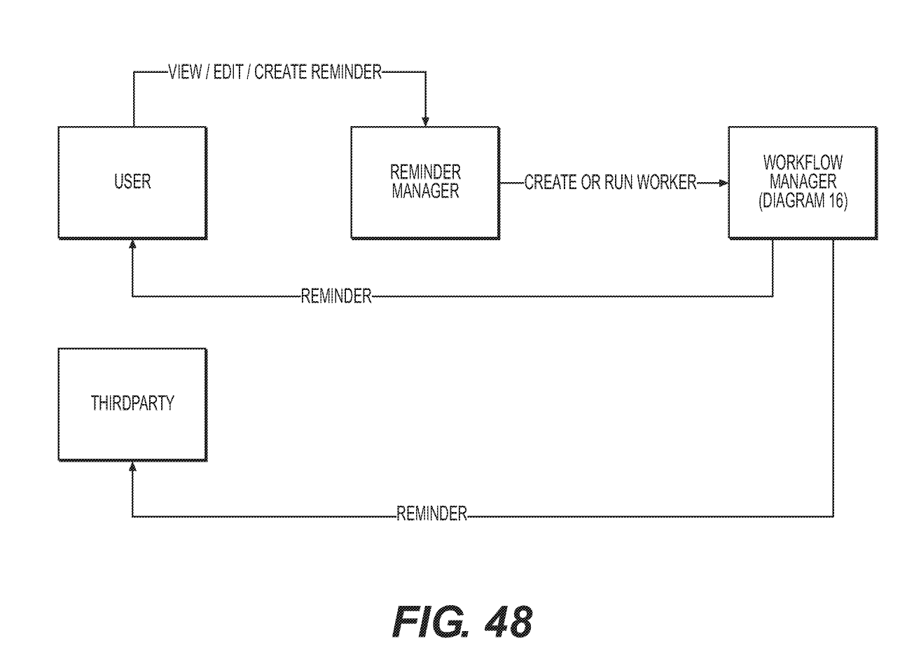

FIG. 48 is a block diagram illustrating reminders according to an embodiment. The reminder can be a user defined reminder created by Abby portal admin users. It can also dynamically created by workflow workers. All reminders can have workflow workers with trigger events. The trigger event can specify how the reminder notification is delivered. For example, a Congestive Heart failure patient needs to be reminded to take their medications in every morning. The patient can set the reminders up in the notification preferences. In an embodiment, by setting the reminder, the patient can receive a phone call each morning reminding them to take their medications.

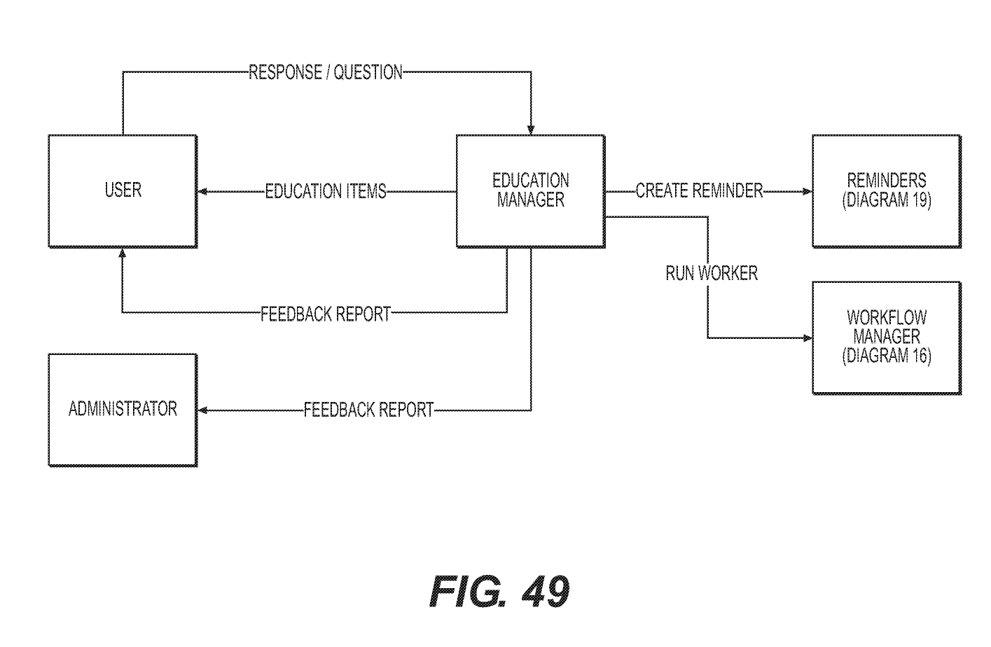

FIG. 49 is a block diagram illustrating education according to an embodiment. Education can be predefined learning modules for a given subject area. These learning modules can be performed in an interactive way by setting the intelligent virtual assistant as the instructor. The intelligent virtual assistant can also give teach backs and trigger reminders to reinforce the education materials. In addition, the intelligent virtual assistant can track the user's progress and score their results in the system.

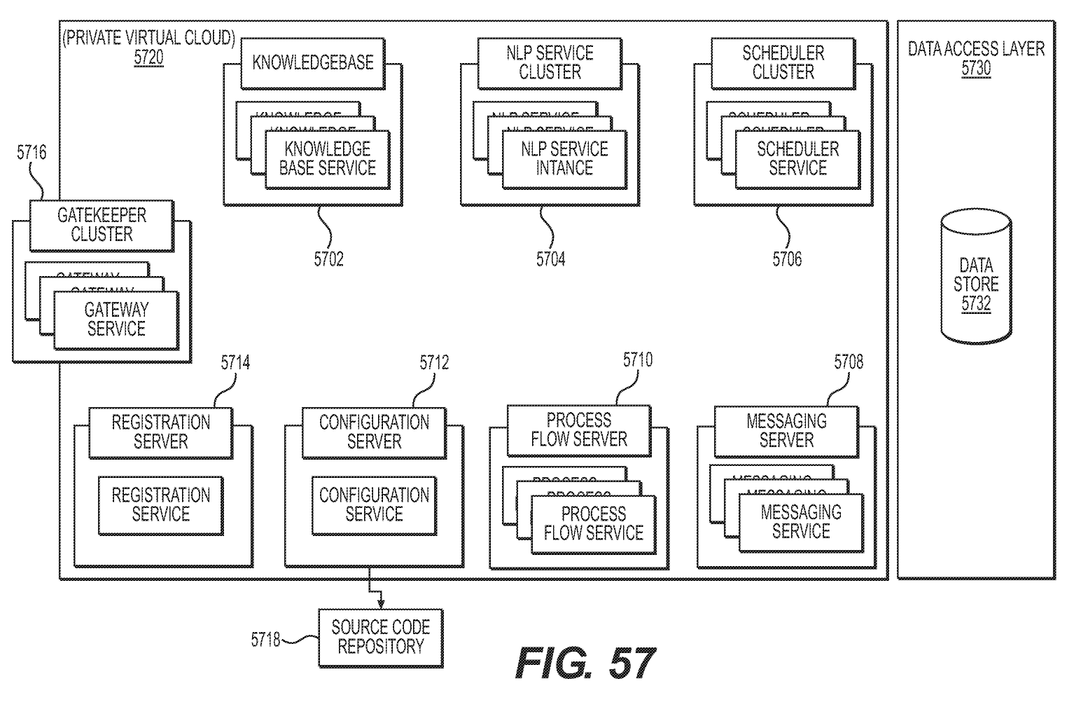

FIG. 57 is a block diagram illustrating an example system for an intelligent virtual assistant platform according to an embodiment. The platform comprises two main components, a private virtual cloud 5720 and a data access layer 5730.

The private virtual cloud 5720 comprises components that interact with each other to create the functionality described herein: a knowledgebase 5702, an NLP service cluster 5704, a scheduler cluster 5706, a messaging server 5708, a process flow server 5710, a configuration server 5712, a registration server 5714, and a gatekeeper cluster 5716.

Each component of the private virtual cloud 5720 either comprises or creates one or more services for the intelligent virtual assistant platform, most of which are private to the private virtual cloud 5720. For example, the knowledgebase 5702 comprises knowledgebase services that include one or more intent engines and also access other platform components for campaign flows, the functionality of which is described further with regard to FIGS. 59, 61, and 62; the NLP service cluster 504 comprises NLP service instances that process NLP queries from user input and create and access NLP trained models, described below; the scheduler cluster 5706 comprises scheduler services to schedule events for a user; the messaging server 5708 comprises messaging services to queue events and transmit data between components and services within the private virtual cloud 5720 and outside the private virtual cloud 5720; the process flow server 5710 comprises process flow services that track and route campaign states and also includes email, SMS, and push services; the configuration server 5712 comprises a configuration service that configures and updates the platform via a source code repository 5718; the registration server 5714 comprises a registration service that is used to register new users to the platform; and the gatekeeper cluster 5716 comprises gateway services, which are the only user-facing services and are used to process user requests and interactions. Services may be instantiated dynamically during use of the platform to compensate for excess user load.

The data access layer 5730 acts as a gateway to the data store 5732 and provides an API that platform services may use to access data stored in the data store 5732. Examples of such data include language corpora, NLP trained models, campaign states, user progress or information, and any other data useful to the intelligent virtual assistant platform and user.

In some embodiments, there may be a non-local, expanded data store, a “data warehouse,” that allows services of the components of the private virtual cloud 5720 to export data for analytics and machine learning purposes. For example, events may be sent outside the private virtual cloud 5720 to a message queue where they are directed to a filesystem for storage and cataloguing. The filesystem may then direct the events to analysis tools or processes before sending them to the data warehouse. Question events processed by the platform may be sent to a query/export process to analyze the types of queries being performed in the platform before they are saved in the data warehouse. Other events, including error events and customer interaction events may be sent to a machine learning process for analysis before being stored in the data warehouse. Machine learning analysis of events allows the platform to learn from its mistakes and successes to improve over time. Other analytics tools, such as those using Online Analytical Processing (OLAP) may be used by administrators to further analyze the data stored in the data warehouse for trends, statistics, training data, and other useful analytics.

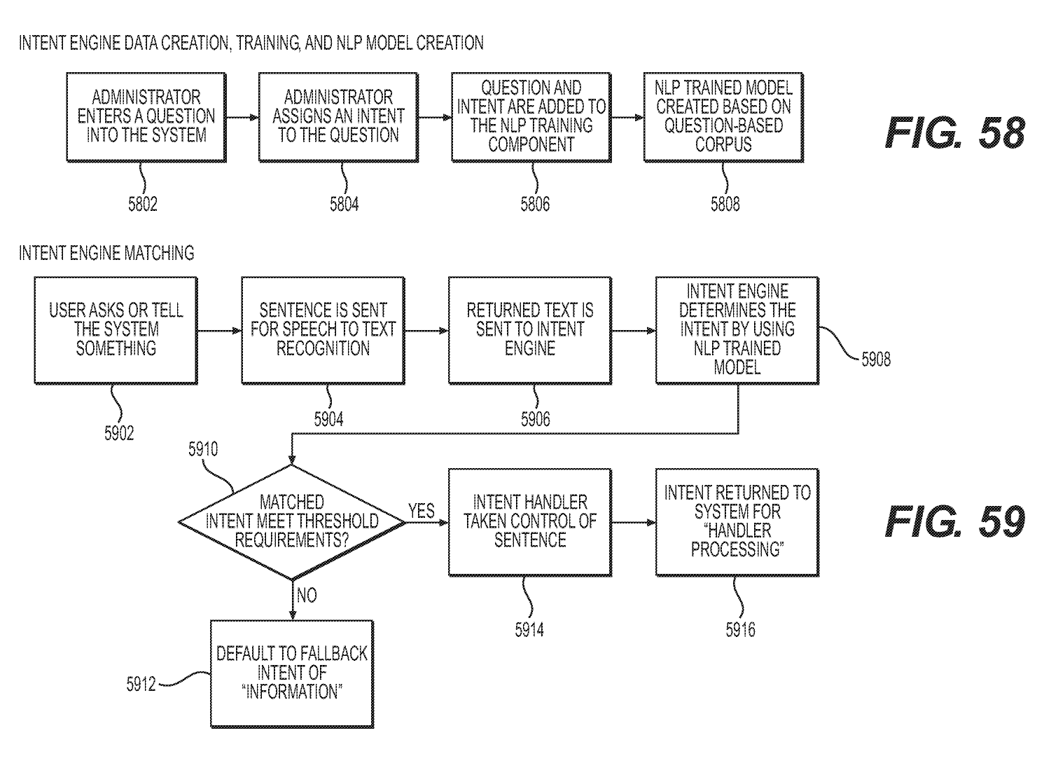

FIG. 58 is a flow diagram illustrating example NLP model creation with intents, according to an embodiment. First, at block 5802, an administrator creates a campaign and enters a question or question-response pair into the platform. Then, at block 5804, the administrator assigns an “intent” to the question. Alternatively, the administrator may enter several questions or question-response pairs with assigned intents all at the same time, e.g., via text file. An intent is a label that gives meaning to a question or query and helps route the query through the various platform components. For each intent, there is a specific handler service that processes the query it is sent. There may be an unlimited number of intents and an unlimited number of intent handlers in the platform. For example, an intent may be “LOCATION,” which indicates to the platform that the user is asking for location information, and the user request should be routed accordingly. The user query may then be sent to the “LOCATION” intent handler service for processing, which may comprise a database lookup, internet search, or other processing to access the information the user is asking for. Training data may be entered via a text file or other suitable means and may look like the following example data, where the word or words in all capital letters are intents and the words following each intent comprise the matched question/query:
LOCATION where is the highest mountain in the world?
LOCATION where is the Eiffel Tower located?
PERSON who is the president of the United States
PERSON who is the president of Russia
SCHEDULE_COMMAND remind me tomorrow to walk my dog at 9 am
SCHEDULE_COMMAND make an appointment at 10 am tomorrow to go to the doctor

At block 5806, both the question and assigned intent are added to an NLP training component, via the NLP service cluster 5704, which collects the myriad questions with intents added to the platform. The training component then uses machine learning at block 5808 to create a trained NLP model based on the corpus of questions and assigned intents. The trained NLP model may then be used to match intents to questions asked during user interaction with the platform. For example, after training hundreds or thousands of question-intent combinations, the query “who is the president of Canada” would be matched to a “PERSON” intent if the platform was trained correctly. The sentence “who is the president of Canada” may not have been in the training set of data, but because the model “learned” how to match an intent to a sentence, it is able to return the intent of other sentences that match the structure and meaning of the sentences in the training set.

FIG. 59 is a flow diagram illustrating matching intents to user questions according to an embodiment. During interaction with the platform, at block 5902, a user presents the platform with a query by asking for or telling the platform a piece of information. If the query was spoken, the platform then converts the speech to text using voice recognition software at block 5904, otherwise the query moves to block 5906. At block 5906, the text is then sent to an intent engine of a knowledgebase service. At block 5908, the intent engine uses the NLP trained model described with regard to FIG. 58 to determine the intent of the query. When the intent engine attempts to match the question to an intent using the NLP trained model, the NLP trained model returns a “percent match” based on the training data/corpora used to train the NLP trained model. For example, the NLP trained model may return an 80% match, indicating an 80% confidence score of the returned match based on the training question-intent pairs entered into it. At block 5910, the percent match is tested against threshold requirements in the platform to determine if the match is acceptable, which is a configurable setting. For example, the platform may be set for an 85% match threshold requirement before allowing a query to be sent to a specific intent handler. So, any intent that is not matched at an 85% or higher confidence score by the NLP trained model would be a non-match for the platform. If the matched intent falls below the platform's threshold, a default intent may be used to route the query. In the example flow diagram of FIG. 59, a non-match flows to block 5912 and sets the intent to the platform's default intent of “INFORMATION,” which may then be handled by attempting the closest intent match, attempting to rematch an intent, or asking for more information from the user. If the matched intent meets the threshold requirements, the query is sent to an intent handler for that specific intent, shown by block 5914. At block 5916, the intent handler then processes the query to return an answer to the user. For example, if a user said to the platform, “remind me to call my mom at 5 pm today,” the voice audio would first be parsed for text using voice recognition. That text would then be sent to the intent engine where the trained model will match the “SCHEDULE_COMMAND” intent to the user's statement or query. Assuming the NLP trained model matched the SCHEDULE_COMMAND intent with a high enough threshold, the query would be sent to the handler for the SCHEDULE_COMMAND intent, which may then process the query and create a calendar event for the user.

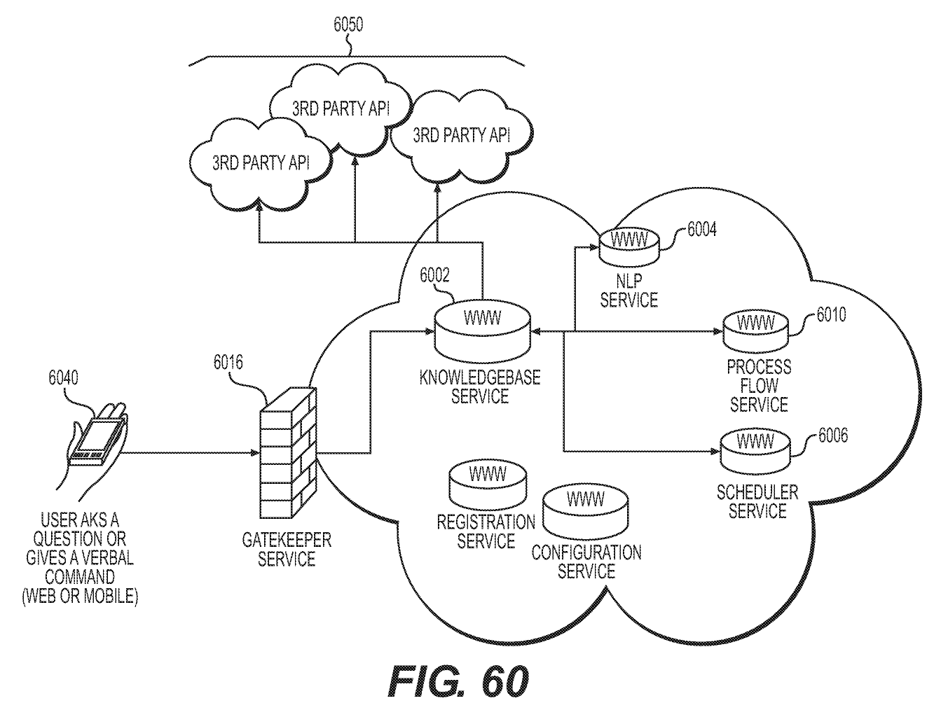

FIG. 60 illustrates an example data flow of conversational NLP according to an embodiment. More particularly, FIG. 60 displays the data flow of information through the platform when performing steps such as those of FIG. 59. The depicted cloud is the private virtual cloud 5720, but for ease of description not all platform components are displayed. First, the user 6040 interacts with the platform through voice, text, SMS, VOIP, chat, etc., to form a request or query that is sent to a gatekeeper service 6016 of the gatekeeper cluster 5716. As mentioned above, the gatekeeper services are the only user-facing services, while all others are internal to the private virtual cloud 5720. The gatekeeper service 6016 routes the query to a knowledgebase service 6002 of the knowledgebase 5702.

The knowledgebase 5702 then passes the query to a process flow service 6010 of the process flow server 5710 to determine if this query if part of an existing conversation with the user. The knowledgebase service 6002 then uses its intent engine to verify the intent of the user 6040 and passes the query to the proper intent handler, as described with respect to FIG. 59. More specifically, there may be several different outcomes, and while four of these process flows are described herein, this specification should not be construed as limiting the platform to only these four process flows. If the intent triggers a state-enabled conversation, the query is routed to the process flow service 6010 to track conversation state and context. If the intent does not require the knowledgebase service 6002, such as those for repeating responses or user small talk, the query is sent to the proper intent handler to properly and quickly process the request. If the intent is a scheduling command, such as the SCHEDULE_COMMAND intent described above with respect to FIG. 59, the query is routed to the scheduler service 6006 of the scheduler cluster 5706 to schedule an event for the user 6040. If the intent requires the knowledgebase 5702, the query is sent to a knowledgebase handler to determine a response to the query based on an NLP trained model and any other relevant data and algorithms, like the processes for determining factual information discussed with respect to FIGS. 58 and 59. After the intent is determined, the knowledgebase 5702 or intent handler may call an NLP service 6004 of the NLP service cluster 5704 to find the matched intent, and process the parts of speech and any named entities in the user's search, such as “Mom” or “Eiffel Tower,” to determine how to process the query and respond to the user 6040. Finally, a matched or triggered response from the intent handler is returned to the user 6040.

The response from the platform may be formatted for any client to interpret and may not be limited to text or avatar voice or video. A client may handle the response in any suitable manner, and the response may be customized with other variables to trigger certain processes, such as GUI manipulation. A response may also include debugging and logging information regarding how the response was created. An example response in Javascript Object Notation (JSON) format is located below:

```
{
“message”: null,
“uniqueId”: null,
“explicitDismissal”: false,
“notificationType”: null,
“userStale”: false,
“payload”: {
  “id”: −1,
  “name”: “uncategorized_no_response_found”,
  “campaignId”: 1,
  “system”: false,
  “responseDetails”: [
  {
  “id”: null,
  “type”: “text”,
  “sequence”: 0,
  “id”: null,
  “type”: “text”,
  “sequence”: 0,
  “content”: “Response not found!”
  },
  {
  “id”: null,
  “type”: “text”,
  “sequence”: 1,
  “content”: “General fallback response, as there is no response with name
‘uncategorized_no_response_found’ for campaignId 1”
  }
  ],
  “exceptionMessage”: null,
  “matchData”: {
    “answerType”: “INFORMATION”,
    “matchType”: “MISSED”,
    “responseRank”: {
    “response”: “no match”,
    “rank”: 0
    },
  “matchQuestionId”: null,
  “matchedQuestionText”: null,
  “matchScore”: null,
  “threshold”: 0.85,
  “transactionIdentifier”: 6496728129721389
    }
  }
}
```

A response created by the platform may tie the returned information to content retrieved from a third-party vendor using a third party API 6050. The knowledgebase 5702 may map the user query to a number of responses internally and may also be triggered by a third-party response key. The entire response may be returned by the third-party, or it may return a key for use by the knowledgebase 5702. For example, external APIs, such as the third party APIs 6050, may allow responses to be handled by third parties outside of the platform if the platform has not had enough training in the information the user 6040 is requesting. The third party APIs 6050 may return a key that is mapped to an existing knowledgebase response. All other response types, such as text, video, etc., may be ignored if there is an external API response type.

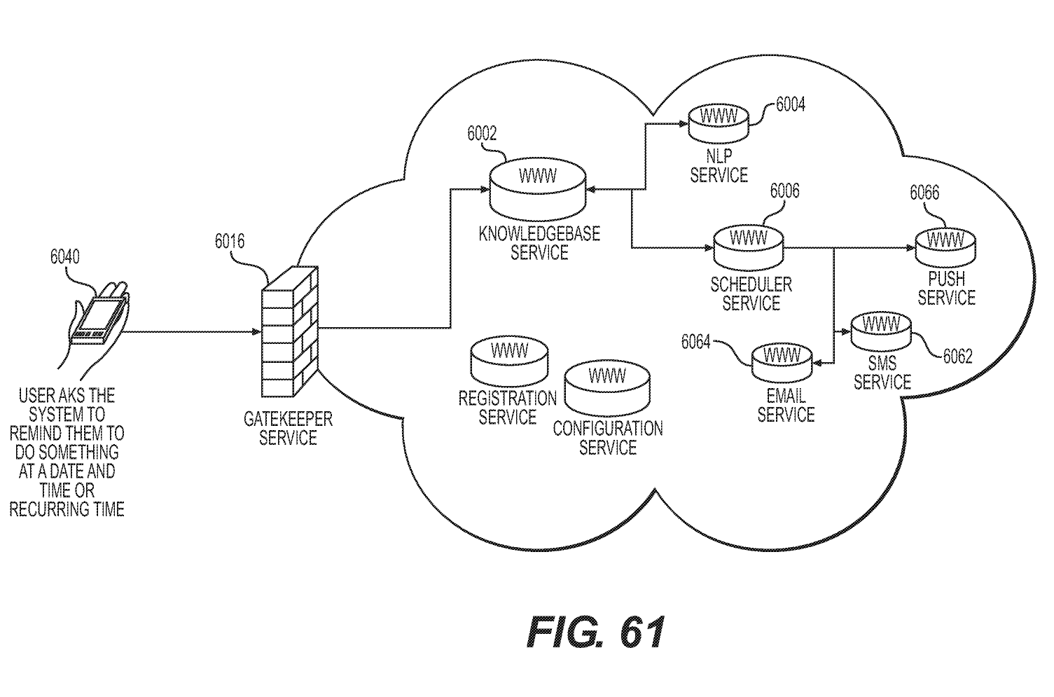

FIG. 61 illustrates an example data flow of scheduling an event according to an embodiment. More particularly, FIG. 61 displays the data flow of information through the platform when performing scheduling, as briefly described above. The depicted cloud is the private virtual cloud 5720, but for ease of description not all platform components are displayed. First, the user 6040 interacts with the platform through voice, text, SMS, VOIP, chat, etc., to form a request or query that is sent to a gatekeeper service 6016 of the gatekeeper cluster 5716. As mentioned above, the gatekeeper services are the only user-facing services, while all others are internal to the private virtual cloud 5720. The gatekeeper service 6016 routes the query to a knowledgebase service 6002 of the knowledgebase 5702. The knowledgebase 5702 then passes the query to a scheduler service 6006 of the scheduler cluster 5706. The scheduler service 6006 then may create, update, read, or remove a scheduled event for the user 6040. After the scheduler service 6006 completes its action, a generic response may be returned to the user 6040 to inform them of the action taken. For example, if the scheduler service 6006 creates an event, the platform may return a response such as, “I have created your event,” or “I have added your doctor's appointment to your calendar for 10 am tomorrow morning.” Alternatively, the response may include all details of the query in the same format as other knowledgebase 5702 responses with one addition; the details of the event, such as date, time, title, recurrence, etc., may be included and specifically parsed out. This data may then be used in API calls to another system or platform if desired. For example, if a user 6040 wanted to schedule an event for “10 am tomorrow morning,” the platform may return a response of, “Your Doctor's Appointment has been created for 10:00 a.m., Sep. 2, 2016, at 123 Fake Street, Smalltown, Pa., USA.” If the user 6040 wanted to schedule this event on a mobile device in addition to the platform, an API call may be easily made to the mobile OS to schedule the event because the specific details of the event have been parsed out and are readily assignable to API attributes.

Each event is stored in the knowledgebase 5702 as an event record, and a trigger for an event notification is created and stored in the scheduler service 6006. Each trigger may have one or more associated notification event types, such as SMS, email, or push notifications. When it is time for an event, or an event's alarm, the trigger fires, and the notification event is passed to a handler via the process flow server 5710. A notification event may be sending an SMS message to the user 6040, sending an email to the user 6040, sending a push notification to an application registered to the user 6040, or any other suitable method of notifying a user of an event. In the example of FIG. 61, the SMS service 6062 is the handler for SMS notification events, the email service 6064 is the handler for email notification events, and the push service 6066 is the hander for push notification events. The SMS service 6062, the email service 6064, and the push service 6066 are services on the process flow server 5710.

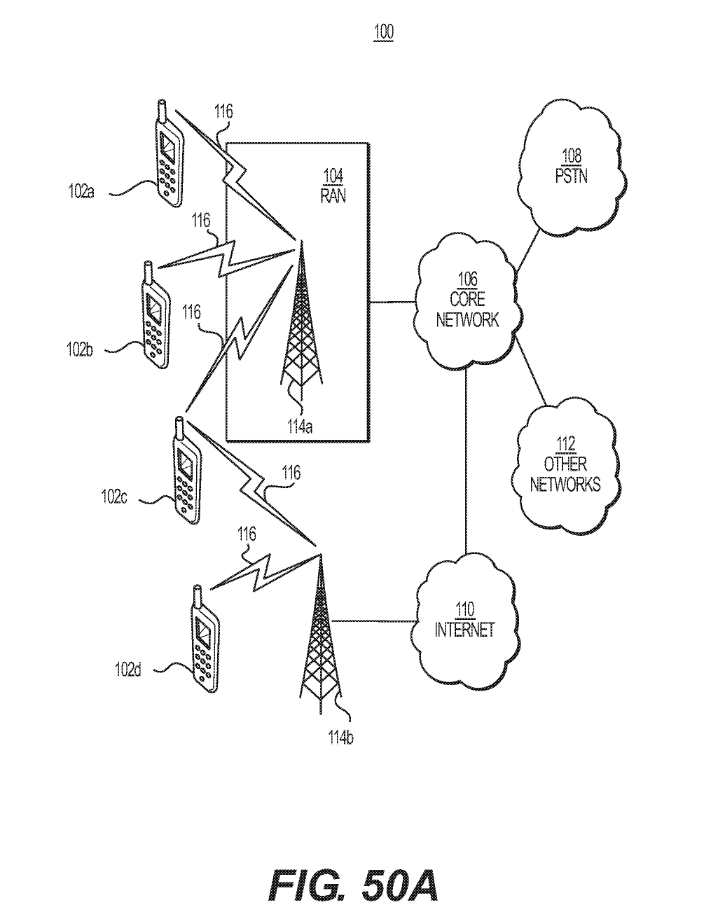

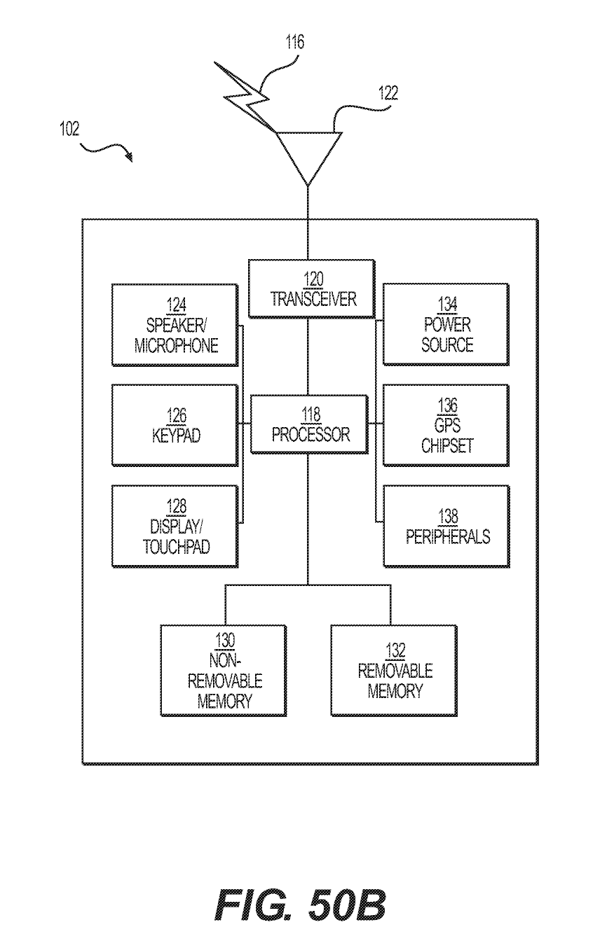

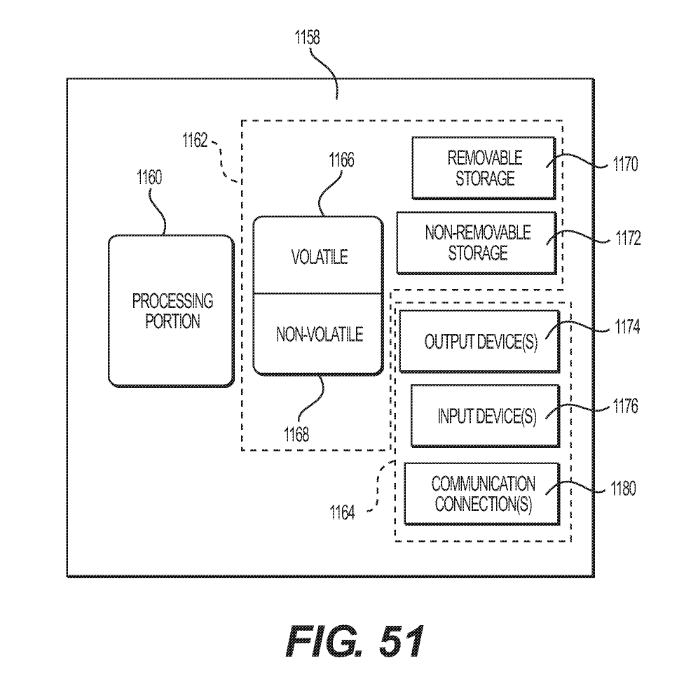

FIG. 50A is a diagram of an example communications system 100 in which one or more disclosed embodiments may be implemented. The communications system 100 may be a multiple access system that provides content, such as voice, data, video, messaging, broadcast, game etc., to multiple wireless users and game players. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. A communications system such as that shown in FIG. 50A may also be referred to herein as a network.

As shown in FIG. 50A, the communications system 100 may include wireless transmit/receive units (WTRUs) 102 a, 102b, 102 c, 102 d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102 a, 102 b, 102 c, 102d may be any type of device configured to operate and/or communicate in a wireless environment. By way of example, the WTRUs 102 a, 102 b, 102 c, 102 d may be configured to transmit and/or receive wireless signals and may include user equipment (UE), a mobile station, a mobile device, a fixed or mobile subscriber unit, a pager, a cellular telephone, a personal digital assistant (PDA), a smartphone, a laptop, a netbook, a personal computer, a wireless sensor, consumer electronics, tablets, multimedia console games, wearable devices and the like.

The communications systems 100 may also include a base station 114 a and a base station 114 b. Each of the base stations 114 a, 114 b may be any type of device configured to wirelessly interface with at least one of the WTRUs 102 a,102 b, 102 c, 102 d to facilitate access to one or more communication networks, such as the core network 106, the Internet 110, and/or the networks 112. By way of example, the base stations 114 a, 114 b may be a base transceiver station (BTS), a Node-B, an eNode B, a Home Node B, a Home eNode B, a site controller, an access point (AP), a wireless router, and the like. While the base stations 114 a, 114 b are each depicted as a single element, it will be appreciated that the base stations 114 a, 114 b may include any number of interconnected base stations and/or network elements.

The base station 114 a may be part of the RAN 104, which may also include other base stations and/or network elements (not shown), such as a base station controller (BSC), a radio network controller (RNC), relay nodes, etc. The base station 114 a and/or the base station 114 b may be configured to transmit and/or receive wireless signals within a particular geographic region, which may be referred to as a cell (not shown). The cell may further be divided into cell sectors. For example, the cell associated with the base station 114 a may be divided into three sectors. Thus, in an embodiment, the base station 114 a may include three transceivers, i.e., one for each sector of the cell. In another embodiment, the base station 114 a may employ multiple-input multiple output (MIMO) technology and, therefore, may utilize multiple transceivers for each sector of the cell.

The base stations 114 a, 114 b may communicate with one or more of the WTRUs 102 a, 102 b, 102 c, 102 d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114 a in the RAN 104 and the WTRUs 102 a, 102 b, 102 c may implement a radio technology such as Universal Mobile Telecommunications System (UMTS) Terrestrial Radio Access (UTRA) that may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114 a and the WTRUs 102 a, 102 b, 102 c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114 a and the WTRUs 102 a, 102 b, 102 c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114 b in FIG. 28A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114 b and the WTRUs 102 c, 102 d may implement a radio technology such as IEEE 802.11 to establish a wireless local area network (WLAN). In another embodiment, the base station 114 b and the WTRUs 102 c, 102 d may implement a radio technology such as IEEE 802.15 to establish a wireless personal area network (WPAN). In yet another embodiment, the base station 114 b and the WTRUs 102 c, 102 d may utilize a cellular-based RAT (e.g., WCDMA, CDMA2000, GSM, LTE, LTE-A, etc.) to establish a picocell or femtocell. As shown in FIG. 49A, the base station 114 b may have a direct connection to the Internet 110. Thus, the base station 114 b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102 a,102 b, 102 c, 102 d. For example, the core network 106 may provide call control, billing services, mobile location-based services, pre-paid calling, Internet connectivity, video distribution, etc., and/or perform high-level security functions, such as user authentication. Although not shown in FIG. 50A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102 a, 102 b, 102 c, 102 d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102 a, 102 b, 102 c, 102 d in the communications system 100 may include multi-mode capabilities, i.e., the WTRUs 102 a, 102 b, 102 c, 102 d may include multiple transceivers for communicating with different wireless networks over different wireless links. For example, the WTRU 102 c shown in FIG. 50A may be configured to communicate with the base station 114 a, which may employ a cellular-based radio technology, and with the base station 114 b, which may employ an IEEE 802 radio technology.

FIG. 50B is a system diagram of an example WTRU 102 that can implement the mobile application disclosed herein. As shown in FIG. 50B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 50B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114 a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 50B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114 a, 114 b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 51 is a block diagram of an example processor 1158 which may be employed in any of the embodiments described herein, including as one or more components of mobile devices 210, 310, and 610, as one or more components of network equipment or related equipment, and/or as one or more components of any third party system or subsystem that may implement any portion of the subject matter described herein. It is emphasized that the block diagram depicted in FIG. 51 is exemplary and not intended to imply a specific implementation. Thus, the processor 1158 can be implemented in a single processor or multiple processors. Multiple processors can be distributed or centrally located. Multiple processors can communicate wirelessly, via hard wire, or a combination thereof.

As depicted in FIG. 51, the processor 1158 comprises a processing portion 1160, a memory portion 1162, and an input/output portion 1164. The processing portion 1160, memory portion 1162, and input/output portion 1164 are coupled together (coupling not shown in FIG. 51) to allow communications between these portions. The input/output portion 1164 is capable of providing and/or receiving components, commands, and/or instructions, utilized to, for example, request and receive APNs, MNCs, and/or MCCs, establish and terminate communications sessions, transmit and receive data access request data and responses, transmit, receive, store and process text, data, and voice communications, execute software that efficiently processes radio resource requests, receive and store radio resource requests, radio resource request processing preferences and configurations, and/or perform any other function described herein.

The processor 1158 may be implemented as a client processor and/or a server processor. In a basic configuration, the processor 1158 may include at least one processing portion 1160 and memory portion 1162. The memory portion 1162 can store any information utilized in conjunction with establishing, transmitting, receiving, and/or processing text, data, and/or voice communications, communications-related data and/or content, voice calls, other telephonic communications, etc. For example, the memory portion is capable of storing APNs, MNCs, MCCs, radio resource requests, software for an efficient radio resource request processing system, text and data communications, calls, voicemail, multimedia content, visual voicemail applications, etc. Depending upon the exact configuration and type of processor, the memory portion 1162 can be volatile (such as RAM) 1166, non-volatile (such as ROM, flash memory, etc.) 1168, or a combination thereof. The processor 1158 can have additional features/functionality. For example, the processor 1158 can include additional storage (removable storage 1170 and/or non-removable storage 1172) including, but not limited to, magnetic or optical disks, tape, flash, smart cards or a combination thereof. Computer storage media, such as memory and storage elements 1162, 1170, 1172, 1166, and 1168, may include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium that can be used to store the desired information and that can be accessed by the processor 1158. Any such computer storage media may be part of the processor 1158.

The processor 1158 may also contain the communications connection(s) 1180 that allow the processor 1158 to communicate with other devices, for example through a radio access network (RAN). Communications connection(s) 1180 is an example of communication media. Communication media typically embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection as might be used with a land line telephone, and wireless media such as acoustic, RF, infrared, cellular, and other wireless media. The term computer-readable media as used herein includes both storage media and communication media. The processor 1158 also can have input device(s) 1176 such as keyboard, keypad, mouse, pen, voice input device, touch input device, etc. Output device(s) 1174 such as a display, speakers, printer, etc. also can be included.

While example embodiments of systems and methods to identify an individual's abilities, skills and interests have been described in connection with various communications devices and computing devices/processors, the underlying concepts can be applied to any communications or computing device, processor, or system capable of implementing the systems and methods to identify an individual's abilities, skills and interests. The various techniques described herein may be implemented in connection with hardware or software or, where appropriate, with a combination of both. Thus, the systems and methods to identify an individual's abilities, skills and interests, or certain aspects or portions thereof, can take the form of program code (i.e., instructions) embodied in tangible, non-transitory media, such as floppy diskettes, CD-ROMs, hard drives, or any other machine-readable storage medium, wherein, when the program code is loaded into and executed by a machine, such as a computer, the machine becomes an apparatus for identifying an individual's abilities, skills and interests. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

It is to be understood that a storage medium, memory, a computer-readable storage medium, and a machine readable storage medium, as described herein have a concrete, tangible, physical structure. As is known, a signal does not have a concrete, tangible, physical structure. A storage medium, memory, a computer-readable storage medium, and a machine readable storage medium, as well as any computer-readable storage medium described herein, is not to be construed as a signal. A storage medium, memory, a computer-readable storage medium, and a machine readable storage medium, as well as any computer-readable storage medium described herein, is not to be construed as a transient signal. A storage medium, memory, a computer-readable storage medium, and a machine readable storage medium, as well as any computer-readable storage medium described herein, is not to be construed as a propagating signal. A storage medium, memory, a computer-readable storage medium, and a machine readable storage medium, as well as any computer-readable storage medium described herein, is to be construed as an article of manufacture having a concrete, physical, tangible structure.

Methods and systems for identifying an individual's abilities, skills and interests may also be practiced via communications embodied in the form of program code that is transmitted over some transmission medium, such as over electrical wiring or cabling, through fiber optics, or via any other form of transmission, wherein, when the program code is received, loaded into, and executed by a machine, such as an EPROM, a gate array, a programmable logic device (PLD), a client computer, or the like, the machine becomes an apparatus for identifying an individual's abilities, skills and interests. When implemented on a general-purpose processor, the program code combines with the processor to provide a unique apparatus that operates to invoke the functionality of identifying an individual's abilities, skills and interests as described herein. Additionally, any storage techniques used in connection with an intelligent roaming and interworking system may invariably be a combination of hardware and software.

While systems and methods for identifying an individual's abilities, skills and interests have been described in connection with the various embodiments of the various figures, it is to be understood that other similar embodiments may be used or modifications and additions may be made to the described embodiments for performing the same function of identifying an individual's abilities, skills and interests without deviating therefrom. For example, one skilled in the art will recognize that systems and methods for identifying an individual's abilities, skills and interests as described in the present application may apply to any environment, whether wired or wireless, and may be applied to any number of such devices connected via a communications network and interacting across the network. Therefore, systems and methods for identifying an individual's abilities, skills and interests should not be limited to any single embodiment, but rather should be construed in breadth and scope in accordance with the appended claims.

Aspects of the invention include the following:

A method comprising: receiving, at a server, game data indicative of a plurality of games, each game of the plurality of games designed to assess at least one personal characteristic; determining, by the server, a first comparative game performance associated with a first game of the plurality of games, the first comparative game performance being based on the game data and comparative game information, the comparative game information being indicative of a comparison between game performance associated with the first game and respective game performance associated with at least one other game of the plurality of games; and deriving, by the server, a personal character from the first comparative game performance; and providing, by the server, an indication of the personal characteristic.

In this method at least one personal characteristic comprises at least one of human abilities, cognitive skills, or career interests. For example, the human abilities can comprise math skills, logical reasoning skills, linguistic skills, visual-spatial skills, musical skills, bodily-kinesthetic skills, interpersonal skills, intrapersonal skills, and naturalistic skills. For example, the cognitive skills may comprise attention functions, engagement functions, optimization functions, efficiency functions, memory functions, inquiry functions, and solution functions.

In this method, the comparative game information may include at least one benchmark table being indicative of scores and performance levels for the game performance associated with the first game and the respective game performance associated with the at least one other game of the plurality of games. For example, the game performance associated with the first game may include at least one metric that is indicative of measurements of the at least one personal characteristic based on the game data. This method may further comprise: determining the at least one metric associated with the first game; calculating, based on the at least one metric, raw scores for each of the at least one metric; averaging the raw scores for each of the at least one metrics; and determining, based on the raw scores, the scores and the performance levels for each of the at least one metric. Herein, the first comparative game performance associated with the first game includes at least one percentile rank for each of the at least one metric associated with the first game.

The methods may further comprise determining at least one percentile rank for each of the game performance associated with the first game based on the comparison between the game performance associated with the first game and the respective game performance associated with at least one other game of the plurality of games.

In additional embodiments the methods may further include determining at least one percentile rank for each of the game performance associated with the first game based on the comparison between the game performance associated with the first game and the respective game performance associated with at least one other game of the plurality of games.

Other aspects of the invention include systems, comprising: a processor; and memory coupled to the processor, the memory comprising at least one executable instruction that when executed by the processor causes the processor to effectuate operations comprising: receiving game data indicative of a plurality of games, each game of the plurality of games designed to assess at least one personal characteristic; determining a first comparative game performance associated with a first game of the plurality of games, the first comparative game performance being based on the game data and comparative game information, the comparative game information being indicative of a comparison between game performance associated with the first game and respective game performance associated with at least one other game of the plurality of games; deriving a personal character from the first comparative game performance; and providing an indication of the personal characteristic.

These systems can be designed so that at least one personal characteristic comprises at least one of human abilities, cognitive skills, or career interests. Alternatively, these systems can be designed wherein the comparative game information includes at least one benchmark table being indicative of scores and performance levels for the game performance associated with the first game and the respective game performance associated with the at least one other game of the plurality of games. For example, the game performance associated with the first game can include at least one metric that is indicative of measurements of the at least one personal characteristic based on the game data. As well, the operations here can further comprise: determining the at least one metric associated with the first game; calculating, based on the at least one metric, raw scores for each of the at least one metric; averaging the raw scores for each of the at least one metrics; and determining, based on the raw scores, the scores and the performance levels for each of the at least one metrics. Accordingly, the first comparative game performance associated with the first game can include at least one percentile rank for each of the at least one metric associated with the first game.

In other embodiments are provided computer-readable storage media comprising executable instructions, that when executed by a processor cause the processor to effectuate operations comprising: receiving game data indicative of a plurality of games, each game of the plurality of games designed to assess at least one personal characteristic; determining, by the server, a first comparative game performance associated with a first game of the plurality of games, the first comparative game performance being based on the game data and comparative game information, the comparative game information being indicative of a comparison between game performance associated with the first game and respective game performance associated with at least one other game of the plurality of games; deriving, by the server, a personal character from the first comparative game performance; and providing, by the server, an indication of the personal characteristic. In these embodiments, the at least one personal characteristic can comprise at least one of human abilities, cognitive skills, or career interests. Also, the comparative game information can include at least one benchmark table being indicative of scores and performance levels for the game performance associated with the first game and the respective game performance associated with the at least one other game of the plurality of games. Here, the game performance associated with the first game can include at least one metric that is indicative of measurements of the at least one personal characteristic based on the game data. As well, the operations can further comprise: determining the at least one metric associated with the first game; calculating, based on the at least one metric, raw scores for each of the at least one metric; averaging the raw scores for each of the at least one metrics; and determining, based on the raw scores, the scores and the performance levels for each of the at least one metrics. For example, the first comparative game performance associated with the first game includes at least one percentile rank for each of the at least one metric associated with the first game.

In other embodiments, the inventive computer-readable storage media can further comprise: determining at least one percentile rank for each of the game performance associated with the first game based on the comparison between the game performance associated with the first game and the respective game performance associated with at least one other game of the plurality of games.

1. The intelligent virtual assistant system of claim 3,
the memory comprising at least one executable instruction that when executed cause the processor to effectuate operations further comprising:
receiving at least one input parameters indicative of a plurality of campaigns and a plurality of prompts from at least one campaign applications;
determining a campaign flow based on the at least one input parameters; and
generating, based on the campaign flow, an intelligent virtual assistance application.

2. The intelligent virtual assistant system of claim 3, the memory comprising at least one executable instruction that when executed cause the processor to effectuate operations further comprising:
receiving a plurality of user data indicative of personal characteristics of users;
converting the plurality of user data into a matrix of users-by-scores;
generating, based on the matrix of user-by-scores, a first cluster of users;
generating, based on the matrix of user-by-scores, a second cluster of users; and
determining at least one similarity based on outcomes of each of the first and second cluster of users;
wherein each column of the matrix of users-by-scores is indicative of a score given on a task and each row of the matrix of users-by-scores is indicative of a user who performed the task.

3. An intelligent virtual assistant system, comprising:
a processor; and
memory coupled to the processor, the memory comprising at least one executable instruction that when executed cause the processor to effectuate operations comprising:
receiving a plurality of user interaction data indicative of patterns of usage within an intelligent virtual assistant application;
determining a first path of user interaction based on the plurality of user interaction data; and
predicting a second path of user interaction based on the first path of user interaction.

4. An intelligent virtual assistant system, comprising:
a processor; and
memory coupled to the processor, the memory comprising at least one executable instruction that when executed cause the processor to effectuate operations comprising:
receiving, via an intelligent virtual assistant application, text data indicative of a user's question;
receiving a training set data indicative of mapping information that maps existing questions to answers;
transforming the text data into a vector space representation;
generating, based on the training set data and the vector space representation, a plurality of candidate responses to the user question, each of the plurality of candidate responses includes probabilistic weight scores;
determining, based on the probabilistic weight scores, a ranking of the plurality of candidate responses; and
providing, based on the ranking, a response to the intelligent virtual assistant application.

5. The intelligent virtual assistant system of claim 4, further comprising a private virtual cloud and a data access layer,
wherein the private virtual cloud comprises a knowledgebase, an NLP service cluster, a scheduler cluster, a messaging server, a process flow server, a configuration server, a registration server, and a gatekeeper cluster, and
wherein the data access layer acts as a gateway to a data store and provides an API that the private virtual cloud may use to access data stored in the data store.

6. The system recited in claim 5 wherein the data store holds language corpora, NLP trained models, campaign states, user progress, and user information.

7. The method of claim 11, further comprising:
receiving, by an intelligent virtual assistant system, event data;
analyzing the event data using a machine learning algorithm;
saving, by the intelligent virtual assistant platform, the event data to a data warehouse.

8. The method of claim 7 wherein the event data is error data, and wherein the machine learning algorithm is used to avoid future errors.

9. The method of claim 7 further comprising:
analyzing the event data saved in the data warehouse for trends, statistics, and training data.

10. The method of claim 7 wherein the event data is customer data, and wherein the machine learning algorithm is used to improve user interaction with the intelligent virtual assistant system.

11. In an intelligent virtual assistant system, a method comprising:
receiving a question;
receiving an intent assigned to the question;
sending the question and intent to a natural language processing training component; and
training a natural language processing model using the training component.

12. The method recited in claim 11 further comprising:
receiving a question; and
assigning an intent to the question using the trained natural language processing model.

13. The method recited in claim 11 further comprising:
receiving a voice query;
converting the voice query to a text query;
sending the text query to an intent engine; and
determining a matched intent for the text query.

14. The method recited in claim 13 further comprising:
determining a confidence score of the matched intent;
determining if the confidence score meets a threshold requirement;
determining that the confidence score does not meeting the threshold requirement; and
assigning a default intent to the query.

15. The method recited in claim 13 further comprising:
determining a confidence score of the matched intent;
determining if the confidence score meets a threshold requirement;
determining that the confidence score meets the threshold requirement; and
assigning the text query to a handler for the matched intent.

16. The method of claim 14 further comprising:
determining a response to the text query; and
outputting the response.

17. The method of claim 11 wherein the receiving is performed by a gatekeeper service or knowledgebase service.
